(19) United States
(12) Patent Application Publication
(10) Pub. No.: US 2014/0199585 A1
(43) Pub. Date: Jul. 17, 2014

(54) Low Symmetry Molecules And Phosphonium Salts, Methods Of Making And Devices Formed There From

(71) Applicant: ESIONIC ES, INC., MENLO PARK, CA (US)

(72) Inventors: Benjamin L. Rupert, Berkeley, CA (US); Leanne Beer, San Francisco, CA (US)

(73) Assignee: ESIONIC ES, INC., MENLO PARK, CA (US)

(21) Appl. No.: 14/158,639

(22) Filed: Jan. 17, 2014

Related U.S. Application Data
(60) Provisional application No. 61/753,875, filed on Jan. 17, 2013.

(51) Int. Cl. H01G 11/62; H01M 10/0525; H01M 10/0568

(52) U.S. Cl. CPC H01G 11/62; H01M 10/0568; H01M 10/0525
USPC 429/188; 252/62.2; 361/502

(57) ABSTRACT

Synthesis of molecules and salts is disclosed having low average symmetry and their use in many applications, including but not limited to: as electrolytes in electronic devices such as memory devices including static, permanent and dynamic random access memory, as electrolytes in energy storage devices such as batteries, electrochemical double layer capacitors (EDLCs) or supercapacitors or ultracapacitors, electrolytic capacitors, as electrolytes in dye-sensitized solar cells (DSSCs), as electrolytes in fuel cells, as a heat transfer medium, high temperature reaction and/or extraction media, among other applications. In particular, synthesis methods and processes to form molecules and salts having low average symmetry using mixed Grignard reagents are disclosed.

### RELATED APPLICATIONS

This application claims the benefit of, and priority to, U.S. Provisional Patent Application Ser. No. 61/753,875, filed on Jan. 17, 2013, which is hereby incorporated by reference in its entirety.

### FIELD OF THE INVENTION

The invention generally encompasses synthesis of molecules and salts having low average symmetry and their use in many applications, including but not limited to: as electrolytes in electronic devices such as memory devices including static, permanent and dynamic random access memory, as electrolytes in energy storage devices such as batteries, electrochemical double layer capacitors (EDLCs) or supercapacitors or ultracapacitors, electrolytic capacitors, as electrolytes in dye-sensitized solar cells (DSSCs), as electrolytes in fuel cells, as a heat transfer medium, high temperature reaction and/or extraction media, among other applications. In particular, the invention relates to synthesis methods and processes to form molecules and salts having low average symmetry using mixed Grignard reagents.

### BACKGROUND OF THE INVENTION

Low symmetry molecules and salts can be advantageous in certain applications as they generally have lower melting points and higher solubility than higher symmetry isomers. These low symmetry molecules and salts can be difficult, and often costly, to synthesize because for example extraordinary measures must be taken to isolate reactive intermediates from a mixture of compounds.

One example of where the prior art methods are limited is in the synthesis of low symmetry phosphonium salts. One such example is the synthesis of ethyldimethylpropyl iodide (EtMe2PrPI) using ethyldichlorophosphine as the starting material or reagent. While this synthesis scheme produces high yield and results in a single-component phosphonium salt with desired properties, the starting material cost is very high. Moreover, ethyldichlorophosphine is pyrophoric, thus posing significant safety concerns and making this material undesirable as a starting material. Accordingly, further developments are needed.

While developments have been made, it is apparent that a continuing need exists for new developments in ionic liquids, salts, and electrolyte compositions and for materials and uses in which the electrolytes may be employed for use in electrochemical double layer capacitors, lithium metal and lithium ion batteries, fuel cells, dye-sensitized solar cells and molecular memory devices. In particular, development of synthesis methods that enable direct synthesis of mixtures of compounds, and optionally at selective or controlled distribution, is highly desirable.

### SUMMARY OF THE INVENTION

The invention generally encompasses synthesis of molecules and salts having low average symmetry and their use in many applications, including but not limited to: as electrolytes in electronic devices such as memory devices including static, permanent and dynamic random access memory, as electrolytes in energy storage devices such as batteries, electrochemical double layer capacitors (EDLCs) or supercapacitors or ultracapacitors, electrolytic capacitors, as electrolytes in dye-sensitized solar cells (DSSCs), as electrolytes in fuel cells, as a heat transfer medium, high temperature reaction and/or extraction media, among other applications. In particular, the invention relates to synthesis methods and processes to form molecules and salts having low average symmetry using mixed Grignard reagents.

The molecules and salts synthesized according to embodiments of the present invention broadly encompasses phosphonium ionic liquids, salts, compositions and their use in many applications, including but not limited to: as electrolytes in electronic devices such as memory devices including static, permanent and dynamic random access memory, as electrolytes in energy storage devices such as batteries, electrochemical double layer capacitors (EDLCs) or supercapacitors or ultracapacitors, electrolytic capacitors, as electrolytes in dye-sensitized solar cells (DSSCs), as electrolytes in fuel cells, as a heat transfer medium, high temperature reactions and/or extraction media, among other applications. In particular, the phosphonium ionic liquids, salts, compositions and molecules produced by the synthesis methods of the present invention possess low average symmetry structural features, wherein the compositions exhibit desired combinations of at least two or more of: thermodynamic stability, low volatility, wide liquidus range and ionic conductivity.

In another aspect, molecules and salts synthesized according to embodiments of the present invention encompasses electrolyte compositions comprised of phosphonium based cations with suitable anions. In some embodiments, the term “electrolyte” or “electrolyte solution” or “electrolyte composition” or “ionic electrolyte” or “ion conducting electrolyte” or “ion conducting composition” or “ionic composition” is used and is herein defined as any one or more of: (a) an ionic liquid, (b) a room temperature ionic liquid, (c) one or more salts dissolved in at least one solvent, and (d) one or more salts dissolved in at least one solvent together with at least one polymer to form a gel electrolyte. Additionally, the one or more salts are defined to include: (a) one or more salts that are a solid at a temperature of 100° C. and below, and (b) one or more salts that are a liquid at a temperature of 100° C. and below.

In another embodiment, molecules and salts synthesized according to embodiments of the present invention are electrolyte compositions comprised of: one or more salts dissolved in a solvent, the one or more salts comprising one or more phosphonium based cations of the general formula:

R¹R²R³R⁴P (1)

and one or more anions, and wherein: R¹, R², R³ and R⁴ are each independently a substituent group, such as but not limited to an alkyl group as described below. In some embodiments R¹, R², R³ and R⁴ are each independently an alkyl group comprised of 1 to 6 carbon atoms, more usually 1 to 4 carbon atoms. Any one or more of the salts may be liquid or solid at a temperature of 100° C. and below. In some embodiments, a salt is comprised of one cation and one anion pair. In other embodiments, a salt is comprised of one cation and multiple anions. In other embodiments, a salt is comprised of one anion and multiple cations. In further embodiments, a salt is comprised of multiple cations and multiple anions.

In another embodiment, molecules and salts synthesized according to embodiments of the present invention are electrolyte composition further comprised of one or more conventional, non-phosphonium salts. In some embodiments the electrolyte composition may be comprised of conventional salts, and wherein the phosphonium based ionic liquids or salts disclosed herein are additives. In some embodiments electrolyte composition is comprised of phosphonium based ionic liquids or salts and one or more conventional salts, present at a mole (or molar) ratio in the range of 1:100 to 1:1, phosphonium based ionic liquid or salt: conventional salt. Examples of the conventional salts include but are not limited to salts which are comprised of one or more cations selected from the group consisting of: tetraalkylammonium such as (CH₃CH₂)₄N⁺, (CH₃CH₂)₃(CH₃)N⁺, (CH₃CH₂)₂(CH₃)₂N⁺, (CH₃CH₂)(CH₃)₃N⁺, (CH₃)₄N⁺ imidazolium, pyrazolium, pyridinium, pyrazinium, pyrimidinium, pyridazinium, pyrrolidinium and one or more anions selected from the group consisting of: ClO₄⁻, BF₄⁻, CF₃SO₃⁻, PF₆⁻, AsF₆⁻, SbF₆⁻, (CF₃SO₂)₂N⁻, (CF₃CF₂SO₂)₂N⁻, (CF₃SO₂)₃C⁻. In some embodiments, the one or more conventional salts include but not limited to: tetraethylammonium tetrafluorborate (TEABF₄), triethylmethylammonium tetrafluoroborate (TEMABF₄), 1-ethyl-3-methylimidazolium tetrafluoroborate (EMIBF₄), 1-ethyl-1-methylpyrrolidinium tetrafluoroborate (EMPBF₄), 1-ethyl-3-methylimidazolium bis(trifluoromethanesulfonyl)imide (EMIIm), 1-ethyl-3-methylimidazolium hexafluorophosphate (EMIPF₆). In some embodiments, the one or more conventional salts are lithium based salts including but not limited to: lithium hexafluorophosphate (LiPF₆), lithium tetrafluoroborate (LiBF₄), lithium perchlorate (LiClO₄), lithium hexafluoroarsenate (LiAsF₆), lithium trifluoromethanesulfonate or lithium triflate (LiCF₃SO₃), lithium bis(trifluoromethanesulfonyl)imide (Li(CF₃SO₂)₂N or LiIm), and lithium bis(pentafluoromethanesulfonyl)imide (Li(CF3CF₂SO₂)₂N or LiBETI).

In another embodiment, molecules and salts synthesized according to embodiments of the present invention provide a battery, comprising: a positive electrode, a negative electrode, a separator between said positive and negative electrode; and an electrolyte. The electrolyte is comprised of an ionic liquid composition or one or more salts dissolved in a solvent, comprising: one or more phosphonium based cations of the general formula:

R¹R²R³R⁴P

wherein: R¹, R², R³ and R⁴ are each independently a substituent group; and one or more anions. In another embodiment, the electrolyte is characterized as having one or more phosphonium based cations, and one or more anions, wherein the ionic liquid composition exhibits thermodynamic stability up to a temperature greater than 375° C., a liquidus range greater than 400° C., and ionic conductivity of at least 1 mS/cm, or at least 5 mS/cm, or at least 10 mS/cm at room temperature. In another embodiment, the electrolyte is comprised of one or more salts having one or more phosphonium based cations, and one or more anions dissolved in a solvent, wherein the electrolyte composition exhibits ionic conductivity of at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature. In a further aspect, the phosphonium electrolyte exhibits reduced flammability as compared to conventional electrolytes, and thus improves the safety of battery operation. In an additional aspect, the phosphonium ionic liquid or salt can be used as an additive to facilitate the formation of a solid electrolyte interphase (SEI) layer or electrode protective layer. The SEI layer may widen the electrochemical stability window, suppress battery degradation or decomposition reactions and hence improve battery cycle life.

In another embodiment, molecules and salts synthesized according to embodiments of the present invention provide an electrochemical double layer capacitor (EDLC), comprising: a positive electrode, a negative electrode, a separator between said positive and negative electrode; and an electrolyte. The electrolyte is comprised of an ionic liquid composition or one or more salts dissolved in a solvent, comprising: one or more phosphonium based cations of the general formula:

R¹R²R³R⁴P

wherein: R¹, R², R³ and R⁴ are each independently a substituent group; and one or more anions. In another embodiment, the electrolyte is characterized as having one or more phosphonium based cations, and one or more anions, wherein the ionic liquid composition or salt exhibits thermodynamic stability up to a temperature greater than 375° C., a liquidus range greater than 400° C., and ionic conductivity of at least 1 mS/cm, or at least 5 mS/cm, or at least 10 mS/cm at room temperature. In another embodiment, the electrolyte is comprised of one or more salts having one or more phosphonium based cations, and one or more anions dissolved in a solvent, wherein the electrolyte composition exhibits ionic conductivity of at least at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature. In a further aspect, the phosphonium electrolyte exhibits reduced flammability as compared to conventional electrolytes, and thus improves the safety of EDLC operation. In an additional aspect, the phosphonium ionic liquid or salt can be used as an additive to facilitate the formation of a solid electrolyte interphase (SEI) layer or electrode protective layer. The protective layer acts to widen the electrochemical stability window, suppress EDLC degradation or decomposition reactions and hence improve EDLC cycle life.

### BRIEF DESCRIPTION OF THE DRAWINGS

Other aspects, embodiments and advantages of the invention will become apparent upon reading of the detailed description of the invention and the appended claims provided below, and upon reference to the drawings in which:

FIG. 1 depicts general reaction schemes to synthesize mixed phosphonium salts according to some embodiments of the present invention;

FIG. 2A and FIG. 2B show the ¹H and ³¹P NMR spectra respectively for exemplary embodiments of mixed phosphonium salts prepared as described in Example 1;

FIG. 3 is a graph showing thermogravimetric analysis (TGA) results for exemplary embodiments of mixed phosphonium salts prepared according to Example 1;

FIGS. 4A, 4B and 4C show the ¹H, ¹⁹F, and ³¹P NMR spectra respectively for exemplary embodiments of mixed phosphonium salts prepared as described in Example 2;

FIG. 5 is a graph showing thermogravimetric analysis (TGA) results for exemplary embodiments of mixed phosphonium salts prepared according to Example 2;

FIGS. 6A and 6B show the ¹H and ¹⁹F spectra respectively for exemplary embodiments of mixed phosphonium salts prepared as described in Example 3;

FIG. 7 is a graph showing thermogravimetric analysis (TGA) results for exemplary embodiments of mixed phosphonium salts prepared according to Example 3;

FIG. 8A and FIG. 8B show the ¹H and ³¹P NMR spectra respectively for exemplary embodiments of phosphonium salts prepared as described in Example 4;

FIG. 9 is a graph showing thermogravimetric analysis (TGA) results for exemplary embodiments of phosphonium salts prepared according to Example 4;

FIG. 10A and FIG. 10B show the ¹H and ³¹P NMR spectra respectively for exemplary embodiments of mixed phosphonium salts prepared as described in Example 5;

FIG. 11A and FIG. 11B show the ¹H and ³¹P NMR spectra respectively for exemplary embodiments of phosphonium salts prepared as described in Example 6;

FIG. 12 is a graph showing thermogravimetric analysis (TGA) results for exemplary embodiments of phosphonium salts prepared according to Example 6;

FIG. 13A and FIG. 13B show the ¹H and ³¹P NMR spectra respectively for exemplary embodiments of phosphonium salt prepared as described in Example 7;

FIG. 14 is a graph showing thermogravimetric analysis (TGA) results for exemplary embodiments of phosphonium salt prepared according to Example 7;

FIG. 15A and FIG. 15B show the ¹H and ³¹P NMR spectra respectively for exemplary embodiments of phosphonium salt prepared as described in Example 8;

FIG. 16 is a graph showing thermogravimetric analysis (TGA) results for exemplary embodiments of phosphonium salt prepared according to Example 8;

FIG. 17A and FIG. 17B are graphs showing differential scanning calorimetry (DSC) results for exemplary embodiments of phosphonium ionic liquids prepared according to Example 9;

FIG. 18 depicts ionic conductivity as a function of ACN/salt volume ratio for phosphonium salt (CH₃CH₂CH₂)(CH₃CH₂)(CH₃)₂PC(CN)₃ in acetonitrile (ACN) as described in Example 11;

FIG. 19 depicts ionic conductivity as a function of PC/salt volume ratio for phosphonium salt (CH₃CH₂CH₂)(CH₃CH₂)(CH₃)₂PC(CN)₃ in propylene carbonate (PC) as described in Example 12;

FIG. 20 depicts ionic conductivity as a function of molar concentration of phosphonium salts compared to an ammonium salt in propylene carbonate as described in Examples 38-41;

FIG. 21 depicts vapor pressure as a function of temperature for acetonitrile, acetonitrile with 1 M ammonium salt, and acetonitrile with 1 M phosphonium salt as described in Example 42;

FIG. 22 shows the impact of phosphonium salt (CH₃CH₂CH₂)(CH₃CH₂)(CH₃)₂PC(CN)₃ on ionic conductivity of 1.0 M LiPF6 in EC:DEC 1:1 at different temperatures from −30 to 60° C. as described in Example 47;

FIG. 23 shows the impact of phosphonium salt (CH₃CH₂CH₂)(CH₃CH₂)(CH₃)₂PCF₃BF₃ on ionic conductivity of 1.0 M LiPF6 in EC:DEC 1:1 at different temperatures from 20 to 90° C. as described in Example 48;

### DETAILED DESCRIPTION OF INVENTION

### Overview

The present invention is generally directed to synthesis of molecules and salts having low average symmetry and their use in many applications.

### General Description

The invention encompasses novel phosphonium ionic liquids, salts, compositions and their use in many applications, including but not limited to: as electrolytes in electronic devices such as memory devices including static, permanent and dynamic random access memory, as electrolytes in batteries, electrochemical double layer capacitors, electrolytic capacitors, fuel cells, dye-sensitized solar cells, and electrochromic devices. Additional applications include use as a heat transfer medium, high temperature reaction and/or extraction media, among other applications. In particular, the invention relates to phosphonium ionic liquids, salts, compositions and molecules possessing structural features, wherein the composition exhibits desirable combination of at least two or more of: thermodynamic stability, low volatility, wide liquidus range, ionic conductivity, and electrochemical stability. The invention further encompasses methods of making such phosphonium ionic liquids, compositions and molecules, and operational devices and systems comprising the same.

In another aspect, embodiments of the present invention provide devices having an electrolyte comprised of phosphonium ionic liquid compositions or one or more salts dissolved in a solvent. In another aspect, embodiments of the present invention provide a battery comprising an electrolyte comprised of phosphonium ionic liquid compositions or one or more salts dissolved in a solvent. In a further aspect, embodiments of the present invention provide an electrochemical double layer capacitor (EDLC) comprising an electrolyte comprised of phosphonium ionic liquid compositions or one or more salts dissolved in a solvent.

The advantageous properties of the phosphonium ionic liquid compositions make them particularly suited for applications as an electrolyte in electronic devices, batteries, EDLC's, fuel cells, dye-sensitized solar cells (DSSCs), and electrochromic devices.

In a further aspect of the present invention, a heat transfer medium is provided comprised of phosphonium ionic liquid compositions or one or more salts dissolved in a solvent. The advantageous properties of the compositions of the present invention are well suited as a heat transfer medium, and useful in processes and systems where a heat transfer medium is employed such as in heat extraction process and high temperature reactions.

### DEFINITIONS

As used herein and unless otherwise indicated, the term “electrolyte” or “electrolyte solution” or “electrolyte composition” or “ionic electrolyte” or “ion conducting electrolyte” or “ion conducting composition” or “ionic composition” is used and is herein defined as any one or more of: (a) an ionic liquid, (b) a room temperature ionic liquid, (c) one or more salts dissolved in at least one solvent, and (d) one or more salts dissolved in at least one solvent together with at least one polymer to form a gel electrolyte. Additionally, the one or more salts are defined to include: (a) one or more salts that are a solid at a temperature of 100° C. and below, and (b) one or more salts that are a liquid at a temperature of 100° C. and below.

As used herein and unless otherwise indicated, the term “acyl” refers to an organic acid group in which the OH of the carboxyl group is replaced by some other substituent (RCO—), such as described herein as “R” substituent groups. Examples include, but are not limited to, halo, acetyl, and benzoyl.

As used herein and unless otherwise indicated, the term “alkoxy group” means an —O— alkyl group, wherein alkyl is as defined herein. An alkoxy group can be unsubstituted or substituted with one, two or three suitable substituents. Preferably, the alkyl chain of an alkoxy group is from 1 to 6 carbon atoms in length, referred to herein, for example, as “(C1-C6) alkoxy.”

As used herein and unless otherwise indicated, “alkyl” by itself or as part of another substituent, refers to a saturated or unsaturated, branched, straight-chain or cyclic monovalent hydrocarbon radical derived by the removal of one hydrogen atom from a single carbon atom of a parent alkane, alkene or alkyne. Also included within the definition of an alkyl group are cycloalkyl groups such as C5, C6 or other rings, and heterocyclic rings with nitrogen, oxygen, sulfur or phosphorus (heterocycloalkyl). Alkyl also includes heteroalkyl, with heteroatoms of sulfur, oxygen, nitrogen, phosphorous, and silicon finding particular use in certain embodiments. Alkyl groups can be optionally substituted with R groups, independently selected at each position as described below.

Examples of alkyl groups include, but are not limited to, (C1-C6) alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, and hexyl, and longer alkyl groups, such as heptyl, and octyl.

The term “alkyl” is specifically intended to include groups having any degree or level of saturation, i.e., groups having exclusively carbon-carbon single bonds, groups having one or more carbon-carbon double bonds, groups having one or more carbon-carbon triple bonds and groups having mixtures of single, double and triple carbon-carbon bonds. Where a specific level of saturation is intended, the expressions “alkanyl,” “alkenyl,” and “alkynyl” are used.

“Alkanyl” by itself or as part of another substituent, refers to a saturated branched, straight-chain or cyclic alkyl radical derived by the removal of one hydrogen atom from a single carbon atom of a parent alkane. “Heteroalkanyl” is included as described above.

“Alkenyl” by itself or as part of another substituent, refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Suitable alkenyl groups include, but are not limited to (C2-C6) alkenyl groups, such as vinyl, allyl, butenyl, pentenyl, hexenyl, butadienyl, pentadienyl, hexadienyl, 2-ethylhexenyl, 2-propyl-2-butenyl, 4-(2-methyl-3-butene)-pentenyl. An alkenyl group can be unsubstituted or substituted with one or more independently selected R groups.

“Alkynyl” by itself or as part of another substituent, refers to an unsaturated branched, straight-chain or cyclic alkyl radical having at least one carbon-carbon triple bond derived by the removal of one hydrogen atom from a single carbon atom of a parent alkyne.

Also included within the definition of “alkyl” is “substituted alkyl”. “Substituted” is usually designated herein as “R”, and refers to a group in which one or more hydrogen atoms are independently replaced with the same or different substituent(s). R substituents can be independently selected from, but are not limited to, hydrogen, halogen, alkyl (including substituted alkyl (alkylthio, alkylamino, alkoxy, etc.), cycloalkyl, substituted cycloalkyl, cycloheteroalkyl, and substituted cycloheteroalkyl), aryl (including substituted aryl, heteroaryl or substituted heteroaryl), carbonyl, alcohol, amino, amido, nitro, ethers, esters, aldehydes, sulfonyl, sulfoxyl, carbamoyl, acyl, cyano, thiocyanato, silicon moieties, halogens, sulfur containing moieties, phosphorus containing moieties, etc. In some embodiments, as described herein, R substituents include redox active moieties (ReAMs). In some embodiments, optionally R and R′ together with the atoms to which they are bonded form a cycloalkyl (including cycloheteroalkyl) and/or cycloaryl (including cycloheteroaryl), which can also be further substituted as desired. In the structures depicted herein, R is hydrogen when the position is unsubstituted. It should be noted that some positions may allow two or three substitution groups, R, R′, and R″, in which case the R, R′, and R″ groups may be either the same or different.

By “aryl” or grammatical equivalents herein is meant an aromatic monocyclic or polycyclic hydrocarbon moiety generally containing 5 to 14 carbon atoms (although larger polycyclic rings structures may be made) and any carbocyclic ketone, imine, or thioketone derivative thereof, wherein the carbon atom with the free valence is a member of an aromatic ring. Aromatic groups include arylene groups and aromatic groups with more than two atoms removed. For the purposes of this application aryl includes heteroaryl. “Heteroaryl” means an aromatic group wherein 1 to 5 of the indicated carbon atoms are replaced by a heteroatom chosen from nitrogen, oxygen, sulfur, phosphorus, boron and silicon wherein the atom with the free valence is a member of an aromatic ring, and any heterocyclic ketone and thioketone derivative thereof. Thus, heterocycle includes both single ring and multiple ring systems, e.g. thienyl, furyl, pyrrolyl, pyrimidinyl, indolyl, purinyl, quinolyl, isoquinolyl, thiazolyl, imidazolyl, naphthalene, phenanthroline, etc. Also included within the definition of aryl is substituted aryl, with one or more substitution groups “R” as defined herein and outlined above and herein. For example, “perfluoroaryl” is included and refers to an aryl group where every hydrogen atom is replaced with a fluorine atom. Also included is oxalyl.

As used herein the term “halogen” refers to one of the electronegative elements of group VIIA of the periodic table (fluorine, chlorine, bromine, iodine, and astatine).

The term “nitro” refers to the —NO₂ group.

By “amino groups” or grammatical equivalents herein is meant —NH2, —NHR and —NRR′ groups, with R and R′ independently being as defined herein.

As used herein the term “pyridyl” refers to an aryl group where one CH unit is replaced with a nitrogen atom.

As used herein the term “cyano” refers to the —CN group.

As used here the term “thiocyanato” refers to the —SCN group.

The term “sulfoxyl” refers to a group of composition RS(O)— where R is a substitution group as defined herein, including alkyl, (cycloalkyl, perfluoroalkyl, etc.), or aryl (e.g., perfluoroaryl group). Examples include, but are not limited to methylsulfoxyl, phenylsulfoxyl, etc.

The term “sulfonyl” refers to a group of composition RSO2— where R is a substituent group, as defined herein, with alkyl, aryl, (including cycloalkyl, perfluoroalkyl, or perfluoroaryl groups). Examples include, but are not limited to methylsulfonyl, phenylsulfonyl, p-toluenesulfonyl, etc.

The term “carbamoyl” refers to the group of composition R(R′)NC(O)— where R and R′ are as defined herein, examples include, but are not limited to N-ethylcarbamoyl, N,N-dimethylcarbamoyl, etc.

The term “amido” refers to the group of composition R₁CONR₂— where R₁ and R₂ are substituents as defined herein. Examples include, but are not limited to acetamido, N-ethylbenzamido, etc.

The term “imine” refers to ═NR.

In certain embodiments, when a metal is designated, e.g., by “M” or “Mₙ”, where n is an integer, it is recognized that the metal can be associated with a counterion.

As used herein and unless otherwise indicated, the term “aryloxy group” means an —O— aryl group, wherein aryl is as defined herein. An aryloxy group can be unsubstituted or substituted with one or two suitable substituents. Preferably, the aryl ring of an aryloxy group is a monocyclic ring, wherein the ring comprises 6 carbon atoms, referred to herein as “(C6) aryloxy.”

As used herein and unless otherwise indicated, the term “benzyl” means —CH2-phenyl.

As used herein and unless otherwise indicated, the term “carbonyl” group is a divalent group of the formula —C(O)—.

As used herein and unless otherwise indicated, the term “cyano” refers to the —CN group.

As used herein and unless otherwise indicated, the term “linker” is a molecule used to couple two different molecules, two subunits of a molecule, or a molecule to a substrate.

Many of the compounds described herein utilize substituents, generally depicted herein as “R.” Suitable R groups include, but are not limited to, hydrogen, alkyl, alcohol, aryl, amino, amido, nitro, ethers, esters, aldehydes, sulfonyl, silicon moieties, halogens, cyano, acyl, sulfur containing moieties, phosphorus containing moieties, Sb, imido, carbamoyl, linkers, attachment moieties, ReAMs and other subunits. It should be noted that some positions may allow two substitution groups, R and R′, in which case the R and R′ groups may be either the same or different, and it is generally preferred that one of the substitution groups be hydrogen.

### Phosphonium Ionic Liquids, Salts, and Compositions of the Invention

As described in detail herein, embodiments of novel phosphonium ionic liquids, salts, and compositions of the present invention exhibit desirable properties and in particular a combination of at least two or more of: high thermodynamic stability, low volatility, wide liquidus range, high ionic conductivity, and wide electrochemical stability window. The combination of up to, and in some embodiments, all of these properties at desirable levels in one composition was unexpected and not foreseen, and provides a significant advantage over known ionic compositions. Embodiments of phosphonium compositions of the present invention exhibiting such properties enable applications and devices not previously available.

In some embodiments, phosphonium ionic liquids of the present invention comprise phosphonium cations of selected molecular weights and substitution patterns, coupled with selected anion(s), to form ionic liquids with tunable combinations of thermodynamic stability, ionic conductivity, liquidus range, and low volatility properties.

In some embodiments, by “ionic liquid” herein is meant a salt that is in the liquid state at and below 100° C. “Room temperature” ionic liquid is further defined herein in that it is in the liquid state at and below room temperature.

In other embodiments, the term “electrolyte” or “electrolyte solution” or “electrolyte composition” or “ionic electrolyte” or “ion conducting electrolyte” or “ion conducting composition” or “ionic composition” is used and is herein defined as any one or more of: (a) an ionic liquid, (b) a room temperature ionic liquid, (c) one or more salts dissolved in at least one solvent, and (d) one or more salts dissolved in at least one solvent together with at least one polymer to form a gel electrolyte. Additionally, the one or more salts are defined to include: (a) one or more salts that are a solid at a temperature of 100° C. and below, and (b) one or more salts that are a liquid at a temperature of 100° C. and below.

In some embodiments the present invention comprises phosphonium ionic liquids and phosphonium electrolytes that exhibit thermodynamic stability up to temperatures of approximately 400° C., and more usually up to temperatures of approximately 375° C. Exhibiting thermal stability up to a temperature this high is a significant development, and allows use of the phosphonium ionic liquids of the present invention in a wide range of applications. Embodiments of phosphonium ionic liquids and phosphonium electrolytes of the present invention further exhibit ionic conductivity of at least 1 mS/cm, or at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature. Embodiments of phosphonium ionic liquids and phosphonium electrolytes of the present invention exhibit volatilities that are about 20% lower compared to their nitrogen-based analogs. This combination of high thermal stability, high ionic conductivity, wide liquidus range, and low volatility, is highly desirable and was unexpected. Generally, in the prior art it is found that thermal stability and ionic conductivity of ionic liquids exhibit an inverse relationship.

In some embodiments, phosphonium ionic liquids and phosphonium electrolytes are comprised of cations having molecular weight of up to 500 Daltons. In other embodiments, phosphonium ionic liquids and phosphonium electrolytes are comprised of cations having molecular weight in the range of 200 to 500 Daltons for ionic liquids at the lower thermal stability ranges.

Phosphonium ionic compositions of the present invention are comprised of phosphonium based cations of the general formula:

R¹R²R³R⁴P (1)

wherein: R¹, R², R³ and R⁴ are each independently a substituent group. In some embodiments, wherein the cations are comprises of open chains.

In some embodiments R¹, R², R³ and R⁴ are each independently an alkyl group. In one embodiment, at least one of the alkyl groups is different from the other two. In one embodiment none of the alkyl groups are methyl. In some embodiments, an alkyl group is comprised of 2 to 7 carbon atoms, more usually 1 to 6 carbon atoms. In some embodiments R¹, R², R³ and R⁴ are each independently a different alkyl group comprised of 2 to 14 carbon atoms. In some embodiments, the alkyl groups contain no branching. In one embodiment R¹=R² in an aliphatic, heterocyclic moiety. Alternatively, R¹=R² in an aromatic, heterocyclic moiety.

In some embodiments, R¹ or R² are comprised of phenyl or substituted alkylphenyl. In some embodiments, R¹ and R² are the same and are comprised of tetramethylene (phospholane) or pentamethylene (phosphorinane). Alternatively, R¹ and R² are the same and are comprised of tetramethinyl (phosphole). In a further embodiment, R¹ and R² are the same and are comprised of phospholane or phosphorinane. Additionally, in another embodiment R², R³ and R⁴ are the same and are comprised of phospholane, phosphorinane or phosphole.

In some embodiments at least one, more, of or all of R¹, R², R³ and R⁴ are selected such that each does not contain functional groups that would react with the redox active molecules (ReAMs)) described below. In some embodiments, at least one, more, of or all of R¹, R², R³ and R⁴ do not contain halides, metals or O, N, P, or Sb.

In some embodiments, the alkyl group comprises from 1 to 7 carbon atoms. In other embodiments the total carbon atoms from all alkyl groups is 12 or less. In yet other embodiments, the alkyl groups are each independently comprised of 1 to 6 carbon atoms, more typically, from 1 to 5 carbon atoms.

In another embodiment, phosphonium ionic compositions are provided and are comprised of: one or more salts dissolved in a solvent, the one or more salts comprising one or more phosphonium based cations of the general formula:

R¹R²R³R⁴P (1)

and one or more anions, and wherein: R¹, R², R³ and R⁴ are each independently a substituent group, such as but not limited to an alkyl group as described below. In some embodiments R¹, R², R³ and R⁴ are each independently an alkyl group comprised of 1 to 6 carbon atoms, more usually 1 to 4 carbon atoms. In some embodiments one or more of the hydrogen atoms in one or more of the R groups are substituted by fluorine. Any one or more of the salts may be liquid or solid at a temperature of 100° C. and below. In some embodiments, a salt is comprised of one cation and one anion. In other embodiments, a salt is comprised of one cation and multiple anions. In other embodiments, a salt is comprised of one anion and multiple cations. In further embodiments, a salt is comprised of multiple cations and multiple anions. Exemplary embodiments of suitable solvents include, but are not limited to, one or more of the following: acetonitrile, ethylene carbonate (EC), propylene carbonate (PC), butylene carbonate (BC), dimethyl carbonate (DMC), diethyl carbonate (DEC), ethylmethyl carbonate (EMC) or methyl ethyl carbonate (MEC), methyl propionate (MP), fluoroethylene carbonate (FEC), fluorobenzene (FB), vinylene carbonate (VC), vinyl ethylene carbonate (VEC), phenylethylene carbonate (PhEC), propylmethyl carbonate (PMC), diethoxyethane (DEE), dimethoxyethane (DME), tetrahydrofuran (THF), γ-butyrolactone (GBL), and γ-valerolactone (GVL).

In an exemplary embodiment, phosphonium cations are comprised of the following formula:

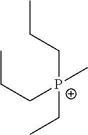

In another exemplary embodiment, phosphonium cations are comprised of the following formula:

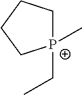

In yet another exemplary embodiment, phosphonium cations are comprised of the following formula:

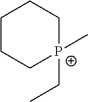

In an additional exemplary embodiment, phosphonium cations are comprised of the following formula:

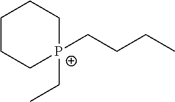

In a further exemplary embodiment, phosphonium cations are comprised of the following formula:

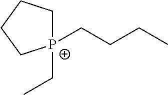

In an additional exemplary embodiment, phosphonium cations are comprised of the following formula:

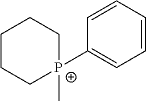

In an additional exemplary embodiment, phosphonium cations are comprised of the following formula:

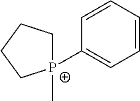

In another exemplary embodiment, phosphonium cations are comprised of the following formula:

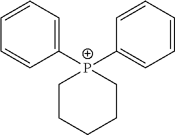 [SMILES: c1ccc([P+]2(c3ccccc3)CCCCC2)cc1]

In a further exemplary embodiment, phosphonium cations are comprised of the following formula:

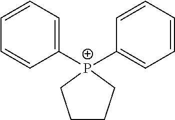 [SMILES: c1ccc([P+]2(c3ccccc3)CCCC2)cc1]

In yet another exemplary embodiment, phosphonium cations are comprised of the following formula:

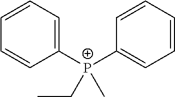 [SMILES: CC[P+](C)(c1ccccc1)c1ccccc1]

In still another exemplary embodiment, phosphonium cations are comprised of the following formula:

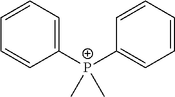

Another exemplary provides phosphonium cations comprised of the following formula:

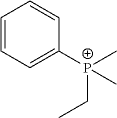

Further provided are phosphonium cations comprised of the following formula:

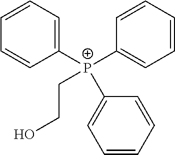 [SMILES: OCC[P+](c1ccccc1)(c1ccccc1)c1ccccc1]

In some embodiments examples of suitable phosphonium cations include but are not limited to: di-n-propyl ethyl phosphonium; n-butyl n-propyl ethyl phosphonium; n-hexyl n-butyl ethyl phosphonium; and the like.

In other embodiments, examples of suitable phosphonium cations include but are not limited to: ethyl phospholane; n-propyl phospholane; n-butyl phospholane; n-hexyl phopholane; and phenyl phospholane.

In further embodiments, examples of suitable phosphonium cations include but are not limited to: ethyl phosphole; n-propyl phosphole; n-butyl phosphole; n-hexyl phophole; and phenyl phosphole.

In yet another embodiment, examples of suitable phosphonium cations include but are not limited to: 1-ethyl phosphacyclohexane; n-propyl phosphacyclohexane; n-butyl phosphacyclohexane; n-hexyl phophacyclohexane; and phenyl phosphacyclohexane.

Phosphonium ionic liquids or salts of the present invention are comprised of cations and anions. As will be appreciated by those of skill in the art, there are a large variety of possible cation and anion combinations. Phosphonium ionic liquids or salts of the present invention comprise cations as described above with anions that are generally selected from compounds that are easily ion exchanged with reagents or solvents of the general formula:

C⁺A⁻

Wherein C⁺ is a cation and A⁺ is an anion. In the instance of organic solvents, C⁺ is preferably Li⁺, K⁺, Na⁺, NH₄⁺ or Ag⁺. In the instance of aqueous solvents, C⁺ is preferably Ag⁺.

Many anions may be selected. In one preferred embodiment, the anion is bis-perfluoromethyl sulfonyl imide. Exemplary embodiments of suitable anions include, but are not limited to, any one or more of: NO₃⁻, O₃SCF₃⁻, N(SO₂CF₃)₂⁻, PF₆⁻, O₃SC₆H₄CH₃⁻, O₃SCF₂CF₂CF₃⁻, O₃SCH₃⁻, I⁻, C(CN)₃⁻, ⁻O₃SCF₃, ⁻N(SO₂)₂CF₃, CF₃BF₃⁻, ⁻O₃SCF₂CF₂CF₃, SO₄²⁻, ⁻O₂CCF₃, ⁻O₂CCF₂CF₂CF₃, or ⁻N(CN)₂.

In some embodiments, phosphonium ionic liquids or salts of the present invention are comprised of a single cation-anion pair. Alternatively, two or more phosphonium ionic liquids or salts may be used to form common binaries, mixed binaries, common ternaries, mixed ternaries, and the like. Composition ranges for binaries, ternaries, etc. include from 1 ppm, up to 999,999 ppm for each component cation and each component anion. In another embodiment, phosphonium electrolytes are comprised of one or more salts dissolved in a solvent, and the salts may be liquid or solid at a temperature of 100° C. In some embodiments, a salt is comprised of a single cation-anion pair. In other embodiments, a salt is comprised of a one cation and multiple anions. In other embodiments, a salt is comprised of one anion and multiple cations. In still other embodiments, a salt is comprised of multiple cations and multiple anions.

In one preferred embodiment, phosphonium ionic liquid compositions are comprised of cation and anion combinations as shown in Tables 1A and 1B, below. In another preferred embodiment, phosphonium electrolytes are comprised of cation and anion combinations shown in Tables 1C, 1D, 1E, and 1F below. For clarity, signs of charge have been omitted in the formulas.

Table 1A illustrates examples of anion binaries with a common cation:

TABLE 1A

| Cation | |
|---|---|
| Structure | Examples of Anion Binaries |
| 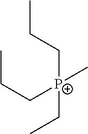 | 1NO₃⁻/1O₃SCF₃⁻ 3NO₃⁻/1O₃SCF₃⁻ 1NO₃⁻/3O₃SCF₃⁻ 1NO₃⁻/1N(SO₂CF₃)₂⁻ 1NO₃⁻/1PF₆⁻ 1O₃SCF₃⁻/1N(SO₂CF₃)₂⁻ 1O₃SCF₃⁻/1O₃SC₆H₄CH₃⁻ 3O₃SCF₃⁻/1O₃SC₆H₄CH₃⁻ 1O₃SCF₃⁻/1O₃SCF₂CF₂CF₃⁻ 1O₃SC₆H₄CH₃⁻/3O₃SCH₃⁻ 1O₃SC₆H₄CH₃⁻/1O₃SCF₂CF₂CF₃⁻ 3O₃SC₆H₄CH₃⁻/1O₃SCF₂CF₂CF₃⁻ 1O₃SC₆H₄CH₃⁻/3O₃SCF₂CF₂CF₃⁻ |

Table 1B illustrates examples of cation and anion combinations:

TABLE 1B

| Cation | |
|---|---|
| Structure | Anions |
| 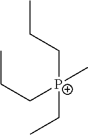 | I⁻ —N(SO₂)₂CF₃ —O₃SCF₃ —O₂CCF₃ —O₂CCF₂CF₂CF₃ —O₃SC₆H₄CH₃ CF₃BF₃⁻ C(CN)₃⁻ PF₆⁻ NO₃⁻ —O₃SCH₃ —O₃SC₆H₄CHCH₂ BF₄⁻ —O₃SCF₂CF₂CF₃ —SC(O)CH₃ SO₄²⁻ —O₂CCF₂CF₃ —O₂CH —O₂CC₆H₅ —OCN CO₃²⁻ |

In another embodiment, phosphonium electrolytes are comprised of salts having cations as shown in Tables 1C-1 to 1C-3 below:

TABLE 1C-1
Cations

| Formula | Structure |
|---|---|
| (CH₃)₄P | 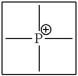 |
| (CH₃CH₂)(CH₃)₃P | 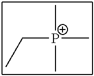 |
| (CH₃CH₂CH₂)(CH₃)₃P | 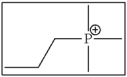 |
| (CH₃CH₂)₂(CH₃)₂P | 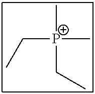 |
| (CH₃CH₂CH₂)₂(CH₃)₂P | 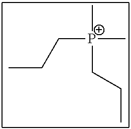 |
| (CH₃CH₂CH₂)(CH₃CH₂)(CH₃)₂P | 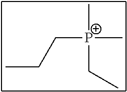 |
| (CH₃CH₂CH₂)(CH₃CH₂)₂(CH₃)P | 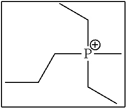 |
| (CH₃CH₂)₃(CH₃)P | 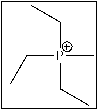 |
| (CH₃CH₂CH₂)(CH₃CH₂)₃P | 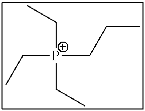 |
| (CH₃CH₂)₄P | 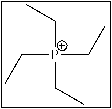 |
| (CH₃CH₂CH₂)₂(CH₃CH₂)₂P | 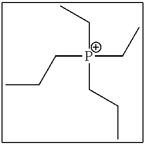 |

TABLE 1C-2
Cations

| Formula | Structure |
|---|---|
| (CH₃CH₂CH₂)₃(CH₃)P | 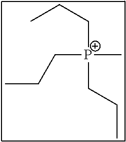 |
| (CH₃CH₂CH₂)₃(CH₃CH₂)P | 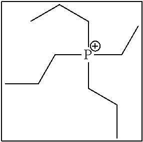 |
| (CH₃CH₂CH₂)₄P | 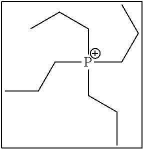 |
| (CF₃CH₂CH₂)(CH₃)₃P | 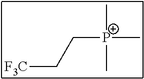 |
| (CF₃CH₂CH₂)(CH₃CH₂)₃P | 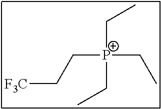 |
| (CF₃CH₂CH₂)₃(CH₃CH₂)P | 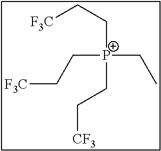 [SMILES: CC[P+](CCC(F)(F)F)(CCC(F)(F)F)CCC(F)(F)F] |
| (CF₃CH₂CH₂)₃(CH₃)P | 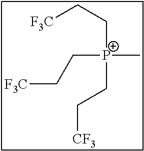 [SMILES: C[P+](CCC(F)(F)F)(CCC(F)(F)F)CCC(F)(F)F] |
| (CF₃CH₂CH₂)₄P | 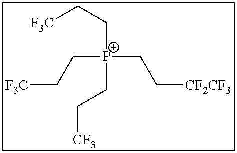 |
| (—CH₂CH₂CH₂CH₂—) (CH₃CH₂)(CH₃)P | 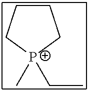 |
| (—CH₂CH₂CH₂CH₂—) (CH₃CH₂CH₂)(CH₃)P | 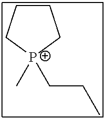 |

TABLE 1C-3
Cations

| Formula | Structure |
|---|---|
| (—CH₂CH₂CH₂CH₂—) (CH₃CH₂CH₂CH₂)(CH₃)P | 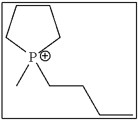 |
| (—CH₂CH₂CH₂CH₂—) (CH₃CH₂CH₂)(CH₃CH₂)P | 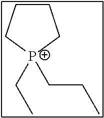 |
| (—CH₂CH₂CH₂CH₂—) (CH₃CH₂CH₂CH₂)(CH₃CH₂)P | 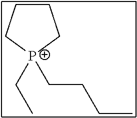 |
| (—CH₂CH₂CH₂CH₂CH₂—) (CH₃CH₂)(CH₃)P | 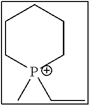 |
| (—CH₂CH₂CH₂CH₂CH₂—) (CH₃CH₂CH₂)(CH₃)P | 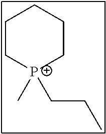 |
| (—CH₂CH₂CH₂CH₂CH₂—) (CH₃CH₂CH₂CH₂)(CH₃)P | 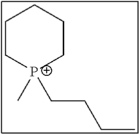 |
| (—CH₂CH₂CH₂CH₂CH₂—) (CH₃CH₂CH₂)(CH₃CH₂)P | 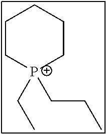 |
| (—CH₂CH₂CH₂CH₂CH₂—) (CH₃CH₂CH₂CH₂)(CH₃CH₂)P | 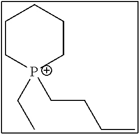 |

In another embodiment, phosphonium electrolytes are comprised of salts having anions as shown in Tables 1D-1 to 1D-4 below:

TABLE 1D-1
Anions

| Formula | Structure |
|---|---|
| PF₆ | 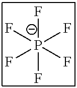 |
| (CF₃)₃PF₃ | 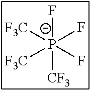 [SMILES: FC(F)(F)[P-](F)(F)(F)(C(F)(F)F)C(F)(F)F] |
| (CF₃)₄PF₂ | 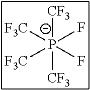 [SMILES: FC(F)(F)[P-](F)(F)(C(F)(F)F)(C(F)(F)F)C(F)(F)F] |
| (CF₃CF₂)₄PF₂ | 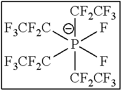 |
| (CF₃CF₂CF₂)₄PF₂ | 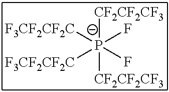 |
| (—OCOCOO—)PF₄ | 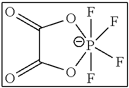 [SMILES: O=C1O[P-](F)(F)(F)(F)OC1=O] |
| (—OCOCOO—)(CF₃)₃PF | 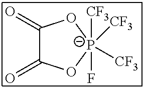 [SMILES: O=C1O[P-](F)(C(F)(F)F)(C(F)(F)F)(C(F)(F)F)OC1=O] |
| (—OCOCOO—)₃P | 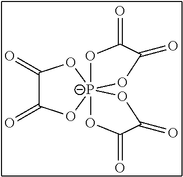 [SMILES: O=C1O[P-]23(OC1=O)(OC(=O)C(=O)O2)OC(=O)C(=O)O3] |
| BF₄ | 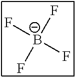 |
| CF₃BF₃ | 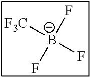 |
| (CF₃)₂BF₂ | 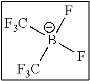 [SMILES: F[B-](F)(C(F)(F)F)C(F)(F)F] |

TABLE 1D-2
Anions

| Formula | Structure |
|---|---|
| (CF₃)₃BF | 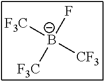 [SMILES: F[B-](C(F)(F)F)(C(F)(F)F)C(F)(F)F] |
| (CF₃)₄B | 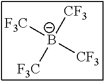 [SMILES: FC(F)(F)[B-](C(F)(F)F)(C(F)(F)F)C(F)(F)F] |
| (—OCOCOO—)BF₂ | 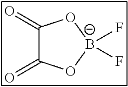 |
| (—OCOCOO—)BF(CF₃) | 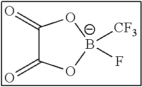 [SMILES: O=C1O[B-](F)(C(F)(F)F)OC1=O] |
| (—OCOCOO—)(CF₃)₂B | 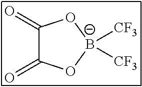 [SMILES: O=C1O[B-](C(F)(F)F)(C(F)(F)F)OC1=O] |
| (—OSOCH₂SOO—)BF₂ | 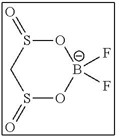 |
| (—OSOCF₂SOO—)BF₂ | 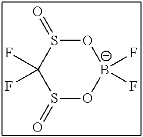 [SMILES: O=S1O[B-](F)(F)OS(=O)C1(F)F] |
| (—OSOCH₂SOO—)BF(CF₃) | 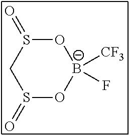 [SMILES: O=S1CS(=O)O[B-](F)(C(F)(F)F)O1] |
| (—OSOCF₂SOO—)BF(CF₃) | 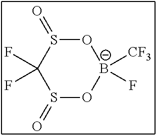 [SMILES: O=S1O[B-](F)(C(F)(F)F)OS(=O)C1(F)F] |
| (—OSOCH₂SOO—)B(CF₃)₂ | 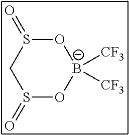 [SMILES: O=S1CS(=O)O[B-](C(F)(F)F)(C(F)(F)F)O1] |

TABLE 1D-3
Anions

| Formula | Structure |
|---|---|
| (—OSOCF₂SOO—)B(CF₃)₂ | 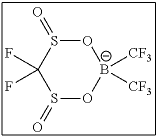 [SMILES: O=S1O[B-](C(F)(F)F)(C(F)(F)F)OS(=O)C1(F)F] |
| SO₃CF₃ | 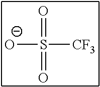 |
| (CF₃SO₂)₂N | 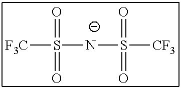 [SMILES: O=S(=O)([N-]S(=O)(=O)C(F)(F)F)C(F)(F)F] |
| (—OCOCOO—)₂PF₂ | 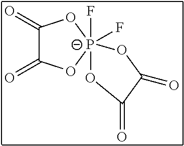 [SMILES: O=C1O[P-]2(F)(F)(OC1=O)OC(=O)C(=O)O2] |
| (CF₃CF₂)₃PF₃ | 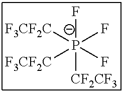 |
| (CF₃CF₂CF₂)₃PF₃ | 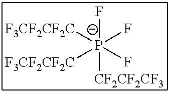 |
| (—OCOCOO—)₂B | 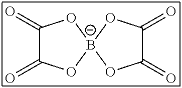 [SMILES: O=C1O[B-]2(OC1=O)OC(=O)C(=O)O2] |
| (—OCO(CH₂)ₙCOO—)BF(CF₃) | 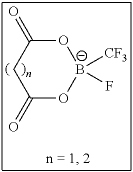 |
| (—OCOCR₂COO—)BF(CF₃) | 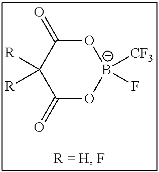 |
| (—OCOCR₂COO—)B(CF₃)₂ | 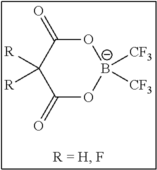 |

TABLE 1D-4
Anions

| Formula | Structure |
|---|---|
| (—OCOCR₂COO—)₂B | 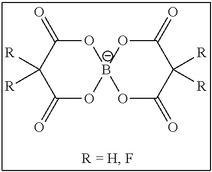 |
| CF₃BF(—OOR)₂ | 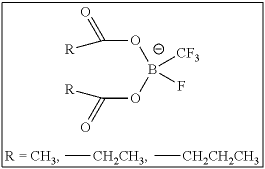 |
| CF₃B(—OOR)₃ | 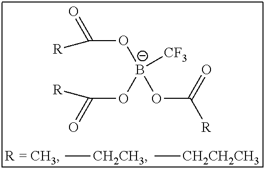 |
| CF₃B(—OOR)F₂ | 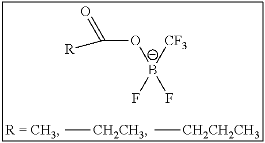 |
| (—OCOCOCOO—)BF(CF₃) | 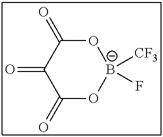 [SMILES: O=C1O[B-](F)(C(F)(F)F)OC(=O)C1=O] |
| (—OCOCOCOO—)B(CF₃)₂ | 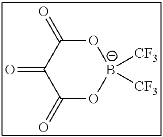 [SMILES: O=C1O[B-](C(F)(F)F)(C(F)(F)F)OC(=O)C1=O] |
| (—OCOCOCOO—)₂B | 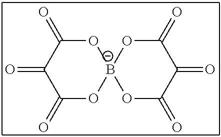 [SMILES: O=C1O[B-]2(OC(=O)C1=O)OC(=O)C(=O)C(=O)O2] |
| (—OCOCR¹R²CR¹R²COO—) BF(CF₃) | 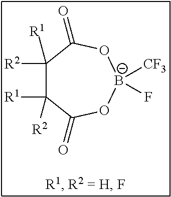 |
| (—OCOCR¹R²CR¹R²COO—) B(CF₃)₂ | 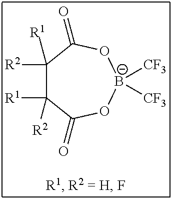 |

In further embodiments, phosphonium electrolyte compositions are comprised of salts having cation and anion combinations as shown in Tables 1E-1 to 1E-4 below:

TABLE 1E-1

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | PF₆ | 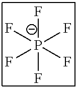 |
| | (CF₃)₃PF₃ | 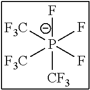 [SMILES: FC(F)(F)[P-](F)(F)(F)(C(F)(F)F)C(F)(F)F] |
| | (CF₃)₄PF₂ | 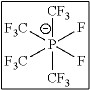 [SMILES: FC(F)(F)[P-](F)(F)(C(F)(F)F)(C(F)(F)F)C(F)(F)F] |
| | (CF₃CF₂)₄PF₂ | 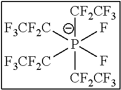 |
| | (CF₃CF₂CF₂)₄PF₂ | 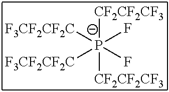 |
| | (—OCOCOO—)PF₄ | 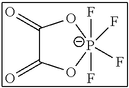 [SMILES: O=C1O[P-](F)(F)(F)(F)OC1=O] |
| | (—OCOCOO—)(CF₃)₃PF | 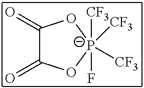 [SMILES: O=C1O[P-](F)(C(F)(F)F)(C(F)(F)F)(C(F)(F)F)OC1=O] |
| | (—OCOCOO—)₃P | 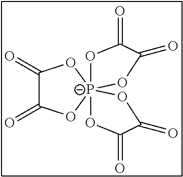 [SMILES: O=C1O[P-]23(OC1=O)(OC(=O)C(=O)O2)OC(=O)C(=O)O3] |
| | BF₄ | 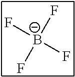 |
| | CF₃BF₃ | 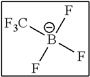 |
| | (CF₃)₂BF₂ | 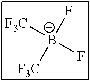 [SMILES: F[B-](F)(C(F)(F)F)C(F)(F)F] |

TABLE 1E-2

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | (CF₃)₃BF | 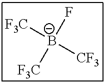 [SMILES: F[B-](C(F)(F)F)(C(F)(F)F)C(F)(F)F] |
| | (CF₃)₄B | 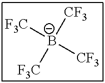 [SMILES: FC(F)(F)[B-](C(F)(F)F)(C(F)(F)F)C(F)(F)F] |
| | (—OCOCOO—)BF₂ | 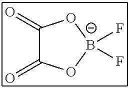 |
| | (—OCOCOO—)BF(CF₃) | 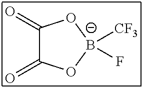 [SMILES: O=C1O[B-](F)(C(F)(F)F)OC1=O] |
| | (—OCOCOO—)(CF₃)₂B | 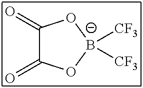 [SMILES: O=C1O[B-](C(F)(F)F)(C(F)(F)F)OC1=O] |
| | (—OSOCH₂SOO—)BF₂ | 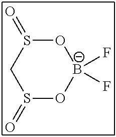 |
| | (—OSOCF₂SOO—)BF₂ | 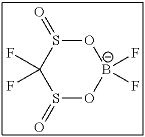 [SMILES: O=S1O[B-](F)(F)OS(=O)C1(F)F] |
| | (—OSOCH₂SOO—)BF(CF₃) | 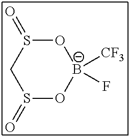 [SMILES: O=S1CS(=O)O[B-](F)(C(F)(F)F)O1] |
| | (—OSOCF₂SOO—)BF(CF₃) | 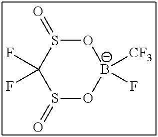 [SMILES: O=S1O[B-](F)(C(F)(F)F)OS(=O)C1(F)F] |
| | (—OSOCH₂SOO—)B(CF₃)₂ | 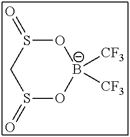 [SMILES: O=S1CS(=O)O[B-](C(F)(F)F)(C(F)(F)F)O1] |

TABLE 1E-3

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | (—OSOCF₂SOO—)B(CF₃)₂ | 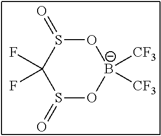 [SMILES: O=S1O[B-](C(F)(F)F)(C(F)(F)F)OS(=O)C1(F)F] |
| | SO₃CF₃ | 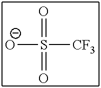 |
| | (CF₃SO₂)₂N | 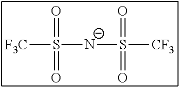 [SMILES: O=S(=O)([N-]S(=O)(=O)C(F)(F)F)C(F)(F)F] |
| | (—OCOCOO—)₂PF₂ | 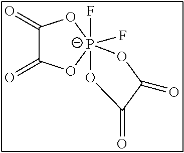 [SMILES: O=C1O[P-]2(F)(F)(OC1=O)OC(=O)C(=O)O2] |
| | (CF₃CF₂)₃PF₃ | 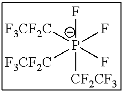 |
| | (CF₃CF₂CF₂)₃PF₃ | 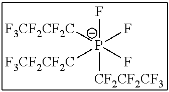 |
| | (—OCOCOO—)₂B | 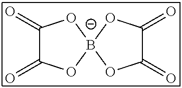 |
| | (—OCO(CH₂)ₙCOO—)BF(CF₃) | 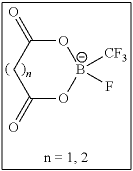 |
| | (—OCOCR₂COO—)BF(CF₃) | 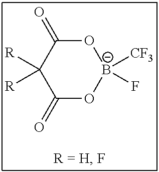 |
| | (—OCOCR₂COO—)B(CF₃)₂ | 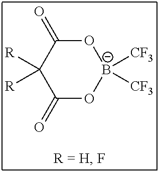 |

TABLE 1E-4

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | (—OCOCR₂COO—)₂B | 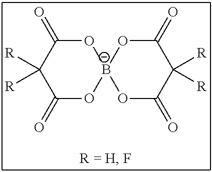 |
| | (CF₃)BF(—OOR)₂ | 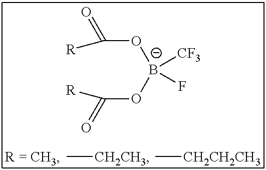 |
| | CF₃B(—OOR)₃ | 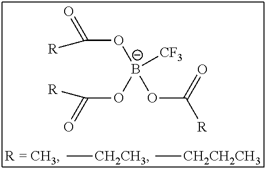 |
| | CF₃B(—OOR)F₂ | 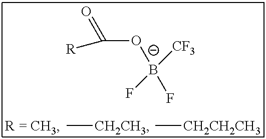 |
| | (—OCOCOCOO—)BF(CF₃) | 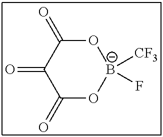 [SMILES: O=C1O[B-](F)(C(F)(F)F)OC(=O)C1=O] |
| | (—OCOCOCOO—)B(CF₃)₂ | 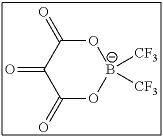 [SMILES: O=C1O[B-](C(F)(F)F)(C(F)(F)F)OC(=O)C1=O] |
| | (—OCOCOCOO—)₂B | 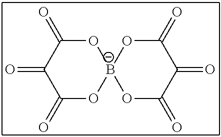 [SMILES: O=C1O[B-]2(OC(=O)C1=O)OC(=O)C(=O)C(=O)O2] |
| | (—OCOCR¹R²CR¹R²COO—)BF(CF₃) | 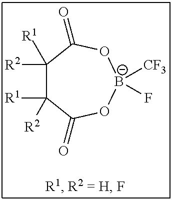 |
| | (—OCOCR¹R²CR¹R²COO—) B(CF₃)₂ | 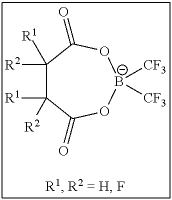 |

In some embodiments, the phosphonium electrolyte is comprised of a salt dissolved in a solvent, where the salt is comprised of: one or more cations of the formula:

P(CH₃CH₂CH₂)_{y}(CH₃CH₂)ₓ(CH₃)_{4-x-y} (x,y=0 to 4;x+y≦4)

P(CF₃CH₂CH₂)_{y}(CH₃CH₂)ₓ(CH₃)_{4-x-y} (x,y=0 to 4;x+y≦4)

P(—CH₂CH₂CH₂CH₂—)(CH₃CH₂CH₂)_{y}(CH₃CH₂)ₓ(CH₃)_{2-x-y} (x,y=0 to 2;x+y≦2)

P(—CH₂CH₂CH₂CH₂CH₂—)(CH₃CH₂CH₂)_{y}(CH₃CH₂)ₓ(CH₃)_{2-x-y} (x,y=0 to 2;x+y≦2)

and one or more anions of the formula:

(CF₃)ₓBF₄₋ₓ (x=0 to 4)

(CF₃(CF₂)ₙ)ₓPF₆₋ₓ (n=0 to 2;x=0 to 4)

(—OCO(CH₂)ₙCOO—)(CF₃)ₓBF₂₋ₓ (n=0 to 2;x=0 to 2)

(—OCO(CF₂)ₙCOO—)(CF₃)ₓBF₂₋ₓ (n=0 to 2;x=0 to 2)

(—OCO(CH₂)ₙCOO—)₂B (n=0 to 2)

(—OCO(CF₂)ₙCOO—)₂B (n=0 to 2)

(—OOR)ₓ(CF₃)BF₃₋ₓ (x=0 to 3)

(—OCOCOCOO—)(CF₃)ₓBF₂₋ₓ (x=0 to 2)

(—OCOCOCOO—)₂B

(—OSOCH₂SOO—)(CF₃)ₓBF₂₋ₓ (x=0 to 2)

(—OSOCF₂SOO—)(CF₃)ₓBF₂₋ₓ (x=0 to 2)

(—OCOCOO—)ₓ(CF₃)_{y}PF_{6-2x-y} (x=1 to 3;y=0 to 4;2x+y≦6)

In another embodiment, the phosphonium electrolyte is comprised of a salt dissolved in a solvent, wherein the salt is comprised of: one or more cations of the formula:

P(CH₃CH₂CH₂)_{y}(CH₃CH₂)ₓ(CH₃)_{4-x-y} (where x,y=0 to 4;x+y≦4)

and;
one or more anions of the formula:

(CF₃)ₓBE₄₋ₓ (where x=0 to 4)

(CF₃(CF₂)ₙ)ₓPF₆₋ₓ (where n=0 to 2;x=0 to 4)

(—OCO(CH₂)ₙCOO—)(CF₃)ₓBF₂₋ₓ (where n=0 to 2;x=0 to 2)

(—OCO(CH₂)ₙCOO—)₂B (where n=0 to 2)

(—OSOCH₂SOO—)(CF₃)ₓBF₂₋ₓ (where x=0 to 2)

(—OCOCOO—)ₓ(CF₃)_{y}PF_{6-2x-y} (x=1 to 3;y=0 to 4;2x+y≦6)

In another embodiment, the phosphonium electrolyte is comprised of a salt dissolved in a solvent, wherein the salt is comprised of: one or more cations of the formula:

P(—CH₂CH₂CH₂CH₂—)(CH₃CH₂CH₂)_{y}(CH₃CH₂)ₓ(CH₃)_{2-x-y} (where x,y=0 to 2;x+y≦2)

P(—CH₂CH₂CH₂CH₂CH₂—)(CH₃CH₂CH₂)_{y}(CH₃CH₂)ₓ(CH₃)_{2-x-y} (where x,y=0 to 2;x+y≦2)

and;
one or more anions of the formula:

(CF₃)ₓBF₄₋ₓ (where x=0 to 4)

(CF₃(CF₂)ₙ)ₓPF₆₋ₓ (where n=0 to 2;x=0 to 4)

(—OCO(CH₂)ₙCOO—)(CF₃)ₓBF₂₋ₓ (where n=0 to 2;x=0 to 2)

(—OCO(CH₂)ₙCOO—)₂B (where n=0 to 2)

(—OSOCH₂SOO—)(CF₃)ₓBF₂₋ₓ (where x=0 to 2)

(—OCOCOO—)ₓ(CF₃)_{y}PF_{6-2x-y} (x=1 to 3;y=0 to 4;2x+y≦6)

In one embodiment, the phosphonium electrolyte is comprised of a salt dissolved in a solvent, where the salt is comprised of one or more anions selected from the group consisting of: PF₆, (CF₃)₃PF₃, (CF₃)₄PF₂, (CF₃CF₂)₄PF₂, (CF₃CF₂CF₂)₄PF₂, (—OCOCOO—)PF₄, (—OCOCOO—)(CF₃)₃PF, (—OCOCOO—)₃P, BF₄, CF₃BF₃, (CF₃)₂BF₂, (CF₃)₃BF, (CF₃)₄B, (—OCOCOO—)BF₂, (—OCOCOO—)BF(CF₃), (—OCOCOO—)(CF₃)₂B, (—OSOCH₂SOO—)BF₂, (—OSOCF₂SOO—)BF₂, (—OSOCH₂SOO—)BF(CF₃), (—OSOCF₂SOO—)BF(CF₃), (—OSOCH₂SOO—)B(CF₃)₂, (—OSOCF₂SOO—)B(CF₃)₂, CF₃SO₃, (CF₃SO₂)₂N, (—OCOCOO—)₂PF₂, (CF₃CF₂)₃PF₃, (CF₃CF₂CF₂)₃PF₃, (—OCOCOO—)₂B, (—OCO(CH₂)ₙCOO—)BF(CF₃), (—OCOCR₂COO—)BF(CF₃), (—OCOCR₂COO—)B(CF₃)₂, (—OCOCR₂COO—)₂B, CF₃BF(—OOR)₂, CF₃B(—OOR)₃, CF₃B(—OOR)F₂, (—OCOCOCOO—)BF(CF₃), (—OCOCOCOO—)B(CF₃)₂, (—OCOCOCOO—)₂B, (—OCOCR¹R²CR¹R²COO—)BF(CF₃), and (—OCOCR¹R²CR¹R²COO—)B(CF₃)₂; and where R, R¹, and R² are each independently H or F.

In one embodiment, the phosphonium electrolyte is comprised of a salt dissolved in a solvent, where the salt is comprised of: a cation of the formula: (CH₃CH₂CH₂)(CH₃CH₂)(CH₃)₂P⁺ and an anion of any one or more of the formula: BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In another embodiment, the phosphonium electrolyte is comprised of a salt dissolved in a solvent, where the salt is comprised of: a cation of the formula (CH₃)(CH₃CH₂)₃P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In a another embodiment, the phosphonium electrolyte is comprised of a salt dissolved in a solvent, where the salt is comprised of: a cation of the formula (CH₃CH₂CH₂)(CH₃CH₂)₃P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In a another embodiment, the phosphonium electrolyte is comprised of a salt dissolved in a solvent, where the salt is comprised of: a cation of the formula (CH₃CH₂CH₂)₃(CH₃)P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In a another embodiment, the phosphonium electrolyte is comprised of a salt dissolved in a solvent, where the salt is comprised of: a cation of the formula (CH₃CH₂CH₂)₃(CH₃CH₂)P⁺ and an anion of any one or more of the formula BF₄⁻, PF₆⁻, CF₃BF₃⁻, (—OCOCOO—)BF₃⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In a another embodiment, the phosphonium electrolyte is comprised of a salt dissolved in a solvent, where the salt is comprised of: a cation of the formula (CH₃CH₂CH₂)₂(CH₃CH₂) (CH₃)P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In a another embodiment, phosphonium electrolyte is comprised of a salt dissolved in a solvent, where the salt is comprised of: a cation of the formula (CH₃CH₂)₄P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In a further embodiment, the phosphonium electrolyte is comprised of a salt dissolved in a solvent, where the salt is comprised of: a cation of the formula 1:3:1 mole ratio of (CH₃CH₂CH₂)(CH₃)₃P/(CH₃CH₂CH₂)(CH₃CH₂)(CH₃)₂P/(CH₃CH₂CH₂)(CH₃CH₂)₂(CH₃)P and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof. In some embodiments, the anions are comprised of a mixture of BF₄⁻ and CF₃BF₃⁻ at a concentration of [BF₄⁻]:[CF₃BF₃⁻] mole ratio in the range of 100/1 to 1/1. In other embodiments, the anions are comprised of a mixture of PF₆⁻ and CF₃BF₃⁻ at a concentration of [PF₆⁻]:[CF₃BF₃⁻] mole ratio in the range of 100/1 to 1/1. In even further embodiments, the anions are comprised of a mixture of PF₆⁻ and BF₄⁻ at a concentration of [PF₆⁻]:[BF₄⁻] mole ratio in the range of 100/1 to 1/1.

In another preferred embodiment, phosphonium ionic liquid compositions are comprised of cation and anion combinations as shown in Table 2 below:

TABLE 2

| Cation | |
|---|---|
| Structure | Anions |
| 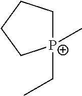 | I⁻ C(CN)₃⁻ —O₃SCF₃ —N(SO₂)₂CF₃ NO₃⁻ CF₃BF₃⁻ —O₃SCF₂CF₂CF₃ SO₄²⁻ —N(CN)₂ |

In another preferred embodiment, phosphonium ionic liquid compositions are comprised of cation and anion combinations as shown in Table 3 below:

TABLE 3

| Cation | |
|---|---|
| Structure | Anions |
| 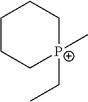 | I⁻ —N(SO₂)₂CF₃ C(CN)₃⁻ —O₃SCF₂CF₂CF₃ NO₃⁻ —O₂CCF₃ —O₂CCF₂CF₂CF₃ |

In a further preferred embodiment, phosphonium ionic liquid compositions are comprised of the cation and anion combinations as shown in Table 4 below:

TABLE 4

| Cation | |
|---|---|
| Structure | Anions |
| 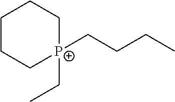 | I⁻ —N(SO₂)₂CF₃ —O₃SC₆H₄CH₃ —O₃SCF₂CF₂CF₃ —O₂SCF₃ |

In yet a further preferred embodiment, phosphonium ionic liquid compositions are comprised of the cation and anion combinations as shown in Table 5 below:

TABLE 5

| Cation | |
|---|---|
| Structure | Anions |
| 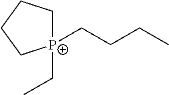 | I⁻ —N(SO₂)₂CF₃ —O₂SCF₃ —O₂SCF₂CF₂CF₃ |

In another preferred embodiment, phosphonium ionic liquid compositions are comprised of the cation and anion combinations as shown in Table 6 below:

TABLE 6

| Cation | |
|---|---|
| Structure | Anions |
| 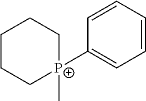 | I⁻ —N(SO₂)₂CF₃ —O₃SCF₃ NO₃⁻ C(CN)₃⁻ PF₆⁻ |

In another preferred embodiment, phosphonium ionic liquid compositions are comprised of cation and anion combinations as shown in Table 7 below:

TABLE 7

| Cation | |
|---|---|
| Structure | Anions |
| 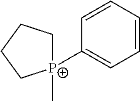 | I⁻ NO₃⁻ —N(SO₂)₂CF₃ |

In another preferred embodiment, phosphonium ionic liquid compositions are comprised of cation and anion combinations as shown in Table 8 below:

TABLE 8

| Cation | |
|---|---|
| Structure | Anions |
| 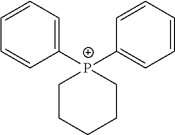 [SMILES: c1ccc([P+]2(c3ccccc3)CCCCC2)cc1] | I⁻ —N(SO₂)₂CF₃ |

In another preferred embodiment, phosphonium ionic liquid compositions are comprised of cation and anion combinations as shown in Table 9 below:

TABLE 9

| Cation | |
|---|---|
| Structure | Anions |
| 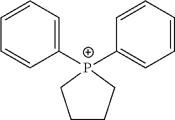 [SMILES: c1ccc([P+]2(c3ccccc3)CCCC2)cc1] | I⁻ —N(SO₂)₂CF₃ |

In another preferred embodiment, phosphonium ionic liquid compositions are comprised of cation and anion combinations as shown in Table 10 below:

TABLE 10

| Cation | |
|---|---|
| Structure | Anions |
| 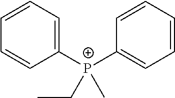 [SMILES: CC[P+](C)(c1ccccc1)c1ccccc1] | I⁻ NO₃⁻ —N(SO₂)₂CF₃ |

Additional preferred embodiments include phosphonium ionic liquid compositions are comprised of cation and anion combinations as shown in Table 11 below:

TABLE 11

| Cation | |
|---|---|
| Structure | Anions |
| 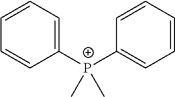 | I⁻ NO₃⁻ —N(SO₂)₂CF₃ |

Provided are further preferred embodiments of phosphonium ionic liquid compositions comprised of cation and anion combinations as shown in Table 12 below:

TABLE 12

| Cation | |
|---|---|
| Structure | Anions |
| 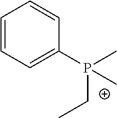 | I⁻ NO₃⁻ —N(SO₂)₂CF₃ |

Another preferred exemplary embodiment includes phosphonium ionic liquid compositions comprised of cation and anion combinations as shown in Table 13 below:

TABLE 13

| Cation | |
|---|---|
| Structure | Anions |
| 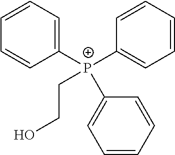 [SMILES: OCC[P+](c1ccccc1)(c1ccccc1)c1ccccc1] | Br— —N(SO₂)₂CF₃ —O₃SCF₃ PF₆⁻ NO₃⁻ |

In some embodiments further examples of suitable phosphonium ionic liquid compositions include but are not limited to: di-n-propyl ethyl methyl phosphonium bis-(trifluoromethyl sulfonyl)imide; n-butyl n-propyl ethyl methyl phosphonium bis-(trifluoromethyl sulfonyl)imide; n-hexyl n-butyl ethyl methyl phosphonium bis-(trifluoromethyl sulfonyl)imide; and the like.

Illustrative examples of suitable phosphonium ionic liquid compositions further include but are not limited to: 1-ethyl-1-methyl phospholanium bis-(trifluoromethyl sulfonyl)imide; n-propyl methyl phospholanium bis-(trifluoromethyl sulfonyl)imide; n-butyl methyl phospholanium bis-(trifluoromethyl sulfonyl)imide; n-hexyl methyl phopholanium bis-(trifluoromethyl sulfonyl)imide; and phenyl methyl phospholanium bis-(trifluoromethyl sulfonyl)imide.

In another embodiment, examples of suitable phosphonium ionic liquid compositions include but are not limited to: 1-ethyl-1-methyl phospholanium bis-(trifluoromethyl sulfonyl)imide; n-propyl methyl phospholanium bis-(trifluoromethyl sulfonyl)imide; n-butyl methyl phospholanium bis-(trifluoromethyl sulfonyl imide; n-hexyl methyl phopholanium bis-(trifluoromethyl sulfonyl)imide; and phenyl methyl phospholanium bis-(trifluoromethyl sulfonyl)imide.

Further exemplary embodiments of suitable phosphonium ionic liquid compositions include but are not limited to: 1-ethyl-1-methyl phosphacyclohexane bis-(trifluoromethyl sulfonyl)imide; n-propyl methyl phosphacyclohexane bis-(trifluoromethyl sulfonyl)imide; n-butyl methyl phosphacyclohexane bis-(trifluoromethyl sulfonyl)imide; n-hexyl methyl phosphacyclohexane bis-(trifluoromethyl sulfonyl)imide; and phenyl methyl phosphacyclohexane bis-(trifluoromethyl sulfonyl)imide.

Phosphonium ionic liquids of the present invention may also form a eutectic from one or more solids, or from a solid and a liquid, according to some embodiments. In this instance, the term “ionic liquid” is further defined to include ionic liquid that are eutectics from ionic solids, or from an ionic liquid and an ionic solid, such as binaries, ternaries, and the like.

### Synthesis by Mixed Grignard Reagent Route

In some embodiments a method of synthesizing one or more molecules having low average symmetry, generally a mixture where one or more components have symmetry lower than C₃ᵥ, is provided comprising: reacting a reactant with a mixture of at least two different Grignard reagents, where the Grignard reagents are present at selected mole fractions or ratios in the mixture. The method of the present invention enables synthesis of salts having a distribution of cations at selectively desired mole fractions or ratios.

In some embodiments, a method of forming a mixture of salts having selective mole ratios of cations is provided, comprising: reacting a reactant (R) with a mixture of two different Grignard reagents (Rₐ and R_{b}), the Grignard reagents being present in the mixture at mole fractions fₐ and f_{b}, respectively, where fₐ+f_{b}=1.

In one example, a low symmetry phosphonium salt is synthesized from phosphorus trichloride, which is an inexpensive material and is non-pyrophoric. Specifically, phosphorus trichloride is added to a mixture of two different Grignard reagents. In this example, the Grignard reagent is comprised of a 2:1 mole ratio mixture of methyl Grignard reagent (CH₃MgX) and ethyl Grignard reagent (CH₃CH₂MgX). This results in an intermediate product mix comprised of a mixture of trimethyl phosphine, ethyldimethyl phosphine and dithylmeythyl phosphine with trace amount of triethyl phosphine, with ethyldimethyl phosphine being the most predominant species in the mixture. Propyl iodide is then added to yield the corresponding mixture of phosphonium iodides. Ion exchange is then performed to replace iodide with the desired anion A⁻. The final product is a mixture of salts with distributed cations at various desirable mole ratios. Of particular advantage, synthesis methods of the present invention enable direct synthesis of a product mixture having a selectively controlled distribution of compounds in the mixture. In the example of salts, the synthesis methods of the present invention enable direct synthesis of a mixture having a desired distribution of cations.

The synthesis route according to this example of the present invention may be shown as the following four steps:

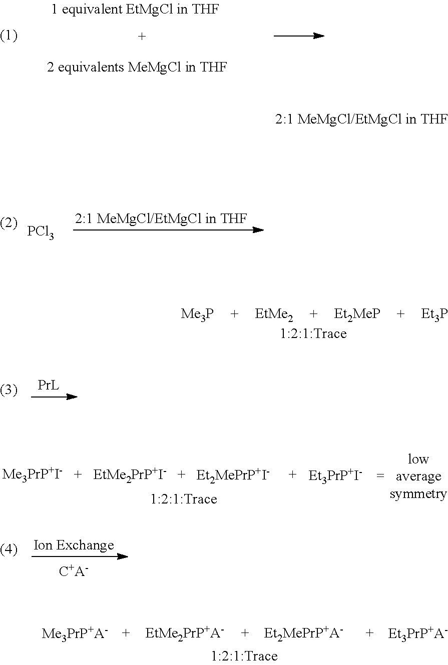

wherein Me stands for (CH₃), Et for (CH₃CH₂), Pr for (CH₃CH₂CH₂), C⁺ for a cation, and A⁺ for an anion.

The synthesis route according to another example of the present invention may be shown as the following four steps:

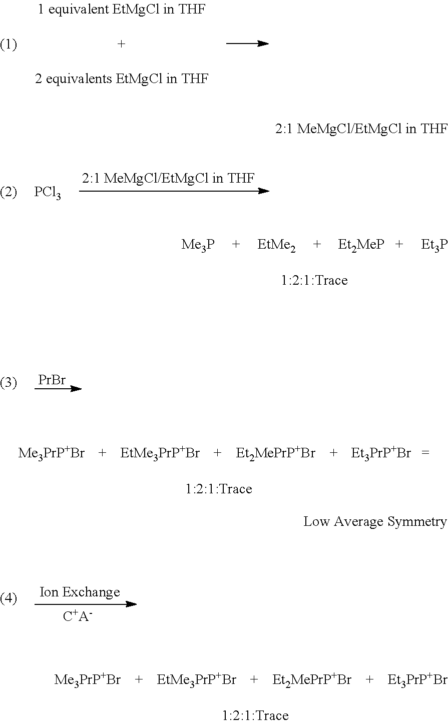

wherein Me stands for (CH₃), Et for (CH₃CH₂), Pr for (CH₃CH₂CH₂), C⁺ for a cation, and A⁺ for an anion.

The above example is illustrative. Other mixtures can be obtained by varying the ratio of alkyl magnesium chlorides or by introducing other alkyl magnesium chlorides in Step 1, and the introduction of different alkyl halides in Step 3 provides even further selection variation and control of the resultant salt mixture. For instance a mixture of propyl and butyl iodide introduced in Step 3 would further increase the number of phosphonium salts present in the final mixture.

In another embodiment, a method of synthesizing molecules and salts having low average symmetry are provided comprising the following reaction scheme:

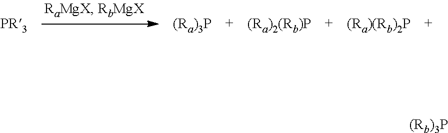

where Grignard reagents are comprised of: RₐMgX and R_{b}MgX, and where Rₐ and R_{b} are independently comprised of any one or more of: alkyl, alkenyl, alkynyl, aryl or any other material capable of producing an organomagnesium compound and X is Cl, Br or I. In some embodiments in reactant PR′₃, R′ is comprised of any one or more of: chloro, bromo, iodo, alkyloxy, aryloxy or any other suitable leaving group, generally with a greater electronegativity than carbon. The method further comprises the steps of reacting the mixture of phosphines with one or more alkyl halides to produce a corresponding mixture of phosphonium halides; and ion exchanging the halides with an anion A⁻ to form a mixture of phosphonium ionic liquids or salts having selective mole fractions.

In some embodiments, Grignard reagents RₐMgX and R_{b}MgX are present at mole fractions fₐ and f_{b} respectively, where fₐ+f_{b}=1. In this example, the resulting product is a mixture of phosphines having the following mole ratio: (Rₐ)₃P:(Rₐ)₂(R_{b})P:(Rₐ)(R_{b})₂P:(R_{b})₃P; and fₐ³:3*(fₐ²*f_{b}):3*(fₐ*f_{b}²):f_{b}³. In this embodiment, example mixtures that may be obtained, include the following without limitation:

### Example A

For fₐ=f_{b}=½, that is a Grignard mixture Rₐ:R_{b}=1:1 mole ratio, the following fractions are obtained in the intermediate product mix:

Fraction (Rₐ)₃P=(½)³=⅛
Fraction (Rₐ)₂(R_{b})P=3*((½)²*½)=⅜
Fraction (Rₐ)(R_{b})₂P=3*(½*(½)²)=⅜
Fraction (R_{b})₃P=(½)³=⅛
Thus, the mole ratio of (Rₐ)₃P:(Rₐ)₂(R_{b})P:(Rₐ)(R_{b})₂P:(R_{b})₃P=1:3:3:1. When normalized to 1 mole product, the composition is comprised of 0.125, 0.375, 0.375, 0.125 moles of (Rₐ)₃P, (Rₐ)₂(R_{b})P, (Rₐ)(R_{b})₂P, (R_{b})₃P respectively.

### Example B

In another example, For fₐ= 9/10 and f_{b}= 1/10, that is a Grignard mixture Rₐ:R_{b}=9:1 mole ratio, the following fractions are obtained in the intermediate product mix:

Fraction (Rₐ)₃P=( 9/10)³= 729/1000
Fraction (Rₐ)₂(R_{b})P=3*(( 9/10)²* 1/10)= 243/1000
Fraction (Rₐ)(R_{b})₂P=3*( 9/10*( 1/10)²)= 27/1000
Fraction (R_{b})₃P=( 1/10)³= 1/1000
Thus, the mole ratio of (Rₐ)₃P:(Rₐ)₂(R_{b})P:(Rₐ)(R_{b})₂P:(R_{b})₃P=729:243:27:1. When normalized to 1 mole product, the composition is comprised of 0.729, 0.243, 0.027, 0.001 moles of (Rₐ)₃P, (Rₐ)₂(R_{b})P, (Rₐ(R_{b})₂P, (R_{b})₃P respectively.

### Example C

In another example For fₐ=⅔ and f_{b}=⅓, that is a Grignard mixture Ra:Rb=2:1 mole ratio. With Rₐ=CH₃MgX and R_{b}=CH₃CH₂MgX, the following fractions are obtained in the intermediate product mix:

Fraction Me₃P=(⅔)³= 8/27
Fraction EtMe₂P=3*((⅔)²*⅓)= 12/27
Fraction Et₂MeP=3*(⅔*(⅓)²)= 6/27
Fraction Et₃P=(⅓)³= 1/27
Thus, the mole ratio of Me₃P:EtMe₂P:Et₂MeP:Et₃P is 8:12:6:1. When normalized to 1 mole product, the composition is comprised of 0.296, 0.444, 0.222, 0.037 moles of Me₃P:EtMe₂P:Et₂MeP:Et₃P respectively.

In some embodiments, the mixture of reagents is comprised of more than two Grignard reagents. For a mixture of three Grignard, Rₐ, R_{b} and R_{c} at mole fractions fₐ, f_{b} and f_{c} (where fₐ+f_{b}+f_{c}=1) reacted with PR′₃ the distribution of compounds in the intermediate product mix shown in Table 14 is obtained:

TABLE 14

| Compound | Mole Fraction |
|---|---|
| (Rₐ)₃P | (fₐ)³ |
| (R_{b})₃P | (f_{b})³ |
| (R_{c})₃P | (f_{c})³ |
| (Rₐ)₂(R_{b})P | 3 * (fₐ² * f_{b}) |
| (Rₐ)(R_{b})₂P | 3 * (fₐ * f_{b}²) |
| (Rₐ)₂(R_{c})P | 3 * (fₐ² * f_{c}) |
| (Rₐ)(R_{c})₂P | 3 * (fₐ * f_{c}²) |
| (R_{b})₂(R_{c})P | 3 * (f_{b}² * f_{c}) |
| (R_{b})(R_{c})₂P | 3 * (f_{b} * f_{c}²) |
| (Rₐ)(R_{b})(R_{c})P | 6 * (fₐ * f_{b} * f_{c}) |

For a mixture of four Grignard, Rₐ, R_{b}, R_{c} and R_{d} at mole fractions fₐ, f_{b}, f_{c} and f_{d} (where fₐ+f_{b}+f_{c}+f_{d}=1) reacted with PR′₃ the distribution of compounds in the intermediate product mix shown in Table 15 is obtained:

TABLE 15

| Compound | Mole Fraction |
|---|---|
| (Rₐ)₃P | (fₐ)³ |
| (R_{b})₃P | (f_{b})³ |
| (R_{c})₃P | (f_{c})³ |
| (R_{d})₃P | (f_{d})³ |
| (Rₐ)₂(R_{b})P | 3 * (fₐ² * f_{b}) |
| (Rₐ)(R_{b})₂P | 3 * (fₐ * f_{b}²) |
| (Rₐ)₂(R_{c})P | 3 * (fₐ² * f_{c}) |
| (Rₐ)(R_{c})₂P | 3 * (fₐ * f_{c}²) |
| (Rₐ)₂(R_{c})P | 3 * (fₐ² * f_{d}) |
| (Rₐ)(R_{d})₂P | 3 * (fₐ * f_{d}²) |
| (R_{b})₂(R_{c})P | 3 * (f_{b}² * f_{c}) |
| (R_{b})(R_{c})₂P | 3 * (f_{b} * f_{c}²) |
| (R_{b})₂(R_{d})P | 3 * (f_{b}² * f_{d}) |
| (R_{b})(R_{d})₂P | 3 * (f_{b} * f_{d}²) |
| (R_{c})₂(R_{d})P | 3 * (f_{c}² * f_{d}) |
| (R_{c})(R_{d})₂P | 3 * (f_{c} * f_{d}²) |
| (Rₐ)(R_{b})(R_{c})P | 6 * (fₐ * f_{b} * f_{c}) |
| (Rₐ)(R_{b})(R_{d})P | 6 * (fₐ * f_{b} * f_{d}) |
| (Rₐ)(R_{c})(R_{d})P | 6 * (fₐ * f_{c} * f_{d}) |
| (R_{b})(R_{c})(R_{d})P | 6 * (f_{b} * f_{c} * f_{d}) |

The distribution of compounds shown in Tables 14 and 15 are the theoretical distribution based on equivalent reactivity of all starting materials and intermediates. In practice the distribution may vary as certain intermediates may be more or less reactive towards the different Grignard reagents in the system. This effect will be greater with increasing difference between the Grignard present. A mixture of alkyl Grignard reagents with a large difference in steric bulk (For example a mixture of tert-butylmagnesium chloride and methyl magnesium chloride) will stray further from the theoretical distribution than a mixture of two similar sized Grignard reagents (CH₃MgX and CH₃CH₂MgX for example). Differences in electronic properties could have similar effects, such as a mixture of alkyl and aryl Grignards.

Of particular advantage, the synthesis methodology of the present invention may be employed in a variety of cases, such as without limitation:

Phosphines, phosphoniums, phosphine oxides and other molecules containing the trialkylphosphine (R₃P) fragment.

Reactions with carbonyl containing molecules. Aldehydes and ketones generally react with Grignard reagents to add one Grignard per aldehyde or ketone functionality (other reactive groups may be present which independently react with Grignards) to give primary or secondary alcohols, respectively. Ester groups usually react with two equivalents of Grignard reagents to produce tertiary alcohols. A mixed Grignard system will give a distribution of alcohols, with the composition depending on the nature of the carbonyl (aldehyde, ketone, ester), the number of such functional groups in the reagent molecule, and the mixture of Grignard used. Any combination of aldehyde, ketone and ester functionality may be present in one molecule in the reaction, or in separate molecules included in a single reaction.

In some embodiments, methods of the present invention comprise synthesis reactions of Mono-aldehyde with two Grignards:

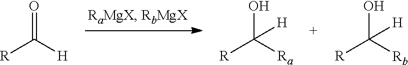

In another embodiment, methods of the present invention comprise synthesis reactions of Di-aldehyde with two Grignards:

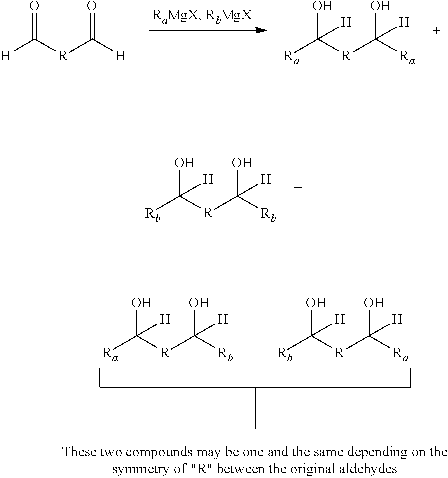

In another embodiment, methods of the present invention comprise synthesis reactions of Di-ketone with two Grignards:

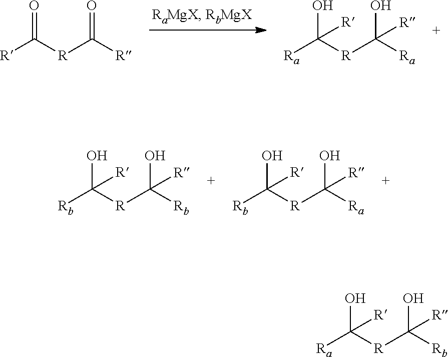

In another embodiment, methods of the present invention comprise synthesis reactions of Mono-ester with three Grignards:

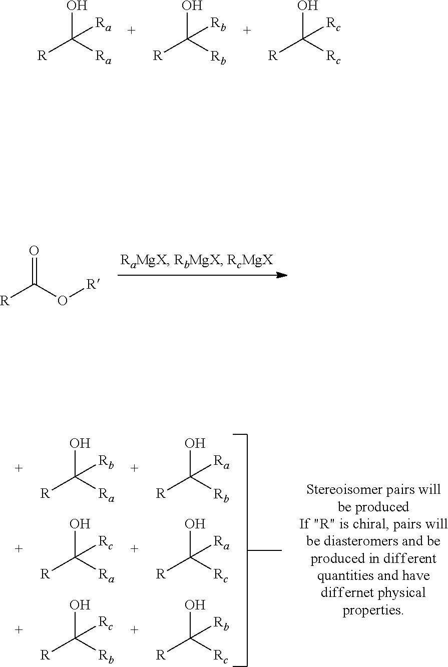

In a further embodiment, methods of the present invention comprise synthesis reactions with mixed Grignards. Mixed Grignards can be used to produce a distribution of products from metal catalyzed Grignard couplings. The Grignard reagents are generally aryl, alkenyl or alkynyl and the halogenated coupling partners are generally aryl or alkenyl.

In one embodiment, methods of the present invention comprise synthesis reactions of an alkenyl bromide with two Grignards:

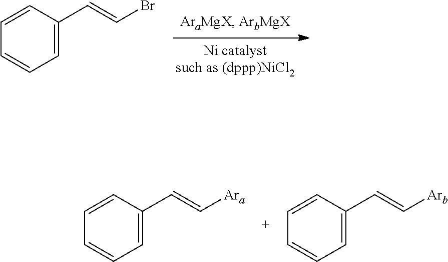

In another embodiment, methods of the present invention comprise synthesis reactions of a di-bromo aryl group with inequivalent reactive sites and two Grignards:

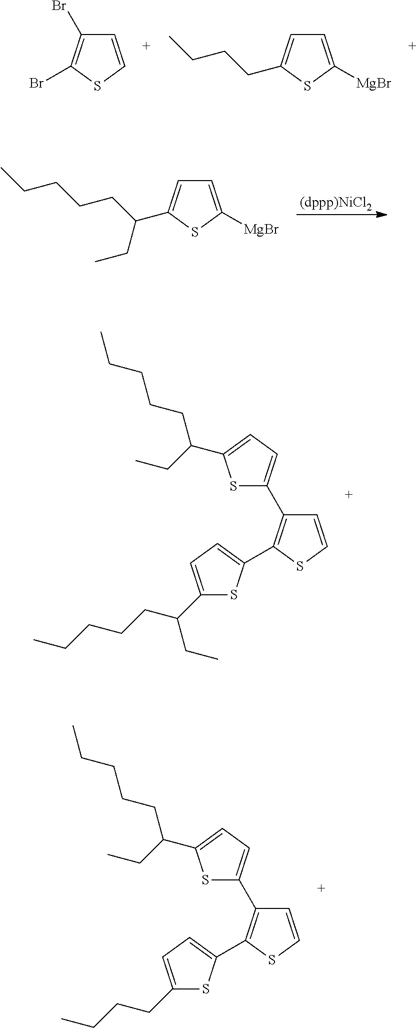

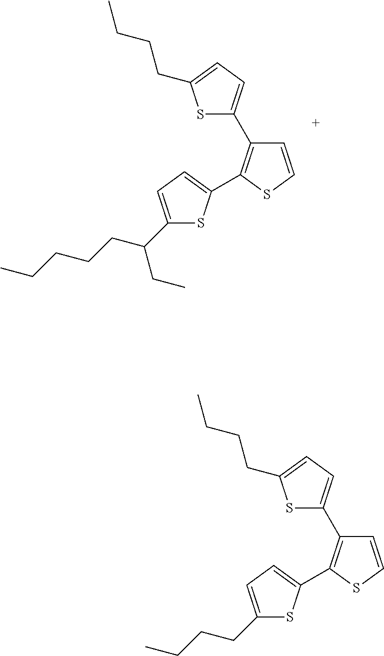 [SMILES: CCCCCC(CC)c1ccc(-c2sccc2-c2ccc(CCCC)s2)s1 ; CCCCc1ccc(-c2ccsc2-c2ccc(CCCC)s2)s1]

In even further embodiments, methods of the present invention comprise synthesis reactions with metal complexes. Many metal-halogen bonds can be reacted with Grignards to give metal-carbon bonds. In the example shown below “M” is any suitable metal or metal-ligand complex and Y is any suitable leaving group such as Cl, Br, I, CH₃C₆H₄SO₃, CF₃SO₃, OR, and the like. One metal or metal ligand complex may have a single or multiple reactive sites.

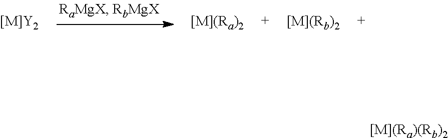

In another embodiments, a method of synthesizing a mixture of phosphonium salts or ionic liquids having controlled cation distribution, comprising the steps of: reacting a reactant of formula PR′₃ with a mixture of Grignard reagents to form a product mixture, wherein each R′ is independently a leaving group having electronegativity greater than carbon; reacting the product mixture of step (i) with an halogen containing compound thereby producing a mixture of phosphonium halides; and ion exchanging the halides with an anion to form a mixture of phosphonium salts or ionic liquids. In some embodiments R′ is selected independently from the group consisting of chloro, bromo, iodo, alkyloxy, aryloxy, thioalkyl, perfluoroalkylsulfonates, tosylates, mesylates, and any combinations thereof. In some embodiments, the reactant is PCl₃.

Optionally, at least two Grignard reagents in the mixture of Grignard reagents comprise a different organic group, wherein the organic group is capable of producing an organomagnesium compound. Is one example, the organic group is selected independently from the group consisting of alkyl, alkenyl, alkynyl, aryl, heteroaryl, cyclyl, heterocyclyl, and any combinations thereof. Is an exemplary embodiment, the mixture of Grignard reagents comprises 2 to 10 different Grignard reagents. At least two Grignard reagents in the mixture of Grignard reagents have a mole ratio of about 100:1 to about 1:1. More usually, the mixture of Grignard reagents comprises two Grignard reagents having a mole ratio of about 10:1 to about 1:1. In some embodiments the mixture of Grignard reagents comprises two Grignard reagents having a mole ratio of about 2:1.

In some embodiments the mixture of Grignard reagents comprises MeMgCl and EtMgCl. In one illustrative example, the mixture of Grignard reagents comprises MeMgCl and EtMgCl in about 2:1 mole ratio. A variety of halogen components may be used. For example, the halogen containing compound is of formula RI or RBr, wherein R is selected from the group consisting of alkyl, alkenyl, alkynyl, aryl, heteroaryl, cyclyl, and heterocyclyl.

Of particular advantage, the ratio of different phosphonium cations in the mixture of phosphonium salts or ionic liquids may be varied by varying mole fraction or ratio of Grignard reagents in the mixture of Grignard reagents.

A variety of anions may be selected. In some embodiments, the anion is selected from the group consisting of (CF₂SO₂)₂N⁻, (CF₃)₂BF₂⁻, (CF₃)₃BF⁻, (CF₃)₃PF₃⁻, (CF₃)₄B⁻, (CF₃)₄PF₂⁻, (CF₃CF₂)₃PF₃⁻, (CF₃CF₂)₄PF₂⁻, (CF₃CF₂CF₂)₃PF₃⁻, (CF₃CF₂CF₂)₄PF₂⁻, (CF₃SO₂)₂N⁻, (—OCO(CH₂)ₙCOO—)BF(CF₃)⁻, (13 OCOCOCOO—)₂B⁻, (—OCOCOCOO—)B(CF₃)₂⁻, (—OCOCOCOO—)BF(CF₃)⁻, (—OCOCOO—)(CF₃)₂B⁻, (—OCOCOO—)(CF₃)₃PF⁻, (—OCOCOO—)₂B⁻, (—OCOCOO—)₂PF₂⁻, (—OCOCOO—)₃P⁻, (—OCOCOO—)BF(CF₃)⁻, (—OCOCOO—)BF₂⁻, (—OCOCOO—)PF₄⁻, (—OCOCR¹R²CR¹R²COO—)B(CF₃)₂⁻, (—OCOCR¹R²CR¹R²COO—)BF(CF₃)⁻, (—OCOCR₂COO—)₂B⁻, (—OCOCR₂COO—)B(CF₃)₂⁻, (—OCOCR₂COO—)BF(CF₃)⁻, (—OSOCF₂SOO—)B(CF₃)₂⁻, (—OSOCF₂SOO—)BF(CF₃)⁻, (—OSOCF₂SOO—)BF₂, (—OSOCH₂SOO—)B(CF₃)₂⁻, (—OSOCH₂SOO—)BF(CF₃)⁻, (—OSOCH₂SOO—)BF₂⁻, BF₄⁻, C(CN)₃⁻, C₆H₅CO₂⁻, CF₃CF₂CO₂⁻, CF₃B(—OOR)₃⁻, CF₃B(—OOR)F₂⁻, CF₃BF(—OOR)₂⁻, CF₃BF₃⁻, CF₃CF₂BF₃⁻, CF₃CF₂CF₂CO₂⁻, CF₃CF₂CF₂SO₃⁻, CF₃CO₂⁻, CF₃SO₃⁻, CH₃SO₃⁻, CHO₂⁻, CO₃²⁻, N(CN)₂⁻, NO₃⁻, OCN⁻, PF₆⁻, and any combinations thereof, wherein R, R¹, and R² are independently for each occurrence H or fluoro.

### Applications and Uses of the Phosphonium Ionic Liquids or Salts

Molecules and salts synthesized according to embodiments of the present invention may be used in a variety of applications. In particular, embodiments of the synthesis methods of the invention produce molecules and salts having low average symmetry which are useful in a variety of application, including but not limited to: as electrolytes in batteries, electrochemical double layer capacitors, electrolytic capacitors, fuel cells, dye-sensitized solar cells, and electrochromic devices. Additional applications include use as a heat transfer medium, high temperature reaction and/or extraction media, among other applications.

### Batteries

Phosphonium ionic liquids, salts, and compositions formed according to embodiments of the present invention are well suited as electrolytes in battery applications. In one embodiment, a battery is provided comprising: a positive electrode (cathode), a negative electrode (anode), a separator between said positive and negative electrode; and an electrolyte. The electrolyte is comprised of an ionic liquid composition or one or more ionic liquids or salts selectively synthesized by mixed Grignard reagents and dissolved in a solvent, comprising: one or more phosphonium based cations of the general formula:

R¹R²R³R⁴P

wherein: R¹, R², R³ and R⁴ are each independently a substituent group; and one or more anions. In some embodiments R¹, R², R³ and R⁴ are each independently an alkyl group comprised of 1 to 6 carbon atoms, more usually 1 to 4 carbon atoms. Any one or more of the salts may be liquid or solid at a temperature of 100° C. and below. In some embodiments, a salt is comprised of one cation and one anion pair. In other embodiments, a salt is comprised of one cation and multiple anions. In other embodiments, a salt is comprised of one anion and multiple cations. In further embodiments, a salt is comprised of multiple cations and multiple anions. In one embodiment, the electrolyte is comprised of an ionic liquid having one or more phosphonium based cations, and one or more anions, wherein the ionic liquid composition exhibits thermodynamic stability up to 375° C., a liquidus range greater than 400° C., and ionic conductivity of at least 1 mS/cm, or at least 5 mS/cm, or at least 10 mS/cm at room temperature. In another embodiment, the electrolyte is comprised of one or more salts having one or more phosphonium based cations, and one or more anions dissolved in a solvent, wherein the electrolyte composition exhibits ionic conductivity of at least at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature.

A battery comprising electrolyte compositions according to embodiments of the present invention are further described in co-pending U.S. patent application Ser. No. 13/706,323 (attorney docket no. 057472-060), the entire disclosure of which is hereby incorporated by reference.

In some embodiments, the electrolyte composition is comprised of, but not limited to one or more of the following solvents: acetonitrile, ethylene carbonate (EC), propylene carbonate (PC), butylene carbonate (BC), dimethyl carbonate (DMC), diethyl carbonate (DEC), ethylmethyl carbonate (EMC) or methyl ethyl carbonate (MEC), methyl propionate (MP), fluoroethylene carbonate (FEC), fluorobenzene (FB), vinylene carbonate (VC), vinyl ethylene carbonate (VEC), phenylethylene carbonate (PhEC), propylmethyl carbonate (PMC), diethoxyethane (DEE), dimethoxyethane (DME), tetrahydrofuran (THF), γ-butyrolactone (GBL), and γ-valerolactone (GVL).

In some embodiments, the electrolyte composition is comprised of one more lithium salts having one or more anions selected from the group consisting of: PF₆, (CF₃)₃PF₃, (CF₃)₄PF₂, (CF₃CF₂)₄PF₂, (CF₃CF₂CF₂)₄PF₂, (—OCOCOO—)PF₄, (—OCOCOO—)(CF₃)₃PF, (—OCOCOO—)₃P, BF₄, CF₃BF₃, (CF₃)₂BF₂, (CF₃)₃BF, (CF₃)₄B, (—OCOCOO—)BF₂, (—OCOCOO—)BF(CF₃), (—OCOCOO—)(CF₃)₂B, (—OSOCH₂SOO—)BF₂, (—OSOCF₂SOO—)BF₂, (—OSOCH₂SOO—)BF(CF₃), (—OSOCF₂SOO—)BF(CF₃), (—OSOCH₂SOO—)B(CF₃)₂, (—OSOCF₂SOO—)B(CF₃)₂, CF₃SO₃, (CF₃SO₂)₂N, (—OCOCOO—)₂PF₂, (CF₃CF₂)₃PF₃, (CF₃CF₂CF₂)₃PF₃, (—OCOCOO—)₂B, (—OCO(CH₂)₁COO—)BF(CF₃), (—OCOCR₂COO—)BF(CF₃), (—OCOCR₂COO—)B(CF₃)₂, (—OCOCR₂COO—)₂B, CF₃BF(—OOR)₂, CF₃B(—OOR)₃, CF₃B(—OOR)F₂, (—OCOCOCOO—)BF(CF₃), (—OCOCOCOO—)B(CF₃)₂, (—OCOCOCOO—)₂B, (—OCOCR¹R²CR¹R²COO—)BF(CF₃), and (—OCOCR¹R²CR¹R²COO—)B(CF₃)₂; and where R, R¹, and R² are each independently H or F.

In further embodiments, the electrolyte composition is comprised of, but not limited to one or more of the following lithium salts: lithium hexafluorophosphate (LiPF₆), lithium tetrafluoroborate (LiBF₄), lithium perchlorate (LiClO₄), lithium hexafluoroarsenate (LiAsF₆), lithium trifluoromethanesulfonate or lithium triflate (LiCF₃SO₃), lithium bis(trifluoromethanesulfonyl)imide (Li(CF₃SO₂)₂N or LiIm), and lithium bis(pentafluoromethanesulfonyl)imide (Li(CF3CF₂SO₂)₂N or LiBETI).

A key requirement for enhanced energy cycle efficiency and delivery of maximum power is a low cell equivalent series resistance (ESR). Hence, it is useful for battery electrolytes to have high conductivity to ion movement. Surprisingly, when a phosphonium electrolyte composition disclosed herein, as described above, replaces a conventional electrolyte or when a phosphonium salt is used as an additive with a conventional electrolyte, the ionic conductivity is significantly increased; and the performance stability of the battery device is greatly improved, as can be seen in the Examples below.

In one exemplary embodiment, a neat phosphonium ionic liquid (CH₃CH₂CH₂)(CH₃CH₂)(CH₃)₂PC(CN)₃ without a solvent exhibits an ionic conductivity of 13.9 mS/cm.

In another exemplary embodiment, the phosphonium ionic liquid (CH₃CH₂CH₂)(CH₃CH₂)(CH₃)₂PC(CN)₃ when mixed in a solvent of acetonitrile (ACN) exhibits an ionic conductivity of 75 mS/cm at ACN/ionic liquid volume ratio between 1.5 and 2.0.

In another exemplary embodiment, the phosphonium ionic liquid (CH₃CH₂CH₂)(CH₃CH₂)(CH₃)₂PC(CN)₃ when mixed in a solvent of propylene carbonate (PC) exhibits an ionic conductivity of 22 mS/cm at PC/ionic liquid volume ratio between 0.75 and 1.25.

In other exemplary embodiment, various phosphonium salts were dissolved in acetonitrile (ACN) solvent at 1.0 M concentration. The resulting electrolytes exhibited ionic conductivity at room temperature greater than about 28 mS/cm, or greater than about 34 mS/cm, or greater than about 41 mS/cm, or greater than about 55 mS/cm, or greater than about 61 mS/cm.

In another exemplary embodiment, to a conventional electrolyte solution of 1.0 M LiPF₆ in a mixed solvent of EC (ethylene carbonate) and DEC (diethyl carbonate) at 1:1 weight ratio, noted as EC:DEC=1:1, a phosphonium salt (CH₃CH₂CH₂)(CH₃CH₂)(CH₃)₂PC(CN)₃ is added at 10 w %. The ionic conductivity of the electrolyte is increased by 109% at −30° C., and about 25% at +20° C. and +60° C. with the addition of the phosphonium additive. In general, ionic conductivity of the conventional electrolyte solution increased by at least 25% as a result of the phosphonium additive.

In a further exemplary embodiment, to a conventional electrolyte solution of 1.0 M LiPF₆ in a mixed solvent of EC (ethylene carbonate), DEC (diethyl carbonate) and EMC (ethylmethyl carbonate) at 1:1:1 weight ratio, noted as EC:DEC:EMC 1:1:1, a phosphonium salt (CH₃CH₂CH₂)(CH₃CH₂)(CH₃)₂PCF₃BF₃ is added at 10 w %. The ionic conductivity of the electrolyte is increased by 36% at 20° C., 26% at 60° C., and 38% at 90° C. with the addition of the phosphonium additive. In general, ionic conductivity of the conventional electrolyte solution is increased by at least 25% as a result of the phosphonium additive.

Another important advantage of the novel phosphonium electrolyte compositions, either as replacements or using phosphonium salts as additives in conventional electrolytes, disclosed herein is that they exhibit wider electrochemical voltage stability window compared to the conventional electrolytes.

In some exemplary embodiments, various phosphonium salts are dissolved in acetonitrile (ACN) solvent to form electrolyte solutions at 1.0 M concentration. The electrochemical voltage window is determined in cells with a Pt working electrode and a Pt counter electrode and an Ag/Ag+ reference electrode. In one arrangement, the stable voltage window is between about −3.0 V and +2.4 V. In another arrangement, the voltage window is between about −3.2 V and +2.4 V. In another arrangement, the voltage window is between about −2.4 V and +2.5 V. In another arrangement, the voltage window is between about −1.9 V and +3.0 V.

Another important advantage of using phosphonium electrolyte compositions disclosed herein, either as replacements or using phosphonium salts as additives in a conventional electrolyte is that they exhibit reduced vapor pressure and therefore flammability as compared to conventional electrolytes, and thus improve the safety of battery operation. In one aspect of the invention, when phosphonium salts are used as additives with conventional electrolytes (which contain conventional, non-phosphonium salts), the phosphonium salt and the conventional salt are present in the electrolyte at a mole ratio in the range of 1/100 to 1/1, phosphonium salt/conventional salt.

In one exemplary embodiment, an electrolyte is formed by dissolving phosphonium salt-(CH₃CH₂CH₂)(CH₃CH₂)(CH₃)₂PCF₃BF₃ in a solvent of acetonitrile (ACN) at 1.0 M concentration. The vapor pressure of ACN is lowered by about 39% at 25° C., and by 38% at 105° C. The significant suppression in vapor pressure by phosphonium salt is an advantage in reducing the flammability of the electrolyte solution, thus improving the safety of device operation.

In another exemplary embodiment, to a conventional electrolyte solution of 1.0 M LiPF₆ in a mixed solvent of EC (ethylene carbonate) and DEC (diethyl carbonate) at 1:1 weight ratio, phosphonium additive (CH₃CH₂CH₂)(CH₃CH₂)(CH₃)₂PC(CN)₃ is added at 20 w %. The fire self-extinguishing time is reduced by 53% with the addition of the phosphonium additive to the conventional electrolyte. This is an indication that the safety and reliability of lithium ion batteries can be substantially improved by using the phosphonium salt as an additive in the conventional electrolytes.

In a further aspect, the phosphonium ionic liquid or salt can be used as an additive to facilitate the formation of solid electrolyte interphase (SEI) layer or electrode protective layer. The SEI layer helps widen the electrochemical stability window, suppress battery degradation or decomposition reactions and hence improve battery cycle life.

Phosphonium ionic liquids, salts, and compositions according to embodiments of the present invention are well suited as electrolytes in a variety of batteries such as lithium primary batteries and lithium secondary batteries including lithium-ion batteries and rechargeable lithium metal batteries. Examples of lithium primary batteries include, but are not limited to: lithium/manganese dioxide (Li/MnO₂), lithium/carbon monofluoride (Li/CFx), lithium/silver vanadium oxide (Li/Ag₂V₄O₁₁), Li—(CF)ₓ, lithium iron disulfide (Li/FeS₂), and lithium/copper oxide (Li/CuO). Examples of lithium-ion batteries (LIBs) include, but are not limited to: an anode of carbon, graphite, graphene, silicon (Si), tin (Sn), Si/Co doped carbon, and metal oxide such as lithium titanate oxide (LTO) and a cathode of lithium cobalt oxide (LCO) (LiCoO₂), lithium manganese oxide (LMO) (LiMn₂O₄), lithium iron phosphate (LFP) (LiFePO₄), lithium nickel manganese cobalt oxide (NMC) (Li(NiMnCo)O₂), lithium nickel cobalt aluminum oxide (NCA) (Li(NiCoAl)O₂), lithium nickel manganese oxide (LNMO) (Li₂NiMn₃O₈), and lithium vanadium oxide (LVO). Examples of rechargeable lithium metal batteries include, but are not limited to: a lithium metal anode with a cathode of lithium cobalt oxide (LCO) (LiCoO₂), lithium manganese oxide (LMO) (Li/Mn₂O₄), lithium iron phosphate (LFP) (LiFePO₄), lithium nickel manganese cobalt (NMC) (Li(NiMnCo)O₂), lithium nickel cobalt aluminum (NCA) (Li(NiCoAl)O₂), lithium nickel manganese oxide (LNMO) (Li₂NiMn₃O₈), a lithium/sulfur battery, and a lithium/air battery.

In a further embodiment, the above approaches to energy storage may be combined with electrochemical double layer capacitors (EDLCs) to form a hybrid energy storage system comprising an array of battery cells and EDLCs.

### Electrochemical Double Layer Capacitors

Phosphonium ionic liquids, salts, and compositions formed according to embodiments of the present invention are well suited as electrolytes in electrochemical double layer capacitor (EDLCs). In one embodiment, an EDLC is provided comprising: a positive electrode, a negative electrode, a separator between said positive and negative electrode; and an electrolyte. The electrolyte is comprised of an ionic liquid composition or one or more ionic liquids or salts selectively synthesized by mixed Grignard reagents and dissolved in a solvent, comprising: one or more phosphonium based cations of the general formula:

R¹R²R³R⁴P

wherein: R¹, R², R³ and R⁴ are each independently a substituent group; and one or more anions. In some embodiments R¹, R², R³ and R⁴ are each independently an alkyl group comprised of 1 to 6 carbon atoms, more usually 1 to 4 carbon atoms. Any one or more of the salts may be liquid or solid at a temperature of 100° C. and below. In some embodiments, a salt is comprised of one cation and one anion pair. In other embodiments, a salt is comprised of one cation and multiple anions. In other embodiments, a salt is comprised of one anion and multiple cations. In further embodiments, a salt is comprised of multiple cations and multiple anions. In one embodiment, the electrolyte is comprised of an ionic liquid having one or more phosphonium based cations, and one or more anions, wherein the ionic liquid composition exhibits thermodynamic stability up to 375° C., a liquidus range greater than 400° C., and ionic conductivity of at least 1 mS/cm, or at least 5 mS/cm, or at least 10 mS/cm at room temperature. In another embodiment, the electrolyte is comprised of one or more salts having one or more phosphonium based cations, and one or more anions dissolved in a solvent, wherein the electrolyte composition exhibits ionic conductivity of at least at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature.

In another embodiment, the electrolyte composition further comprises one or more conventional, non-phosphonium salts. In some embodiments the electrolyte composition may be comprised of conventional salts, and wherein the phosphonium based ionic liquids or salts disclosed herein are additives. In some embodiments electrolyte composition is comprised of phosphonium based ionic liquids or salts and one or more conventional salts, present at a mole (or molar) ratio in the range of 1:100 to 1:1, phosphonium based ionic liquid or salt: conventional salt. Examples of the conventional salts include but are not limited to salts which are comprised of one or more cations selected from the group consisting of: tetraalkylammonium such as (CH₃CH₂)₄N⁺, (CH₃CH₂)₃(CH₃)N⁺, (CH₃CH₂)₂(CH₃)₂N⁺, (CH₃CH₂)(CH₃)₃N⁺ (CH₃)₄N⁺, imidazolium, pyrazolium, pyridinium, pyrazinium, pyrimidinium, pyridazinium, pyrrolidinium and one or more anions selected from the group consisting of: ClO₄⁻, BF₄⁻, CF₃SO₃⁻, PF₆⁻, ASF₆⁻, SbF₆⁻, (CF₃SO₂)₂N⁻, (CF3CF₂SO₂)₂N⁻, (CF₃SO₂)₃C⁻. In some embodiments, the one or more conventional salts include but not limited to: tetraethylammonium tetrafluorborate (TEABF₄), triethylmethylammonium tetrafluoroborate (TEMABF₄), 1-ethyl-3-methylimidazolium tetrafluoroborate (EMIBF₄), 1-ethyl-1-methylpyrrolidinium tetrafluoroborate (EMPBE₄), 1-ethyl-3-methylimidazolium bis(trifluoromethanesulfonyl)imide (EMIIm), 1-ethyl-3-methylimidazolium hexafluorophosphate (EMIPF₆). In some embodiments, the one or more conventional salts are lithium based salts including but not limited to: lithium hexafluorophosphate (LiPF₆), lithium tetrafluoroborate (LiBF₄), lithium perchlorate (LiClO₄), lithium hexafluoroarsenate (LiAsF₆), lithium trifluoromethanesulfonate or lithium triflate (LiCF₃SO₃), lithium bis(trifluoromethanesulfonyl)imide (Li(CF₃SO₂)₂N or LiIm), and lithium bis(pentafluoromethanesulfonyl)imide (Li(CF3CF₂SO₂)₂N or LiBETI).

An EDLC device comprising electrolyte compositions according to some embodiments of the present invention are further described in co-pending U.S. patent application Ser. No. 13/706,233 (attorney docket no. 057472-059), the entire disclosure of which is hereby incorporated by reference.

In some embodiments, the electrolyte composition is comprised of, but not limited to one or more of the following solvents: acetonitrile, ethylene carbonate (EC), propylene carbonate (PC), butylene carbonate (BC), dimethyl carbonate (DMC), diethyl carbonate (DEC), ethylmethyl carbonate (EMC) or methyl ethyl carbonate (MEC), methyl propionate (MP), fluoroethylene carbonate (FEC), fluorobenzene (FB), vinylene carbonate (VC), vinyl ethylene carbonate (VEC), phenylethylene carbonate (PhEC), propylmethyl carbonate (PMC), diethoxyethane (DEE), dimethoxyethane (DME), tetrahydrofuran (THF), γ-butyrolactone (GBL), and γ-valerolactone (GVL).

A key requirement for enhanced energy cycle efficiency and delivery of maximum power is a low cell equivalent series resistance (ESR). Hence, it is useful for battery electrolytes to have high conductivity to ion movement. Surprisingly, when a phosphonium electrolyte composition disclosed herein, as described above, replaces a conventional electrolyte or when a phosphonium salt is used as an additive with a conventional electrolyte, the ionic conductivity is significantly increased; and the performance stability of the battery device is greatly improved, as can be seen in the Examples below.

In one exemplary embodiment, a neat phosphonium ionic liquid (CH₃CH₂CH₂)(CH₃CH₂)(CH₃)₂PC(CN)₃ without a solvent exhibits an ionic conductivity of 13.9 mS/cm.

In another exemplary embodiment, the phosphonium ionic liquid (CH₃CH₂CH₂)(CH₃CH₂)(CH₃)₂PC(CN)₃ when mixed in a solvent of acetonitrile (ACN) exhibits an ionic conductivity of 75 mS/cm at ACN/ionic liquid volume ratio between 1.5 and 2.0.

In another exemplary embodiment, the phosphonium ionic liquid (CH₃CH₂CH₂)(CH₃CH₂)(CH₃)₂PC(CN)₃ when mixed in a solvent of propylene carbonate (PC) exhibits an ionic conductivity of 22 mS/cm at PC/ionic liquid volume ratio between 0.75 and 1.25.

In other exemplary embodiment, various phosphonium salts were dissolved in acetonitrile (ACN) solvent at 1.0 M concentration. The resulting electrolytes exhibited ionic conductivity at room temperature greater than about 28 mS/cm, or greater than about 34 mS/cm, or greater than about 41 mS/cm, or greater than about 55 mS/cm, or greater than about 61 mS/cm.

In another exemplary embodiment, to a conventional electrolyte solution of 1.0 M LiPF₆ in a mixed solvent of EC (ethylene carbonate) and DEC (diethyl carbonate) at 1:1 weight ratio, noted as EC:DEC=1:1, a phosphonium salt (CH₃CH₂CH₂)(CH₃CH₂)(CH₃)₂PC(CN)₃ is added at 10 w %. The ionic conductivity of the electrolyte is increased by 109% at −30° C., and about 25% at +20° C. and +60° C. with the addition of the phosphonium additive. In general, ionic conductivity of the conventional electrolyte solution increased by at least 25% as a result of the phosphonium additive.

In a further exemplary embodiment, to a conventional electrolyte solution of 1.0 M LiPF₆ in a mixed solvent of EC (ethylene carbonate), DEC (diethyl carbonate) and EMC (ethylmethyl carbonate) at 1:1:1 weight ratio, noted as EC:DEC:EMC 1:1:1, a phosphonium salt (CH₃CH₂CH₂)(CH₃CH₂)(CH₃)₂PCF₃BF₃ is added at 10 w %. The ionic conductivity of the electrolyte is increased by 36% at 20° C., 26% at 60° C., and 38% at 90° C. with the addition of the phosphonium additive. In general, ionic conductivity of the conventional electrolyte solution is increased by at least 25% as a result of the phosphonium additive.

Another important advantage of the novel phosphonium electrolyte compositions, either as replacements or using phosphonium salts as additives in conventional electrolytes, disclosed herein is that they exhibit wider electrochemical voltage stability window compared to the conventional electrolytes.

In some exemplary embodiments, various phosphonium salts are dissolved in acetonitrile (ACN) solvent to form electrolyte solutions at 1.0 M concentration. The electrochemical voltage window is determined in cells with a Pt working electrode and a Pt counter electrode and an Ag/Ag+ reference electrode. In one arrangement, the stable voltage window is between about −3.0 V and +2.4 V. In another arrangement, the voltage window is between about −3.2 V and +2.4 V. In another arrangement, the voltage window is between about −2.4 V and +2.5 V. In another arrangement, the voltage window is between about −1.9 V and +3.0 V.

Another important advantage of using phosphonium electrolyte compositions disclosed herein, either as replacements or using phosphonium salts as additives in a conventional electrolyte is that they exhibit reduced vapor pressure and therefore flammability as compared to conventional electrolytes, and thus improve the safety of battery operation. In one aspect of the invention, when phosphonium salts are used as additives with conventional electrolytes (which contain conventional, non-phosphonium salts), the phosphonium salt and the conventional salt are present in the electrolyte at a mole ratio in the range of 1/100 to 1/1, phosphonium salt/conventional salt.

In one exemplary embodiment, an electrolyte is formed by dissolving phosphonium salt-(CH₃CH₂CH₂)(CH₃CH₂)(CH₃)₂PCF₃BF₃ in a solvent of acetonitrile (ACN) at 1.0 M concentration. The vapor pressure of ACN is lowered by about 39% at 25° C., and by 38% at 105° C. The significant suppression in vapor pressure by phosphonium salt is an advantage in reducing the flammability of the electrolyte solution, thus improving the safety of device operation.

In another exemplary embodiment, to a conventional electrolyte solution of 1.0 M LiPF₆ in a mixed solvent of EC (ethylene carbonate) and DEC (diethyl carbonate) at 1:1 weight ratio, phosphonium additive (CH₃CH₂CH₂)(CH₃CH₂)(CH₃)₂PC(CN)₃ is added at 20 w %. The fire self-extinguishing time is reduced by 53% with the addition of the phosphonium additive to the conventional electrolyte. This is an indication that the safety and reliability of lithium ion batteries can be substantially improved by using the phosphonium salt as an additive in the conventional electrolytes.

In a further aspect, the phosphonium ionic liquid or salt can be used as an additive to facilitate the formation of solid electrolyte interphase (SEI) layer or electrode protective layer. The protective layer helps widen the electrochemical stability window, suppress EDLC degradation or decomposition reactions and hence improve EDLC cycle life.

Phosphonium ionic liquids, salts, and compositions according to embodiments of the present invention are well suited as electrolytes in a variety of EDLCs, wherein the electrode active materials are selected from any one or more in the group consisting of carbon blacks, graphite, graphene; carbon-metal composites; polyaniline, polypyrrole, polythiophene; oxides, chlorides, bromides, sulfates, nitrates, sulfides, hydrides, nitrides, phosphides, or selenides of lithium, ruthenium, tantalum, rhodium, iridium, cobalt, nickel, molybdenum, tungsten, or vanadium, and combinations thereof.

In a further embodiment, an EDLC device may be built using the phosphonium electrolyte composition disclosed herein, a cathode (positive electrode) made of high surface area activated carbon and an anode (negative electrode) made of lithium ion intercalated graphite. The EDLC formed is an asymmetric hybrid capacitor, called lithium ion capacitor (LIC).

In an additional embodiment, EDLCs may be combined with batteries to form a capacitor-battery hybrid energy storage system comprising an array of battery cells and EDLCs.

### Electrolytic Capacitors

Phosphonium ionic liquids, salts, and compositions according to embodiments of the present invention are well suited as electrolytes in electrolytic capacitors. In one embodiment, an electrolytic capacitor provided comprising: a positive electrode, a negative electrode, a separator between said positive and negative electrode; and an electrolyte. The electrolyte is comprised of an ionic liquid composition or one or more ionic liquids or salts dissolved in a solvent, comprising: one or more phosphonium based cations of the general formula:

R¹R²R³R⁴P

wherein: R¹, R², R³ and R⁴ are each independently a substituent group; and one or more anions. In one embodiment, the electrolyte is comprised of an ionic liquid having one or more phosphonium based cations, and one or more anions, wherein the ionic liquid composition exhibits thermodynamic stability up to 375° C., a liquidus range greater than 400° C., and ionic conductivity of at least 1 mS/cm, or at least 5 mS/cm, or at least 10 mS/cm at room temperature. In another embodiment, the electrolyte is comprised of one or more salts having one or more phosphonium based cations, and one or more anions dissolved in a solvent, wherein the electrolyte composition exhibits ionic conductivity of at least at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature. In some embodiments, the electrolyte composition is comprised of, but not limited to one or more of the following solvents: acetonitrile, ethylene carbonate (EC), propylene carbonate (PC), butylene carbonate (BC), dimethyl carbonate (DMC), diethyl carbonate (DEC), ethylmethyl carbonate (EMC) or methyl ethyl carbonate (MEC), methyl propionate (MP), fluoroethylene carbonate (FEC), fluorobenzene (FB), vinylene carbonate (VC), vinyl ethylene carbonate (VEC), phenylethylene carbonate (PhEC), propylmethyl carbonate (PMC), diethoxyethane (DEE), dimethoxyethane (DME), tetrahydrofuran (THF), γ-butyrolactone (GBL), and γ-valerolactone (GVL. In one embodiment, the positive electrode—the anode is typically an aluminum foil with thin oxide film formed by electrolytic oxidation or anodization. While aluminum is the preferred metal for the anode, other metals such as tantalum, magnesium, titanium, niobium, zirconium and zinc may be used. The negative electrode—the cathode is usually an etched an etched aluminum foil. In a further aspect, the phosphonium electrolyte exhibits reduced flammability as compared to conventional electrolytes, and thus improves the safety of the electrolytic capacitor operation.

### Dye Sensitized Solar Cells

Phosphonium ionic liquids, salts, and compositions according to embodiments of the present invention are well suited as electrolytes in dye sensitized solar cells (DSSCs). In one embodiment, a DSSC is provided comprising: a dye molecule attached anode, an electrolyte containing a redox system, and a cathode. The electrolyte is comprised of an ionic liquid composition or one or more ionic liquids or salts dissolved in a solvent, comprising: one or more phosphonium based cations of the general formula:

R¹R²R³R⁴P

wherein: R¹, R², R³ and R⁴ are each independently a substituent group; and one or more anions. In another embodiment, the electrolyte is characterized as having one or more phosphonium based cations, and one or more anions, wherein the electrolyte composition exhibits least two or more of: thermodynamic stability, low volatility, wide liquidus range, ionic conductivity, chemical stability, and electrochemical stability. In another embodiment, the electrolyte is characterized as having one or more phosphonium based cations, and one or more anions, wherein the electrolyte composition exhibits thermodynamic stability up to a temperature of approximately 375° C. or greater, and ionic conductivity up to 10 mS/cm.

### Electrolytic Films

Phosphonium ionic liquids, salts, and compositions according to embodiments of the present invention are well suited as electrolytic or electrolyte films. In one embodiment, an electrolytic film is provided comprising: a phosphonium ionic liquid composition applied to a substrate. In another embodiment, an electrolytic film is provided comprising: one or more phosphonium ionic liquids or salts dissolved in a solvent applied to a substrate. In one example, one or more phosphonium ionic liquids or salts are dissolved in a solvent to form a coating solution. The solution is applied to a substrate by any suitable means, such as by spray, spin coating, and the like. The substrate is then heated to partially or completely remove the solvent, forming the electrolyte or ion-conducting film. In other embodiments, solutions of ionic liquids, salts, and polymers, dissolved in suitable solvents, are coated onto substrates, such as by spray or spin coating, and then the solvents are partially or completely evaporated. This results in the formation of ion-conductive polymer gels/films. Such films are particularly suitable as electrolytes for batteries, EDLCs, and DSSCs, and as fuel cell membranes.

### Heat Transfer Medium

The desirable properties of high thermodynamic stability, low volatility and wide liquidus range of the phosphonium ionic liquids of the present invention are well suited as heat transfer medium. Some embodiments of the present invention provide a heat transfer medium, comprising an ionic liquid composition or one or more salts dissolved in a solvent comprising: one or more phosphonium based cations, and one or more anions, wherein the heat transfer medium exhibits thermodynamic stability up to a temperature of approximately 375° C., a liquidus range of greater than 400° C. In some embodiments, the heat transfer medium of the invention is a high temperature reaction media. In another embodiment, the heat transfer medium of the invention is a heat extraction media.

### Other Applications

The phosphonium ionic liquids of the present invention find use in additional applications. In one exemplary embodiment, an embedded capacitor is proved. In one embodiment the embedded capacitor is comprised of a dielectric disposed between two electrodes, where the dielectric is comprised of an electrolytic film of a phosphonium ionic composition as described above. The embedded capacitor of the present invention may be embedded in an integrated circuit package. Further embodiments include “on-board” capacitor arrangements.

### EXAMPLES

Embodiments of the present invention are now described in further detail with reference to specific Examples. The Examples provided below are intended for illustration purposes only and in no way limit the scope and/or teaching of the invention.

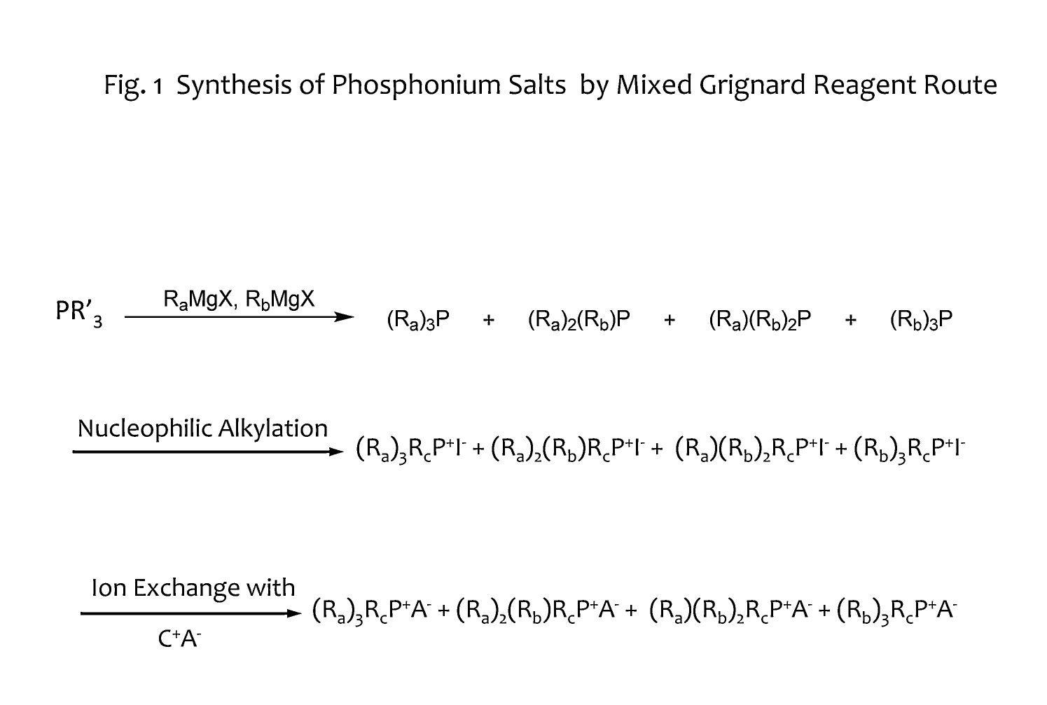

In general, phosphonium ionic liquids were prepared by either metathesis reactions of the appropriately substituted phosphonium salt with the appropriately substituted metal salt, or by reaction of appropriately substituted phosphine precursors with an appropriately substituted anion precursor. FIG. 1 illustrates general reaction schemes to make phosphonium salts by mixed Grignard reagents according to the present invention.

### Example 1

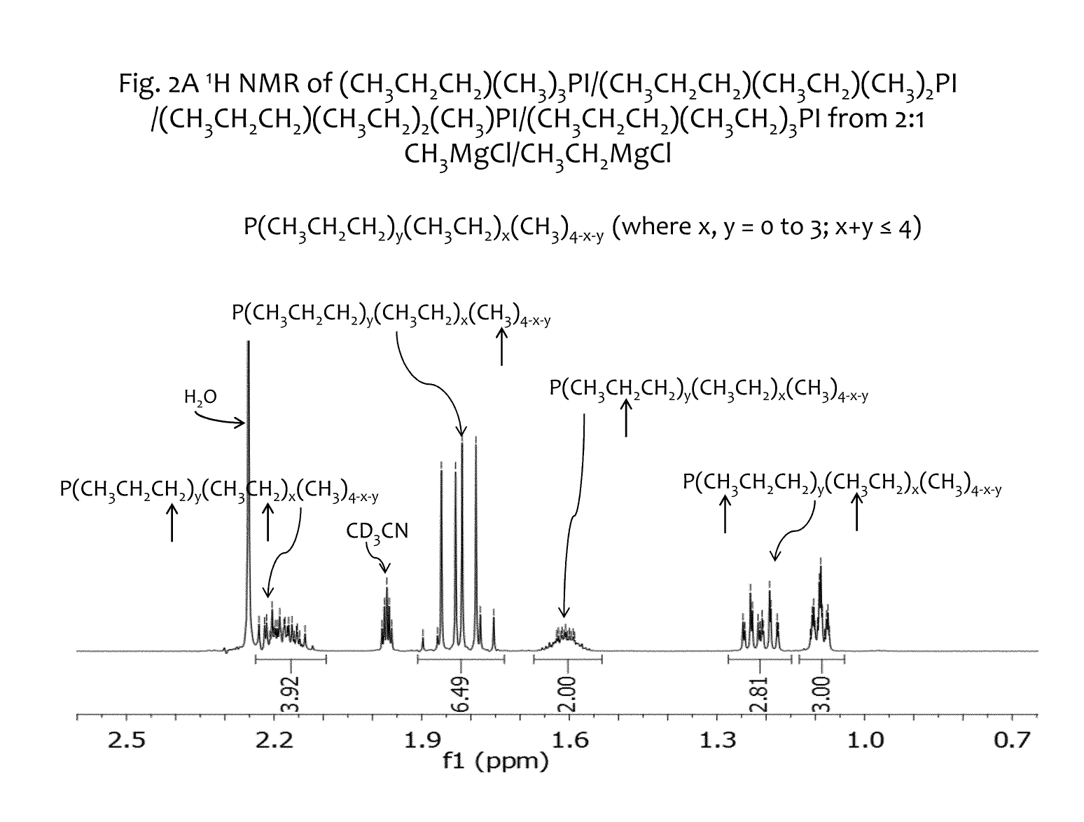

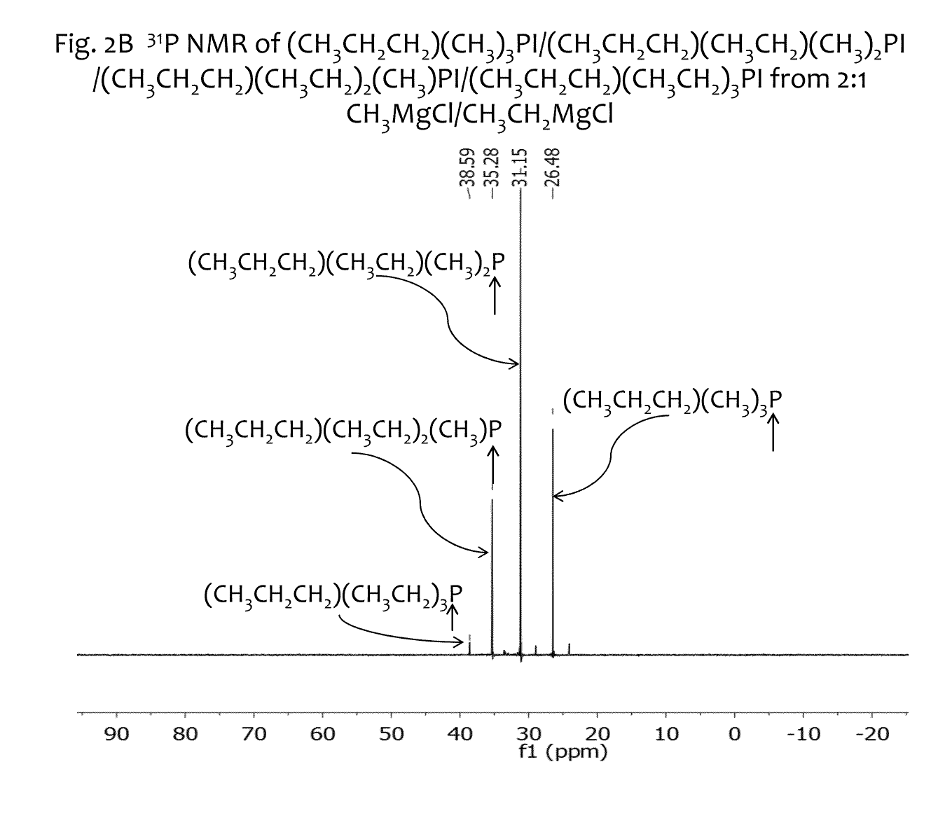

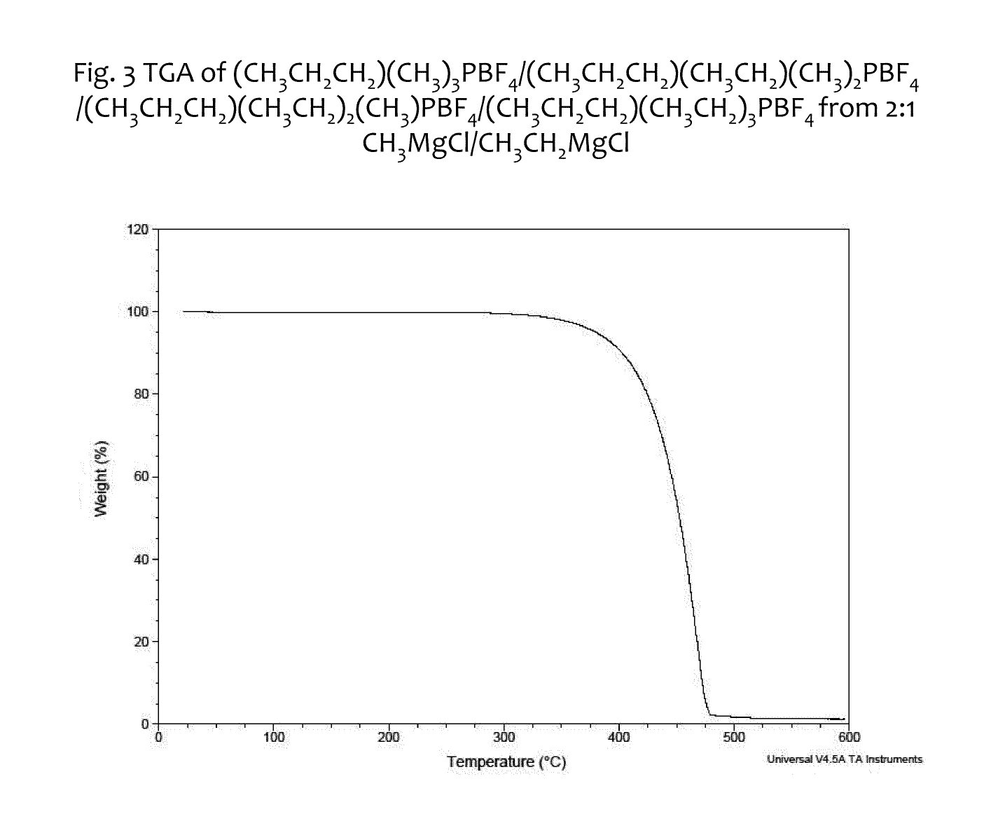

In this experiment, mixed phosphonium iodides (CH₃CH₂CH₂)(CH₃)₃PI/(CH₃CH₂CH₂)(CH₃CH₂)(CH₃)₂PI/(CH₃CH₂CH₂)(CH₃CH₂)₂(CH₃)PI/(CH₃CH₂CH₂)(CH₃CH₂)₃PI were prepared with 2:1 CH₃MgCl/CH₃CH₂MgCl Grignard reagents. Methylmagnesium chloride CH₃MgCl (3.0M in THF, 76.4 mL, 0.229 mol) and ethylmagnesium chloride CH₃CH₂MgCl (2.0M in THF, 57.3 mL, 0.115 mol) were mixed in a side arm round bottom flask under an atmosphere of argon. This solution was further diluted with 180 mL anhydrous, degassed tetrahydrofuran (THF) and then cooled on an ice bath with stirring. Phosphorus trichloride (10.0 mL, 0.1146 mol) was added slowly, dropwise, to the solution of Grignards with vigorous stirring. Once the addition was complete, the reaction was stirred for 1 h and warmed to room temperature. Degassed 1-iodopropane (12.0 mL, 0.123 mol) was added via syringe and the reaction was stirred at room temperature for 3 days. The crude solid was collected by stick filtration, rigorously rinsed 4 times with 200 mL anhydrous THF, and dried in vacuum. This crude product can be recrystallized from 2-propanol to afford analytically pure material. Yield: 25.45 g, 85%. The product is a mixture of 1:2:1:trace (CH₃CH₂CH₂)(CH₃)₃PI/(CH₃CH₂CH₂)(CH₃CH₂)(CH₃)₂PI/(CH₃CH₂CH₂)(CH₃CH₂)₂(CH₃)PI/(CH₃CH₂CH₂)(CH₃CH₂)₃PI. The composition is confirmed by the ¹H NMR spectrum shown in FIG. 2A and the ³¹P NMR spectrum shown in FIG. 2B. Thermogravimetric Analysis (TGA) was performed on the material and the results are shown in FIG. 3.

### Example 2

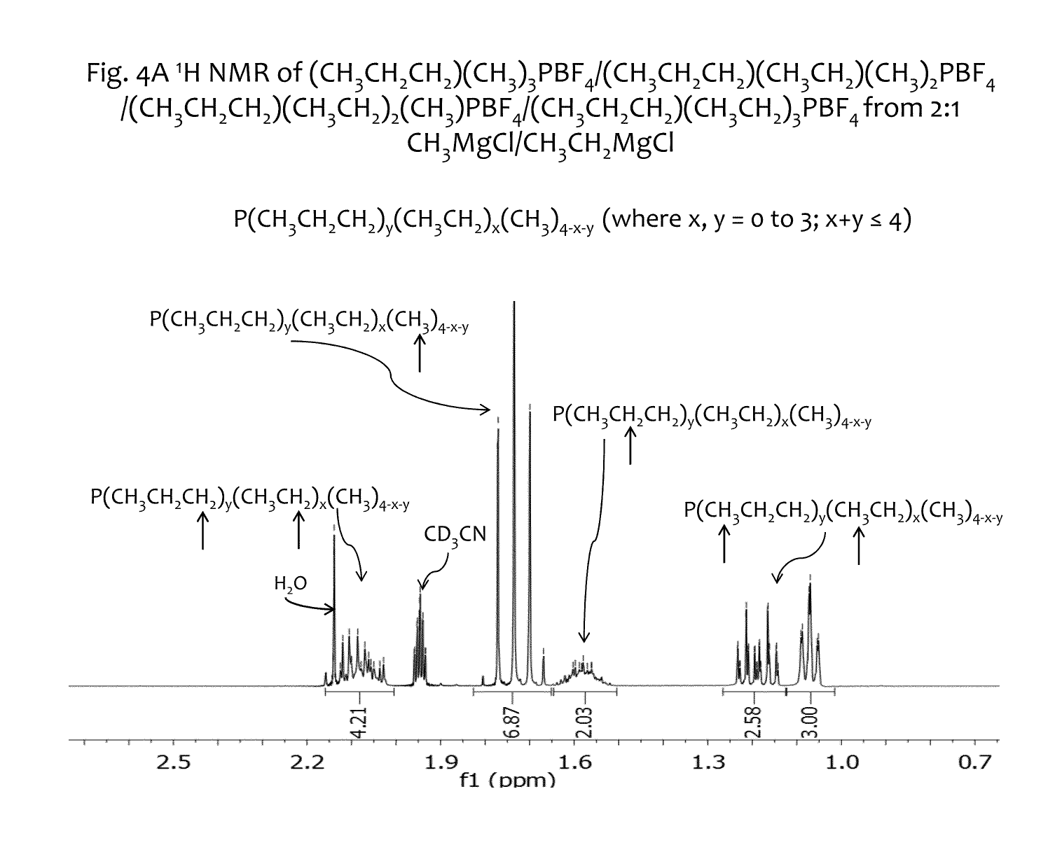

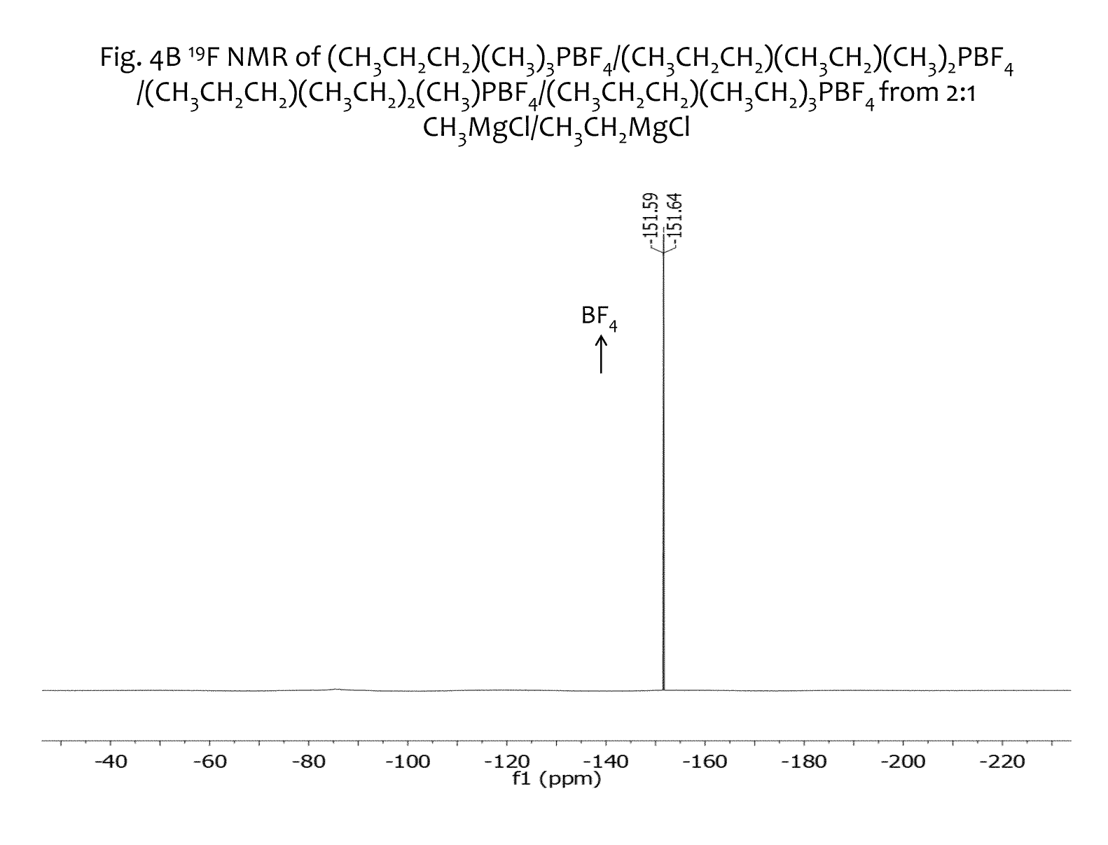

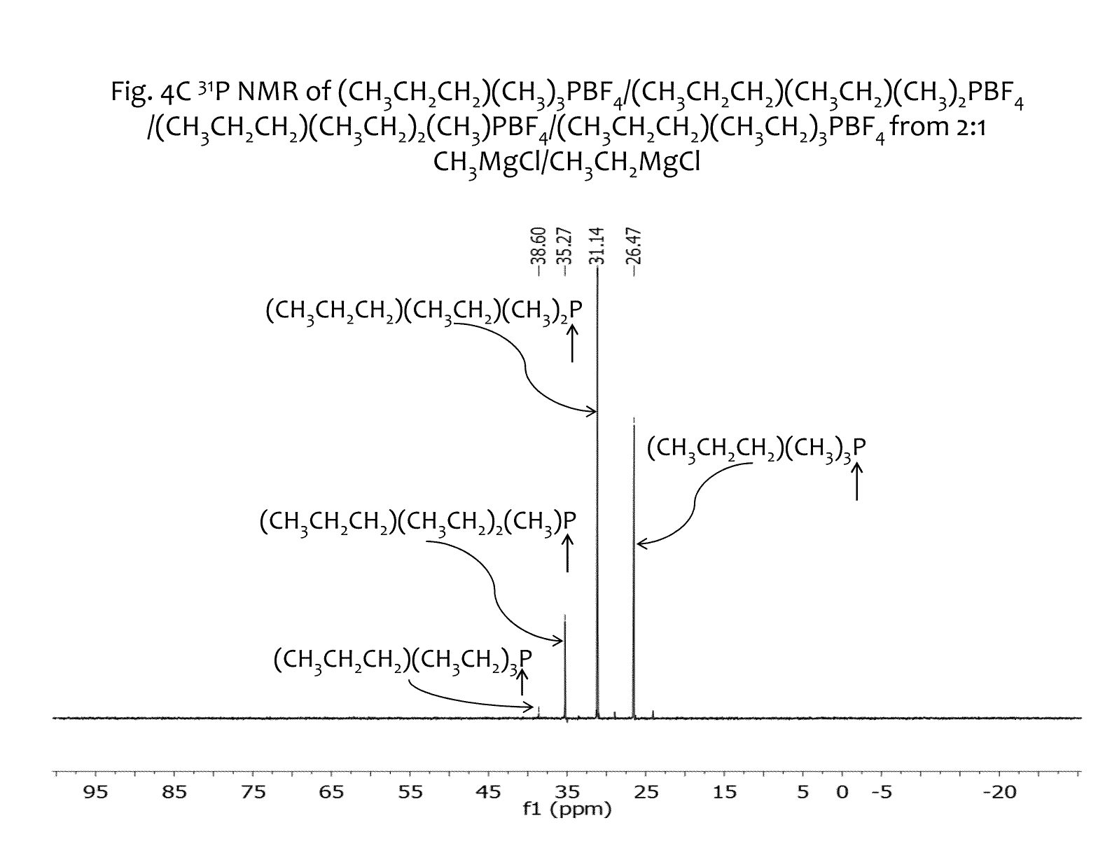

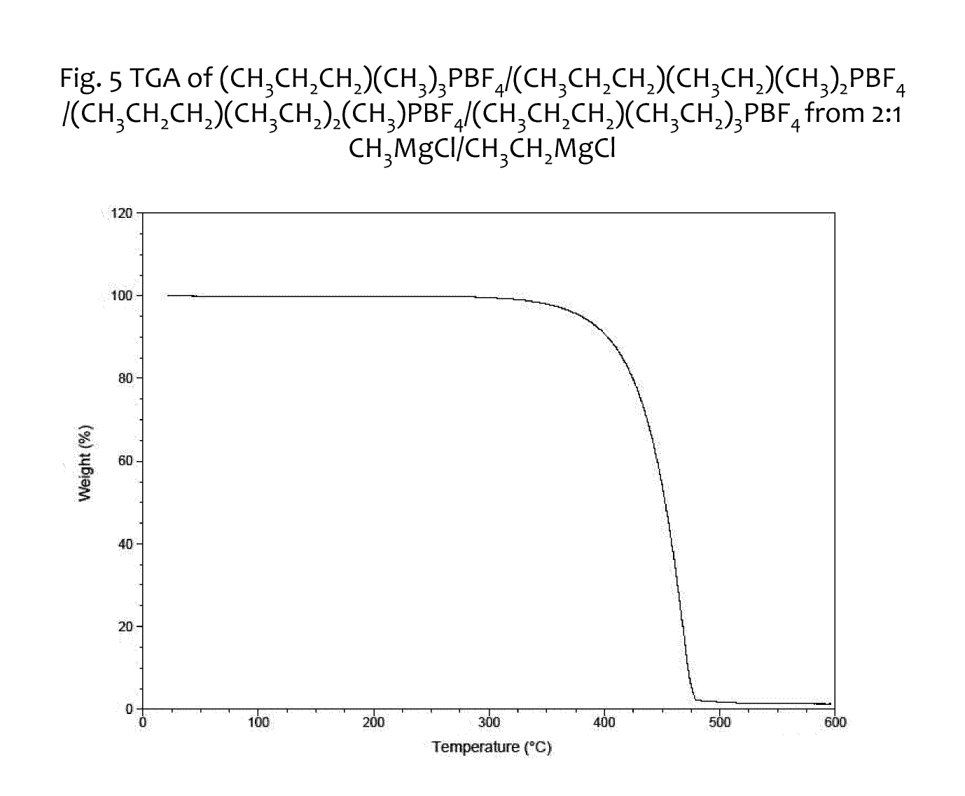

In another experiment, mixed phosphonium tetrafluoroborates (CH₃CH₂CH₂)(CH₃)₃PBF₄/(CH₃CH₂CH₂)(CH₃CH₂)(CH₃)₂PBF₄/(CH₃CH₂CH₂)(CH₃CH₂)₂(CH₃)PBF₄/(CH₃CH₂CH₂)(CH₃CH₂)₃PBF₄ were prepared. 17.0 g (0.065 mol) of the mixed phosphonium iodides prepared in Example 1 was dissolved in 300 mL acetonitrile under an atmosphere of argon. To this solution, 12.99 g (0.067 mol) silver tetrafluoroborate was added with stirring. A yellow precipitate of AgI formed immediately. The reaction was stirred for 5 minutes, the AgI was removed by filtration, and the acetonitrile was removed from the filtrate on a rotary evaporator to afford a white solid. Yield: 12.70 g (88%). This crude product can be recrystallized from 2-propanol to afford analytically pure material. The product is a mixture of 1:2:1:trace (CH₃CH₂CH₂)(CH₃)₃P BF₄/(CH₃CH₂CH₂)(CH₃CH₂)(CH₃)₂PBF₄/(CH₃CH₂CH₂)(CH₃CH₂)₂(CH₃)P BF₄/(CH₃CH₂CH₂)(CH₃CH₂)₃PBF₄. The composition is confirmed by the ¹H NMR spectrum as shown in FIG. 4A, the ¹⁹F NMR spectrum shown in FIG. 4B, and the ³¹P NMR spectrum shown in FIG. 4C. Thermogravimetric Analysis (TGA) was performed on the material and the results are shown in FIG. 5.

### Example 3

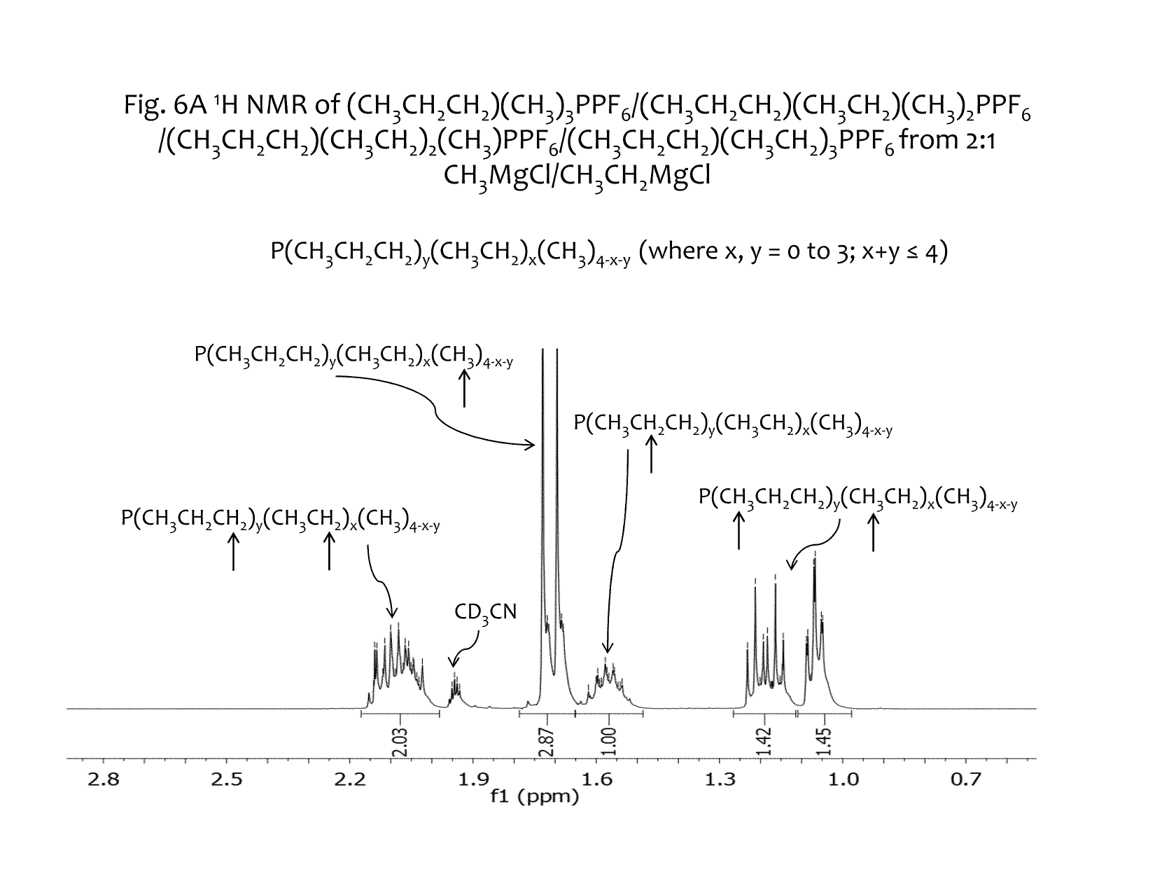

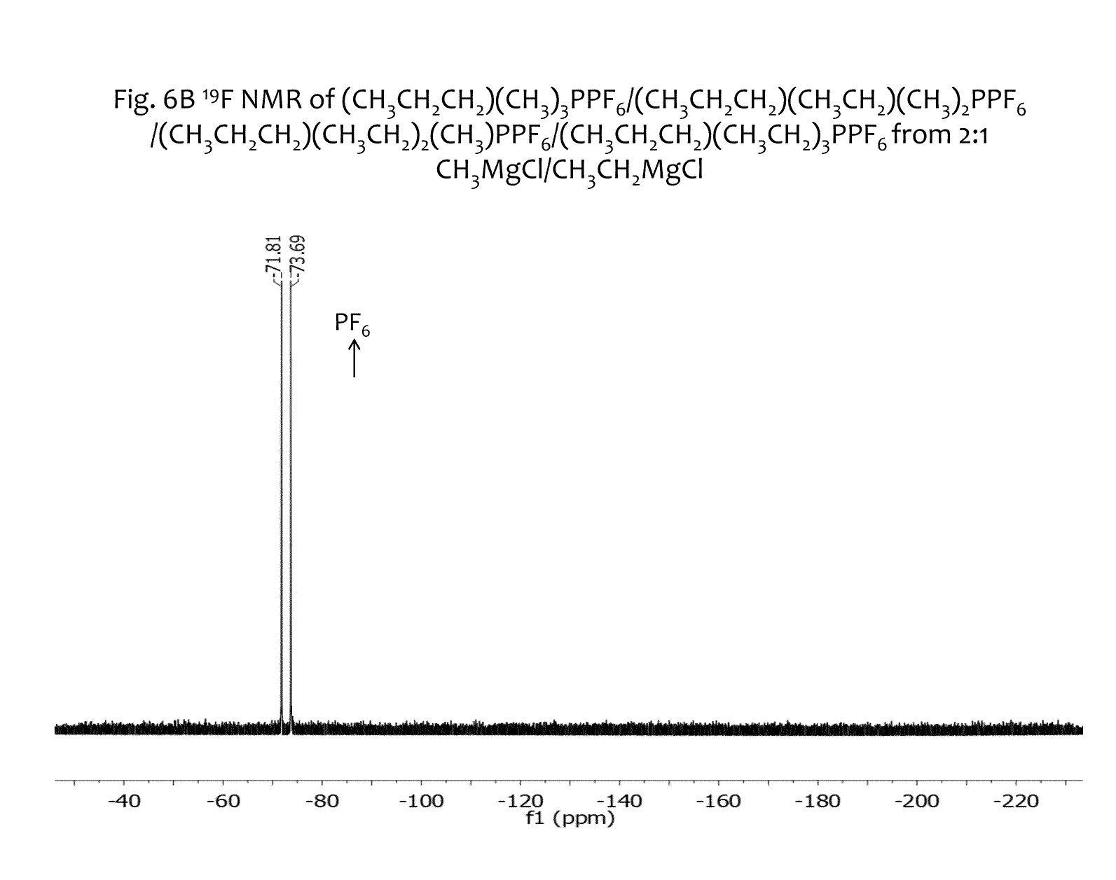

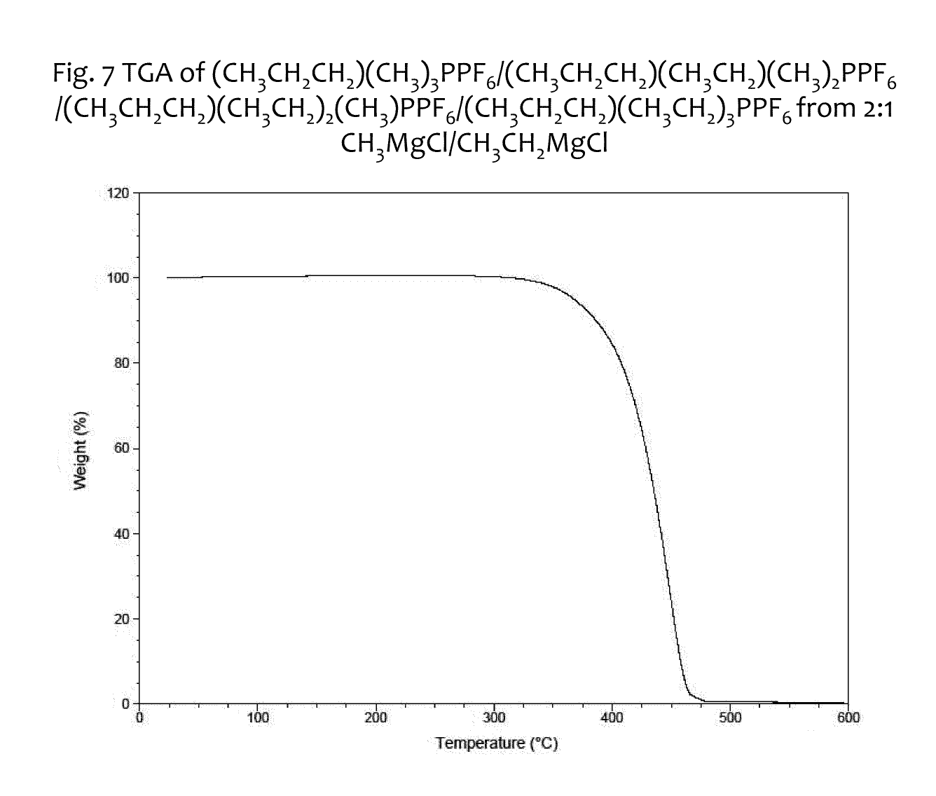

In a further experiment, mixed phosphonium hexafluorophosphates (CH₃CH₂CH₂)(CH₃)₃PPF₆/(CH₃CH₂CH₂)(CH₃CH₂)(CH₃)₂P PF₆/(CH₃CH₂CH₂)(CH₃CH₂)₂(CH₃)PPF₆/(CH₃CH₂CH₂)(CH₃CH₂)₃PPF₆ were prepared. 6.0 g (0.023 mol) of the mixed phosphonium iodides prepared in Example 1 was dissolved in 75 mL acetonitrile under an atmosphere of argon. To this solution, 5.83 g (0.023 mol) Silver hexafluorophosphate was added with stirring. A yellow precipitate of AgI formed immediately. The reaction was stirred for 5 minutes, the AgI was removed by filtration, and the filtrate was passed through 0.2 μm PTFE membrane filter. The acetonitrile was removed from the filtrate on a rotary evaporator to afford an oily solid, which was dried under vacuum. The solid was dissolved in dichloromethane to get a cloudy solution which was passed through 0.2 μm PTFE membrane filter. The dichloromethane was removed from the filtrate on a rotary evaporator to afford a glassy solid to which hot isopropyl alcohol was added to obtain immiscible layers. The layers were agitated and allowed to cool to obtain solid compound in cold isopropyl alcohol. The isopropyl alcohol was decanted while cold to obtain pure compound which was washed with cold isopropyl alcohol. The recrystallization with hot isopropyl alcohol was repeated and the solid obtained was dried under vacuum at 120° C. to obtain analytically pure material. Yield: 4.73 g (74%). The product is a mixture of 1:2:1:trace (CH₃CH₂CH₂)(CH₃)₃PPF₆/(CH₃CH₂CH₂)(CH₃CH₂)(CH₃)₂PPF₆/(CH₃CH₂CH₂)(CH₃CH₂)₂(CH₃)PPF₆/(CH₃CH₂CH₂)(CH₃CH₂)₃PPF₆. The composition is confirmed by the ¹H NMR spectrum as shown in FIG. 6A and the ¹⁹F NMR spectrum shown in FIG. 6B. Thermogravimetric Analysis (TGA) was performed on the material and the results are shown in FIG. 7.

### Example 4

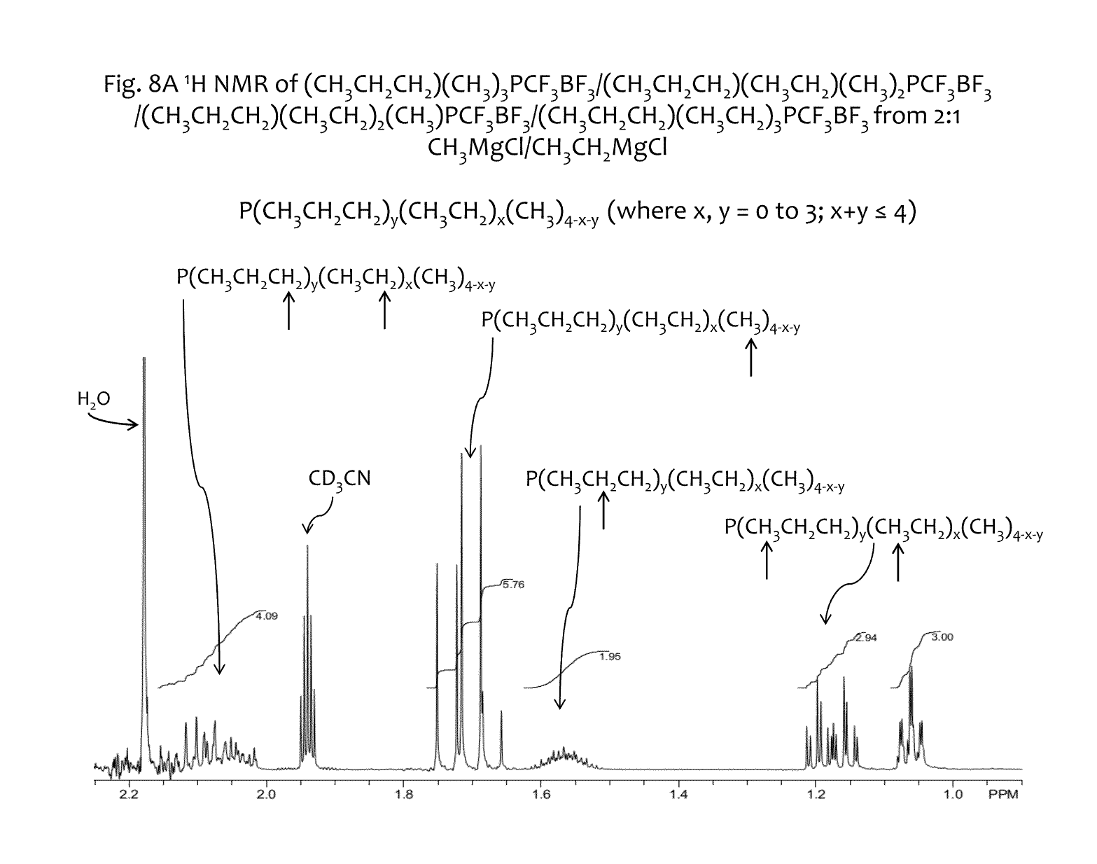

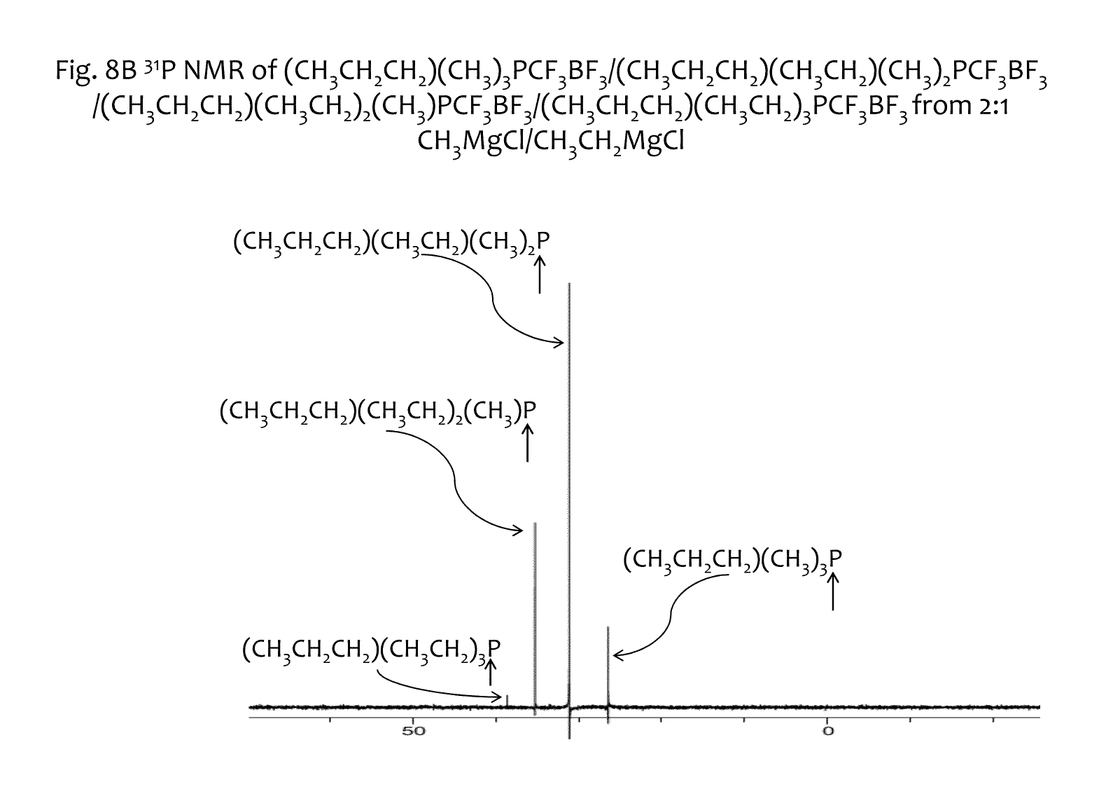

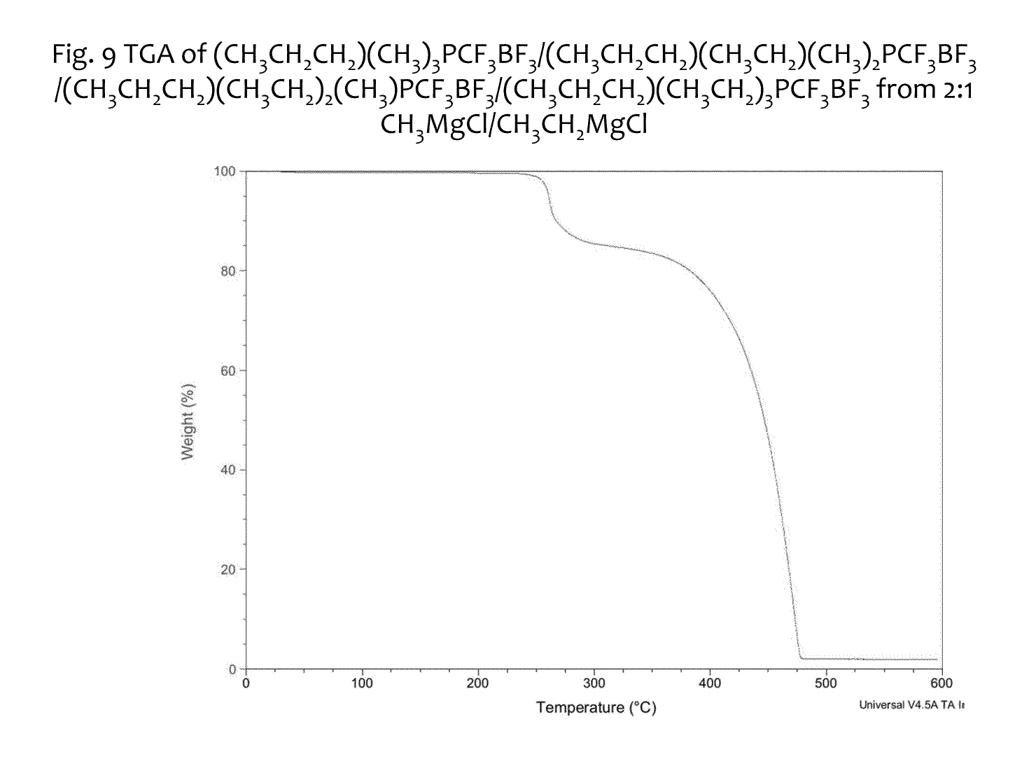

In another experiment, mixed phosphonium trifluoromethyltrifluoroborates (CH₃CH₂CH₂)(CH₃)₃PCF₃BF₃/(CH₃CH₂CH₂)(CH₃CH₂)(CH₃)₂PCF₃BF₃/(CH₃CH₂CH₂)(CH₃CH₂)₂(CH₃)PCF₃BF₃/(CH₃CH₂CH₂)(CH₃CH₂)₃PCF₃BF₃ were prepared. 5.0 g (0.019 mol) distributed phosphonium iodide is added to 20 mL deionized water followed by 3.7 g (0.021 mol) potassium (trifluoromethyl)trifluoroborate. 100 mL dichloromethane was added and the reaction was stirred at room temperature for 1 h. The organic layer was separated and extracted three times with 20 mL deionized water, followed by a single extraction with 20 mL of a 1 mg/mL solution of AgNO3 in deionized water, followed by three additional extractions with 20 mL deionized water. The solution was dried over magnesium sulfate and the dichloromethane was removed from the product under vacuum on a rotary evaporator to afford a clear, colorless oil. Yield: 3.5 g, 67%. The composition is confirmed by the ¹H NMR spectrum as shown in FIG. 8A and the ³¹P NMR spectrum shown in FIG. 8B. Thermogravimetric Analysis (TGA) was performed on the material and the results are shown in FIG. 9.

### Example 5

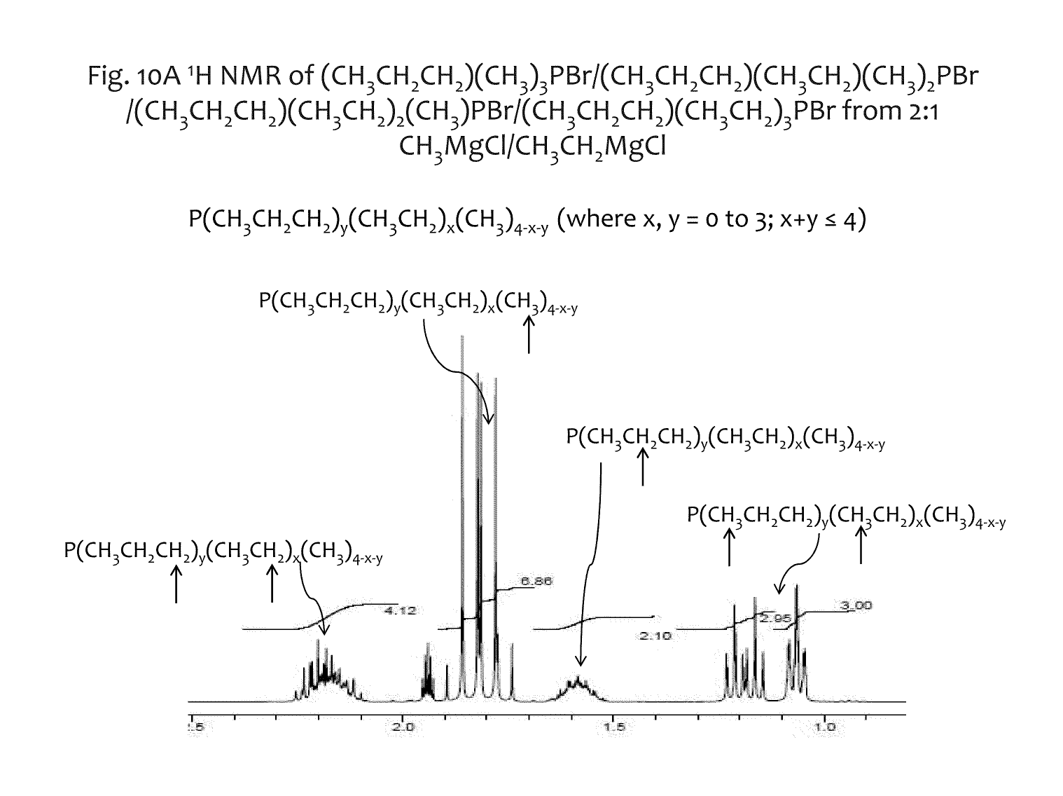

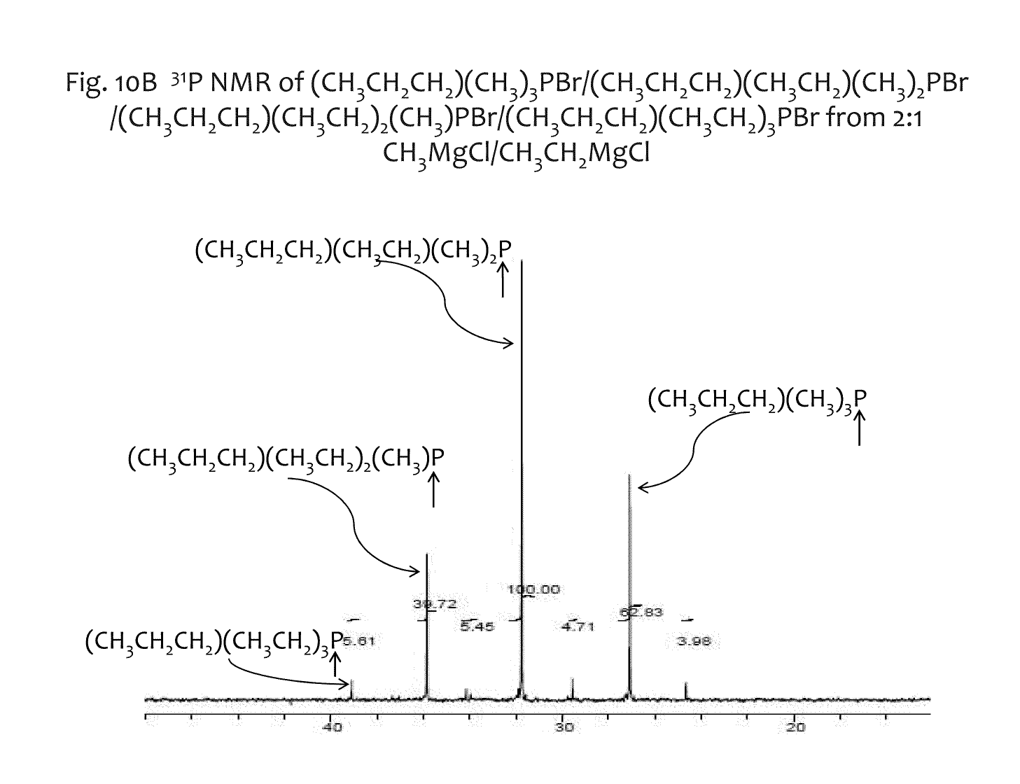

In this experiment, mixed phosphonium bromides (CH₃CH₂CH₂)(CH₃)₃PI/(CH₃CH₂CH₂)(CH₃CH₂)(CH₃)₂PBr/(CH₃CH₂CH₂)(CH₃CH₂)₂(CH₃)PBr/(CH₃CH₂CH₂)(CH₃CH₂)₃PBr were prepared with 2:1 CH₃MgCl/CH₃CH₂MgCl Grignard reagents. Methylmagnesium chloride CH₃MgCl (3.0 M in THF, 153 mL, 0.458 mol) and ethylmagnesium chloride CH₃CH₂MgCl (2.0 M in THF, 115 mL, 0.229 mol) were mixed in a side arm round bottom flask under an atmosphere of argon. This solution was further diluted with 500 mL anhydrous, degassed tetrahydrofuran (THF) and then cooled on an ice bath with stirring. Phosphorus trichloride (20.0 mL, 0.229 mol) was added slowly, dropwise, to the solution of Grignards with vigorous stirring. Once the addition was complete, the reaction was stirred for 1 h and warmed to room temperature. Degassed 1-bromopropane (24.0 mL, 0.264 mol) was added via syringe and the reaction was stirred at 55° C. under inert atmosphere for 7 days. The crude solid was collected by stick filtration, rigorously rinsed 4 times with 500 mL anhydrous THF, and dried in vacuum. Material contains hygroscopic magnesium bromide impurity and must be handled in a glove box. Yield: 35.4 g, 72%. The product is a mixture of 1:2:1:trace (CH₃CH₂CH₂)(CH₃)₃PBr/(CH₃CH₂CH₂)(CH₃CH₂)(CH₃)₂PBr/(CH₃CH₂CH₂)(CH₃CH₂)₂(CH₃)PBr/(CH₃CH₂CH₂)(CH₃CH₂)₃PBr. The composition is confirmed by the ¹H NMR spectrum shown in FIG. 10A and the ³¹P NMR spectrum shown in FIG. 10B.

### Example 6

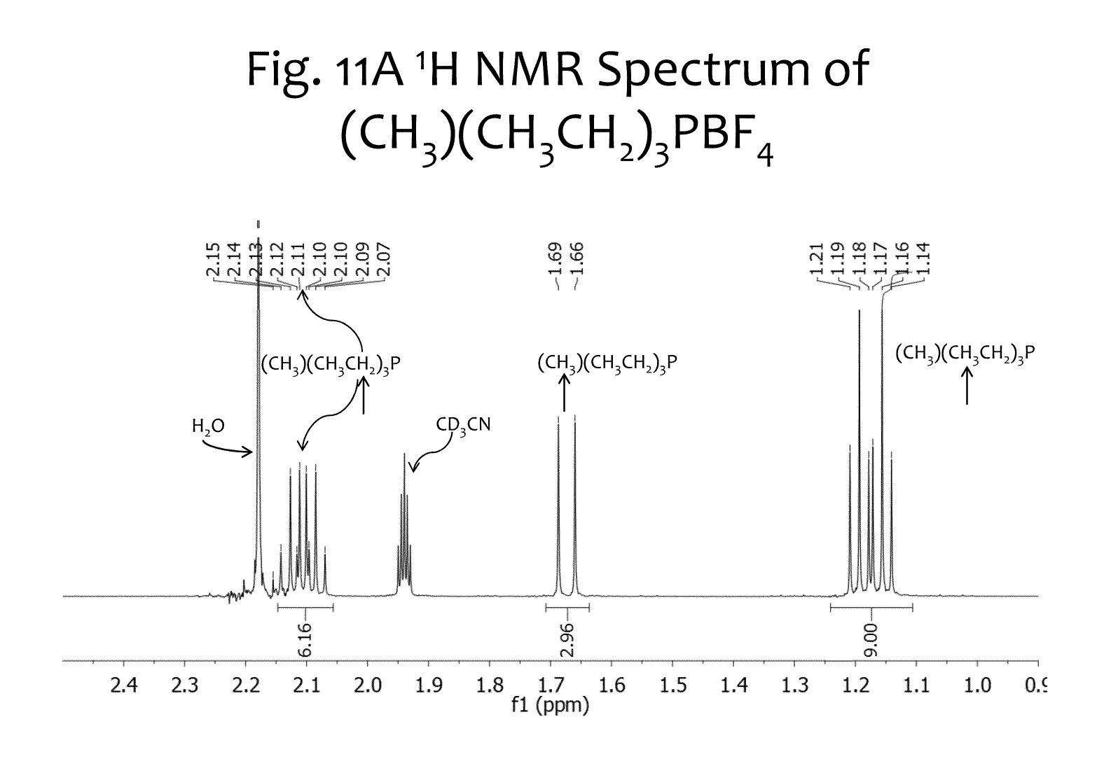

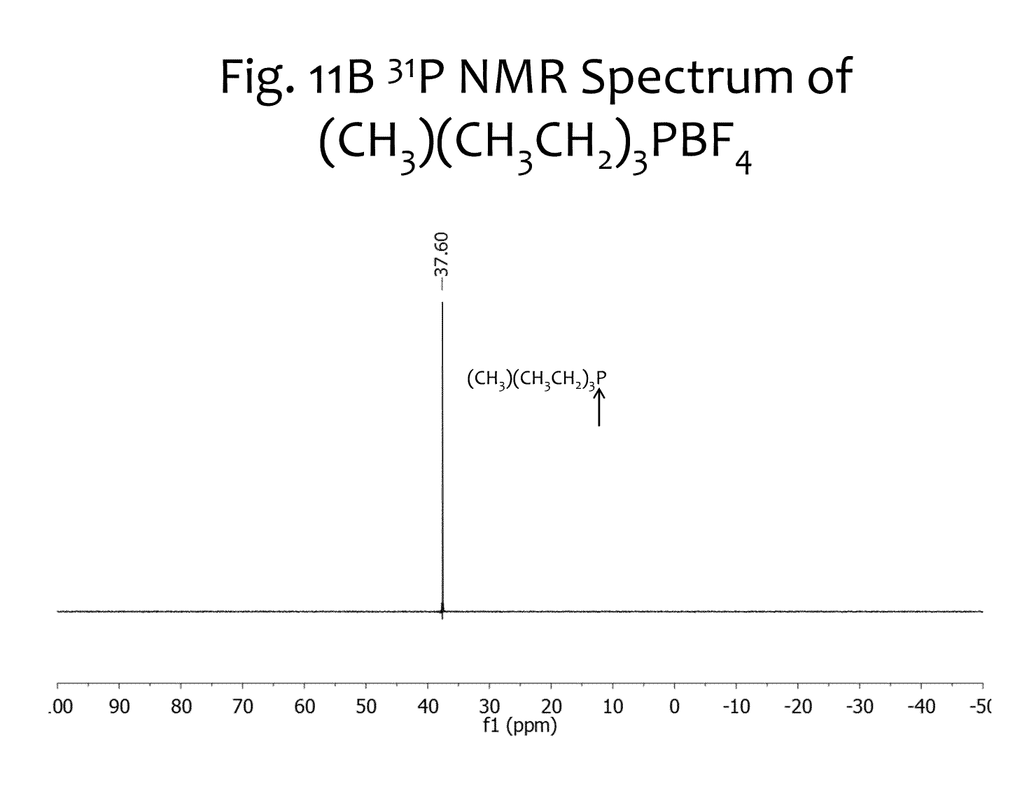

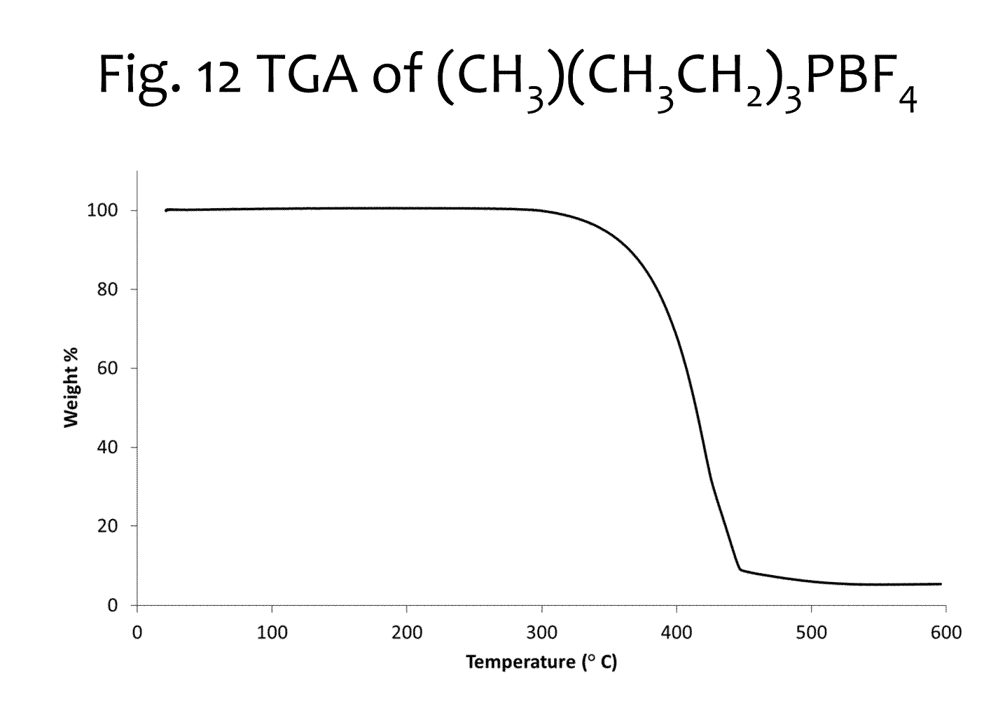

In another experiment, 250 mg (0.96 mmol) triethylmethylphosphonium iodide is added to 15 mL deionized water followed by 163 mg (0.96 mmol) silver nitrate pre-dissolved in 5.0 mL deionized water. The reaction is stirred for 10 minutes, at which time the white to yellow precipitate is filtered off. The solids are then washed with 5.0 mL deionized water and the aqueous fractions are combined. The water is removed under vacuum on a rotary evaporator to leave a white solid residue, which is recrystallized from a 3:1 mixture of ethyl acetate and acetonitrile to give triethylmethylphosphonium nitrate. Yield: 176 mg, 94%. The phosphonium nitrate salt (176 mg, 0.90 mmol) is dissolved in 5 mL anhydrous acetonitrile. 113 mg (0.90 mmol) potassium tetrafluoroborate dissolved in 5 mL anhydrous acetonitrile is added to the phosphonium salt and after stirring 5 minutes the solids are removed by filtration. The solvent is removed on a rotary evaporator and the resulting off white solid recrystallized from hot 2-propanol to give analytically pure triethylmethylphosphonium tetrafluoroborate. Yield: 161 mg, 81%. The composition is confirmed by the ¹H NMR spectrum as shown in FIG. 11A and the ³¹P NMR spectrum shown in FIG. 11B. Thermogravimetric Analysis (TGA) was performed on the material and the results are shown in FIG. 12.

### Example 7

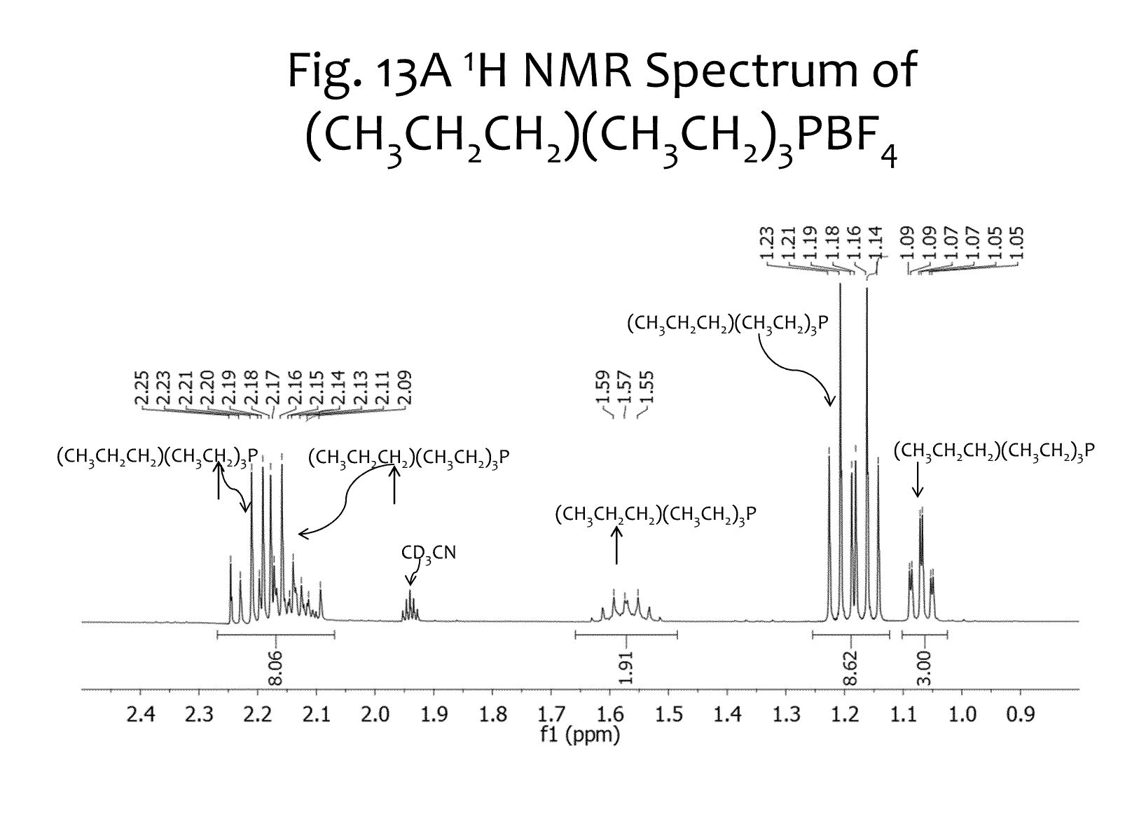

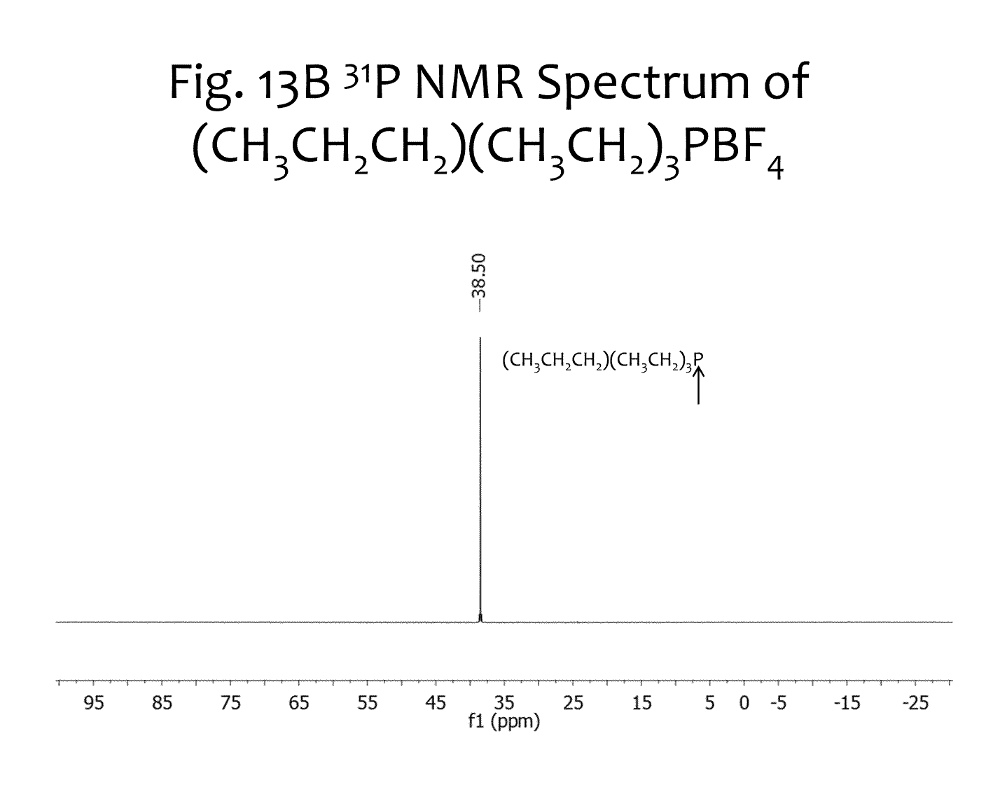

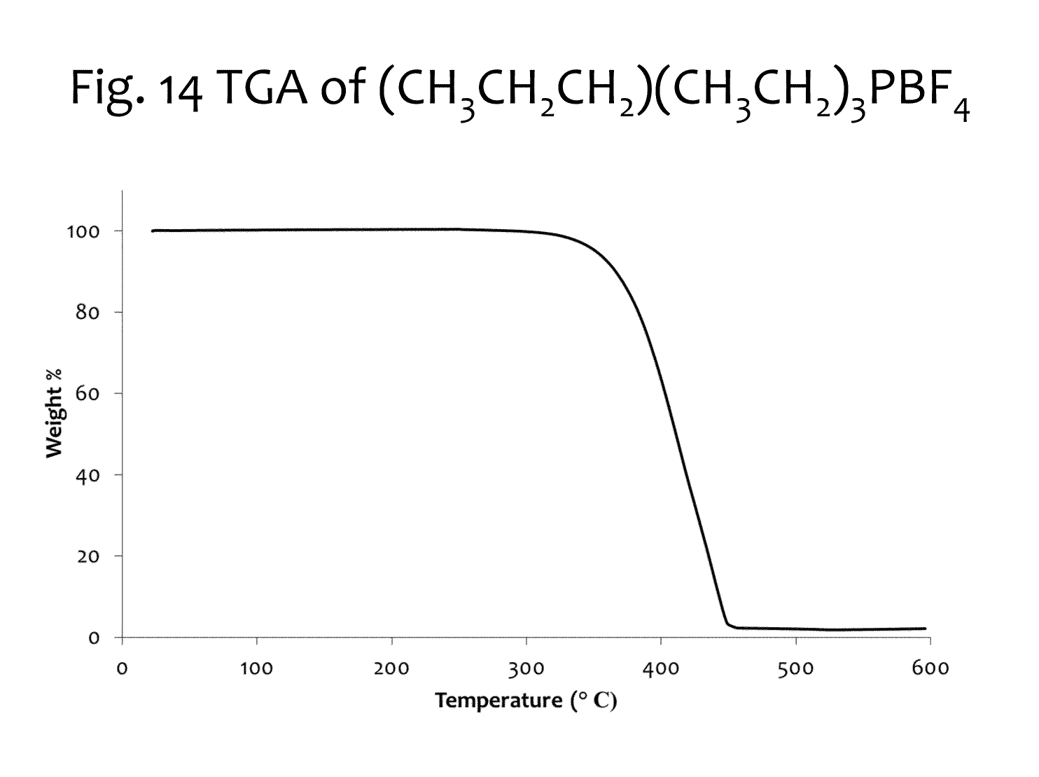

In another experiment, 250 mg (1.04 mmol) of triethylpropylphosphonium bromide and 135 mg (1.06 mmol) of potassium tetrafluoroborate were combined in 10 mL of acetonitrile. A fine white precipitate of KBr started to form immediately. The mixture was stirred for 1 hour, filtered, and the solvent was removed on a rotary evaporator to afford a white solid. Yield: 218 mg, 85%. This crude product can be recrystallized from 2-propanol to afford analytically pure material. The composition is confirmed by the ¹H NMR spectrum as shown in FIG. 13A and the ³¹P NMR spectrum shown in FIG. 13B. Thermogravimetric Analysis (TGA) was performed on the material and the results are shown in FIG. 14.

### Example 8

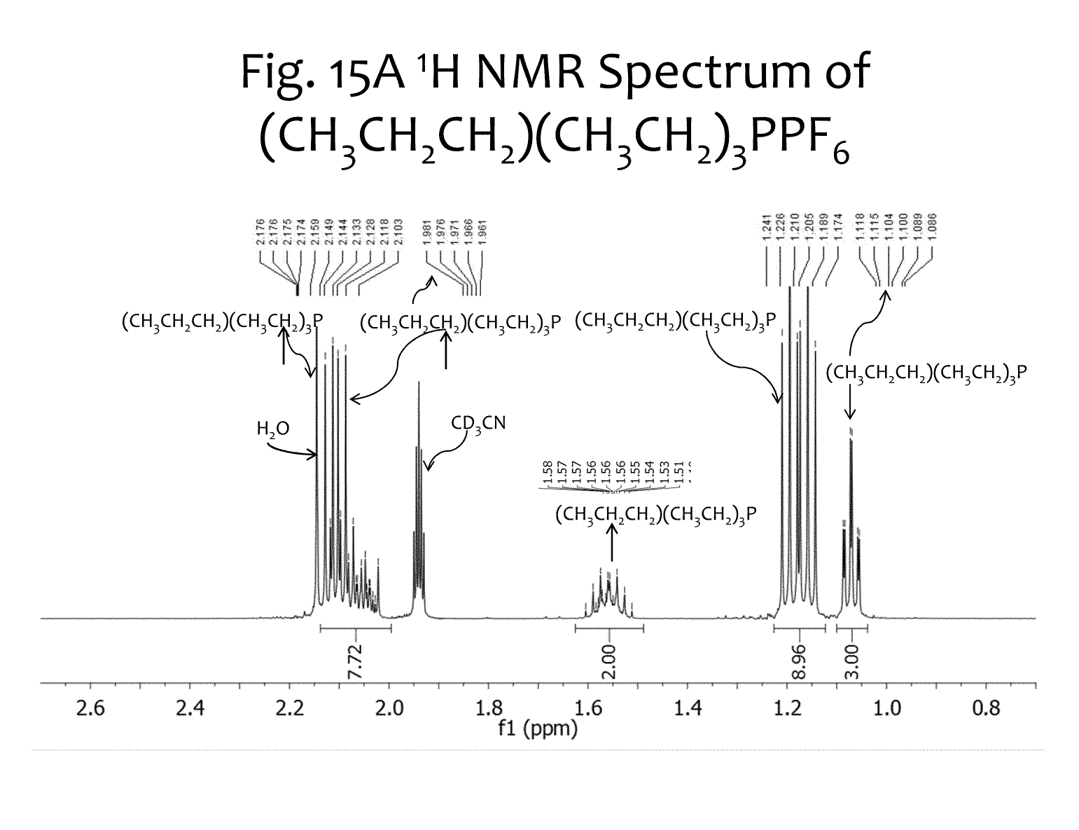

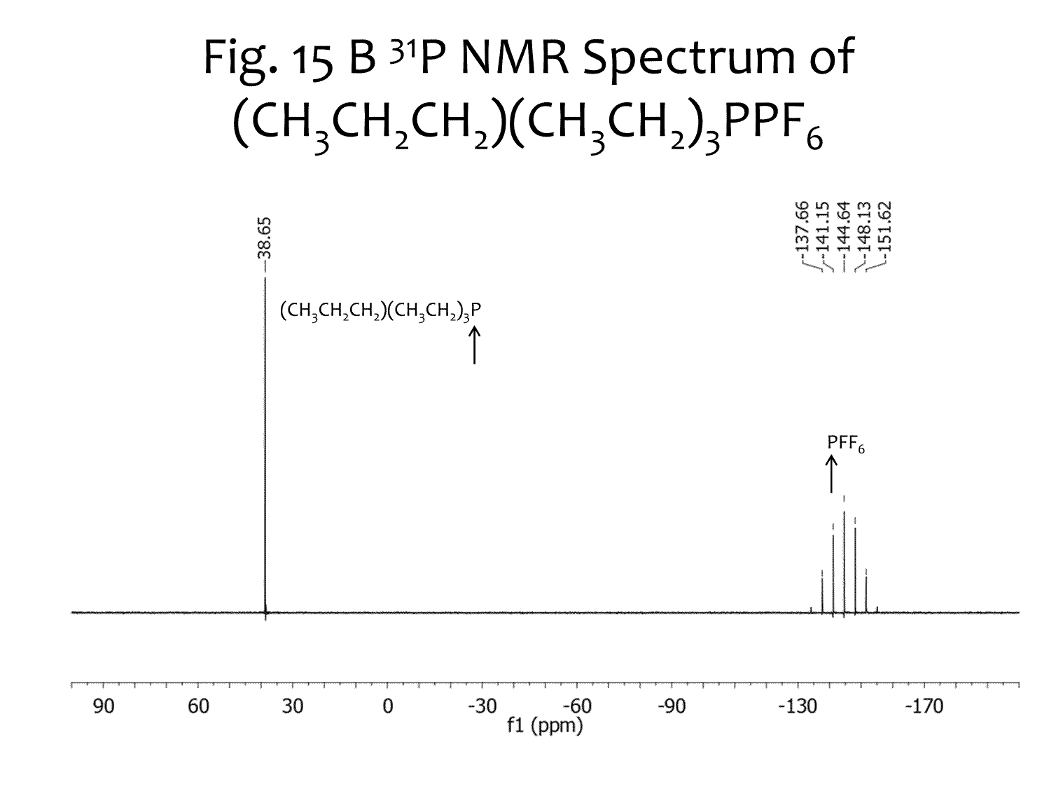

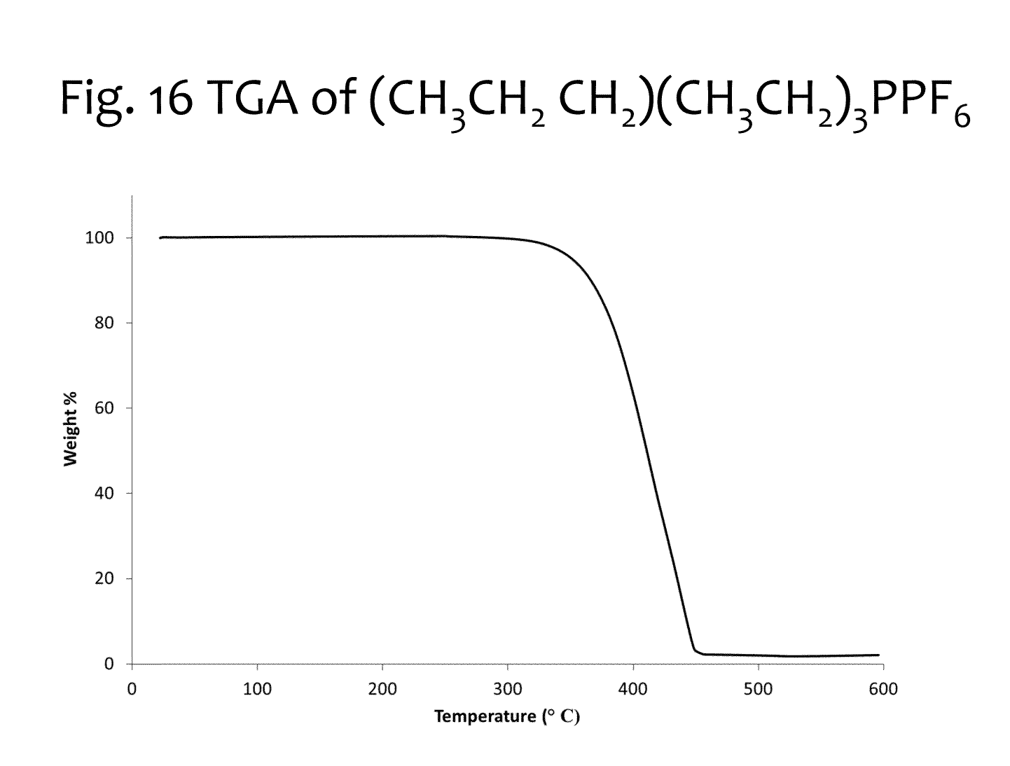

In a further experiment, the reaction was performed in a glove box under an atmosphere of nitrogen. Triethylpropylphosphonium iodide 1.00 g, 3.47 mmol was dissolved in 20 mL anhydrous acetonitrile. To this solution, silver hexafluorophosphate 877 mg (3.47 mmol) was added with constant stirring. White precipitate of silver iodide was formed instantly and the reaction was stirred for 5 minutes. The precipitate was filtered and washed several times with anhydrous CH₃CN. The filtrate was brought out of glove box and evaporated to obtain white solid. The crude material was dissolved in hot isopropanol and passed through 0.2 μm PTFE membrane. The filtrate was cooled to obtain white crystals which were collected by filtration. Yield: 744 mg, 70%. The composition is confirmed by the ¹H NMR spectrum as shown in FIG. 15A and the ³¹P NMR spectrum shown in FIG. 15B. Thermogravimetric Analysis (TGA) was performed on the material and the results are shown in FIG. 16.

### Example 9

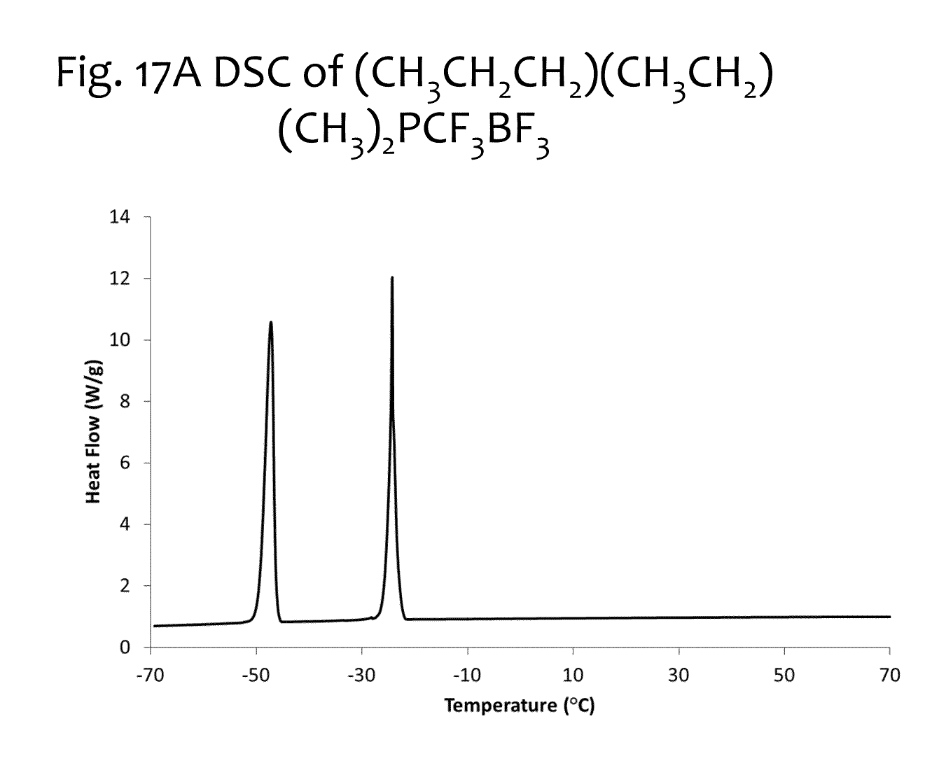

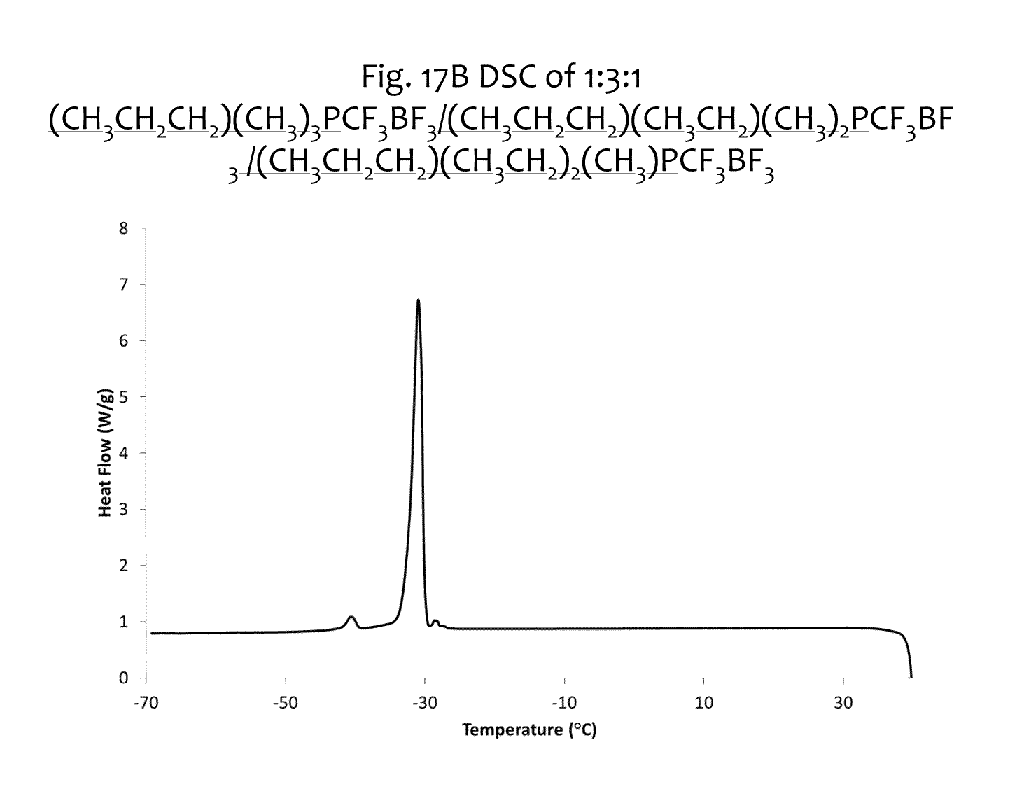

In this example, a ternary phosphonium ionic liquid composition comprising 1:3:1 mole ratio of (CH₃CH₂CH₂)(CH₃)₃PCF₃BF₃/(CH₃CH₂CH₂)(CH₃CH₂)(CH₃)₂P CF₃BF₃/(CH₃CH₂CH₂)(CH₃CH₂)₂(CH₃)P CF₃BF₃ is compared to a single component composition comprising (CH₃CH₂CH₂)(CH₃CH₂)(CH₃)₂P CF₃BF₃. Differential Scanning calorimetry (DSC) was performed on the materials and the results are shown in FIG. 17A for the single component composition and FIG. 17B for the ternary composition. As illustrated by FIGS. 17A and 17B, the ternary composition shows the advantages of a lower freezing temperature and therefore greater liquidus range compared to the single component composition.

### Example 10

In another experiment, phosphonium salt (CH₃CH₂CH₂)(CH₃CH₂)(CH₃)₂PC(CN)₃ was prepared. This salt exhibits a low viscosity of 19.5 cP at 25° C., melting point of −10.9° C., onset decomposition temperature of 396.1° C., liquid range of 407° C., ionic conductivity of 13.9 mS/cm, and electrochemical voltage window of −1.5 V to +1.5 V when measured in an electrochemical cell with a Pt working electrode and a Pt counter electrode and an Ag/Ag reference electrode. The results are summarized in Table 16 below.

TABLE 16

| Viscosity | Thermal | Melting | Liquid | Neat | |
|---|---|---|---|---|---|
| at RT | Stability | Point | Range | Conductivity | Echem Window |
| (cP) | (° C.) | (° C.) | (° C.) | (mS/cm) | (V) |
| 19.5 | 396.1 | −10.9 | 407 | 13.9 | −1.5 V to +1.5 V |

### Example 11

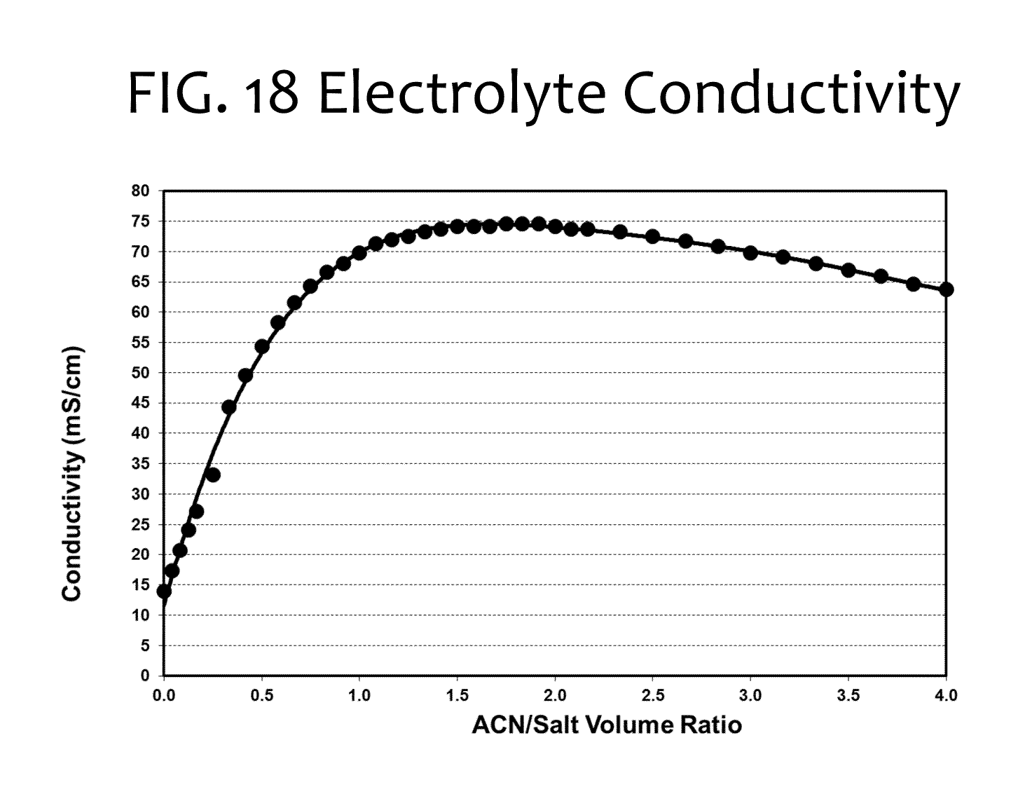

In another experiment, phosphonium salt (CH₃CH₂CH₂)(CH₃CH₂)(CH₃)₂PC(CN)₃ was prepared. The salt was dissolved in a solvent of acetonitrile (ACN) with ACN/salt volume ratios ranging from 0 to 4. The ionic conductivities of the resulting electrolyte solution were measured at room temperature and the results are shown in FIG. 18. As FIG. 18 shows, the ionic conductivity increases with the increase of ACN/salt ratio from 13.9 mS/cm at zero ratio (neat ionic liquid) to a peak value of 75 mS/cm at ratios between 1.5 and 2.0.

### Example 12

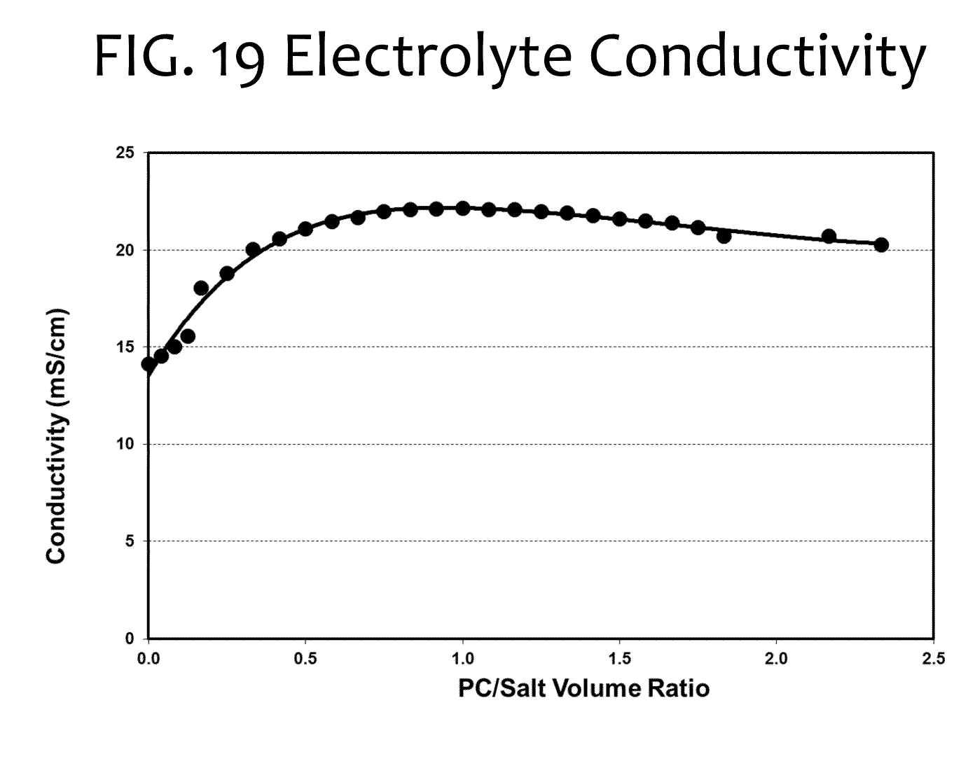

In another experiment, phosphonium salt (CH₃CH₂CH₂)(CH₃CH₂)(CH₃)₂PC(CN)₃ was prepared. The salt was dissolved in a solvent of propylene carbonate (PC) with PC/salt volume ratios ranging from 0 to 2.3. The ionic conductivities of the resulting electrolyte solution were measured at room temperature and the results are shown in FIG. 19. As FIG. 19 shows, the ionic conductivity increases with the increase of PC/salt ratio from 13.9 mS/cm at zero ratio (neat ionic liquid) to a peak value of 22 mS/cm at ratios between 0.75 and 1.25.

### Examples 13-31

In further experiments, various phosphonium salts were prepared. The salts were dissolved in a solvent of acetonitrile (ACN) to form electrolyte solutions at 1.0 M concentration. The ionic conductivities of the resulting electrolyte solutions were measured at room temperature. The electrochemical voltage window (Echem Window) was determined in an electrochemical cell with a Pt working electrode and a Pt counter electrode and an Ag/Ag+ reference electrode. The results are summarized in Table 17. The electrolytes exhibited ionic conductivity at room temperature greater than about 28 mS/cm, or greater than about 34 mS/cm, or greater than about 41 mS/cm, or greater than about 55 mS/cm, or greater than about 61 mS/cm. In one arrangement, the Echem window was between about −3.2 and +3.2 V. In another arrangement, the Echem window was between about −2.0 and +2.4 V. In another arrangement, the Echem window was between about −1.5 and +1.5 V. In yet another arrangement, the Echem window was between about −1.0 and +1.0 V.

TABLE 17

| Example | Cation | Anion | Conductivity (mS/cm) | Echem Window (V) |
|---|---|---|---|---|
| 13 | (CH₃CH₂CH₂)(CH₃CH₂)(CH₃)₂P⁺ | C(CN)₃⁻ | 69.0 | −1.7 to +1.1 |
| 14 | (CH₃CH₂CH₂)(CH₃CH₂)(CH₃)₂P⁺ | CF₃BF₃⁻ | 64.0 | −3.0 to +2.4 |
| 15 | (CH₃CH₂CH₂)(CH₃CH₂)(CH₃)₂P⁺ | CF₃SO₃⁻ | 43.7 | −2.0 to +1.9 |
| 16 | (CH₃CH₂CH₂)(CH₃CH₂)(CH₃)₂P⁺ | BF₄⁻ | 55.5 | −2.0 to +1.9 |
| 17 | (CH₃CH₂CH₂)(CH₃CH₂)(CH₃)₂P⁺ | (CF₃CO)₂N⁻ | 41.5 | −1.6 to +2.0 |
| 18 | (CH₃CH₂CH₂)(CH₃CH₂)(CH₃)₂P⁺ | (CF₃)₂PO₂⁻ | 45.6 | −1.8 to +1.8 |
| 19 | (CH₃CH₂CH₂)₂(CH₃)₂P⁺ | CF₃SO₃⁻ | 38.7 | −2.0 to +2.4 |
| 20 | (CH₃CH₂CH₂)₂(CH₃)₂P⁺ | CH₃C₆H₄SO₃⁻ | 28.6 | N/A |
| 21 | (CH₃CH₂CH₂)₂(CH₃)₂P⁺ | C(CN)₃⁻ | 61.5 | −1.8 to +1.1 |
| 22 | (CH₃CH₂CH₂)₂(CH₃)₂P⁺ | (CF₃SO₂)₂N⁻ | 43.1 | −3.2 to +2.4 |
| 23 | (CH₃CH₂CH₂)₂(CH₃)₂P⁺ | CH₂CHBF₃⁻ | 41.0 | −1.0 to +1.0 |
| 24 | ((CH₃)₂CH)(CH₃CH₂)(CH₃)₂P⁺ | C₄H₄SO₄N | 32.5 | N/A |
| 25 | ((CH₃)₂CH)(CH₃CH₂)(CH₃)₂P⁺ | C₆H₅BF₃⁻ | 37.6 | N/A |
| 26 | ((CH₃)₂CH)(CH₃CH₂)(CH₃)₂P⁺ | C₆H₃F₂BF₃⁻ | 37.1 | N/A |
| 27 | ((CH₃)₂CHCH₂)(CH₃CH₂)(CH₃)₂P⁺ | CH₂CHBF₃⁻ | 45.7 | −1.8 to +1.8 |
| 28 | ((CH₃)₂CHCH₂)₂(CH₃CH₂)(CH₃)P⁺ | CF₃SO₃⁻ | 46.8 | N/A |
| 29 | ((CH₃)₂CHCH₂)₂(CH₃CH₂)(CH₃)P⁺ | (CF₃SO₂)₂N⁻ | 37.5 | N/A |
| 30 | ((CH₃)₂CHCH₂)₂(CH₃CH₂)(CH₃)P⁺ | CH₃CH₂BF₃⁻ | 34.3 | N/A |
| 31 | ((CH₃)₂CHCH₂)₂(CH₃CH₂)(CH₃)P⁺ | BF₄⁻ | 33.9 | N/A |

### Examples 32-37

In further experiments, various phosphonium salts were prepared and compared to an ammonium salt as control. The salts were dissolved in a solvent of propylene carbonate (PC) to form electrolyte solutions at 1.0 M concentration. The ionic conductivities of the resulting electrolyte solutions were measured at room temperature. The electrochemical voltage window (Echem Window) was determined in an electrochemical cell with a Pt working electrode and a Pt counter electrode and an Ag/Ag+ reference electrode. The results are summarized in Table 18 demonstrating that the phosphonium salts exhibit higher conductivity and wider electrochemical voltage stability window compared to the control—ammonium analog.

TABLE 18

| | | | Echem Window |
|---|---|---|---|
| Example | Electrolyte Salts | Conductivity (mS/cm) | (V) |
| 32 | (CH₃CH₂CH₂)(CH₃CH₂)(CH₃)₂PBF₄ | 16.9 | −2.6 to +2.1 |
| 33 | (CH₃CH₂CH₂)(CH₃CH₂)(CH₃)₂PCF₃BF₃ | 15.9 | −1.9 to +3.0 |
| 34 | [1:3:1 ratio | 15.2 | −2.0 to +2.3 |
| | (CH₃CH₂CH₂)(CH₃)₃P/(CH₃CH₂CH₂)(CH₃CH₂)(CH₃)₂P/ | | |
| | (CH₃CH₂CH₂)(CH₃CH₂)₂(CH₃)P]BF₄ | | |
| 35 | (CH₃CH₂CH₂)(CH₃CH₂)₃PBF₄ | 17.6 | −2.5 to +2.2 |
| 36 | (CH₃CH₂)₄PBF₄ | 17.4 | −2.4 to +2.5 |
| 37 | (CH₃CH₂)₃(CH₃)NBF₄ | 14.9 | −1.7 to +1.9 |

### Examples 38-41

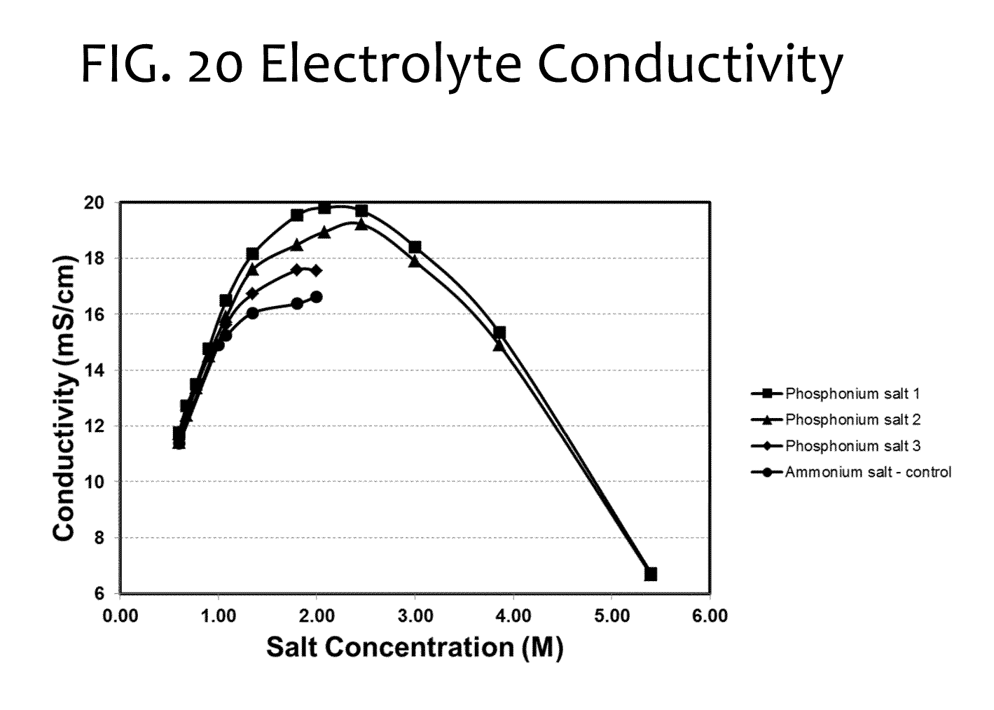

In further experiments, various phosphonium salts were prepared and compared to an ammonium salt as control. The salts were dissolved in a solvent of propylene carbonate (PC) to form electrolyte solutions at concentrations ranging from 0.6 up to 5.4 M. The ionic conductivities of the resulting electrolyte solutions were measured at room temperature and the results are presented in FIG. 20. The numerical values of conductivity at 2.0 M concentration are shown in Table 19 illustrating that the phosphonium salts exhibit higher conductivity compared to the control—ammonium analog.

TABLE 19

| | | | Conductivity |
|---|---|---|---|
| Example | | Salts | (mS/cm) |
| 38 | Phosphonium salt 1 | (CH₃CH₂CH₂)(CH₃CH₂)(CH₃)₂PBF₄ | 19.8 |
| 39 | Phosphonium salt 2 | (CH₃CH₂CH₂)(CH₃CH₂)(CH₃)₂PCF₃BF₃ | 18.9 |
| 40 | Phosphonium salt 3 | [1:3:1 ratio | 17.6 |
| | | (CH₃CH₂CH₂)(CH₃)₃P/(CH₃CH₂CH₂)(CH₃CH₂)(CH₃)₂P/ | |
| | | (CH₃CH₂CH₂)(CH₃CH₂)₂(CH₃)P]BCF₃F3 | |
| 41 | Ammonium salt conytrol | (CH₃CH₂)₃(CH₃)NBF₄ | 16.6 |

### Example 42

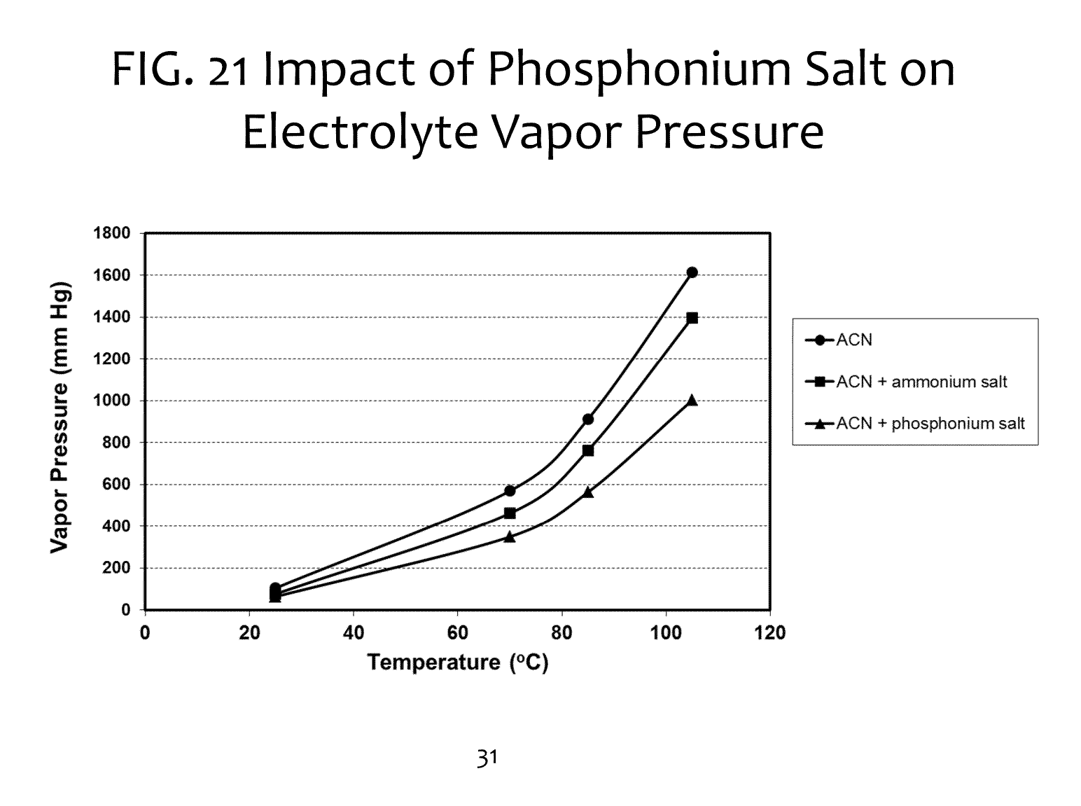

In another experiment, phosphonium salt—(CH₃CH₂CH₂)(CH₃CH₂)(CH₃)₂PCF₃BF₃ was prepared and compared to an ammonium salt (CH₃CH₂)₃(CH₃)NBF₄ as control. The salts were dissolved in a solvent of acetonitrile (ACN) to form electrolyte solutions at 1.0 M concentration. The vapor pressures of the solutions were measured by pressure Differential Scanning calorimeter (DSC) at temperatures from 25 to 105° C. As illustrated in FIG. 21, the vapor pressure of ACN is lowered by 39% with the phosphonium salt compared to 27% with the ammonium salt at 25° C., 38% with the phosphonium salt compared to 13% for the ammonium salt at 105° C. The significant suppression in vapor pressure by phosphonium salt is an advantage in reducing the flammability of the electrolyte solution thus improving the safety of devices utilizing the electrolyte composition, such as batteries, EDLC devices, and the like.

### Examples 43-46

In another experiment, phosphonium salt was used as an additive in a lithium battery standard electrolyte solution. In one embodiment of the present invention, a standard electrolyte solution of 1.0 M LiPF₆ in a mixed solvent of EC (ethylene carbonate) and DEC (diethyl carbonate) at 1:1 weight ratio, noted as EC:DEC 1:1, was provided by Novolyte Technologies (part of BASF Group). The phosphonium salt (CH₃CH₂CH₂)(CH₃CH₂)(CH₃)₂PCF₃BF₃ was added to the standard electrolyte solution at 20 w %. In another embodiment of the present invention, a standard electrolyte solution of 1.0 M LiPF₆ in a mixed solvent of EC (ethylene carbonate), DEC (diethyl carbonate) and EMC (ethylmethyl carbonate) at 1:1:1 weight ratio, noted as EC:DEC:EMC 1:1:1, was provided by Novolyte Technologies (part of BASF Group). The phosphonium salt (CH₃CH₂CH₂)(CH₃CH₂)(CH₃)₂PCF₃BF₃ was added to the standard electrolyte solution at 10 w %. Fire self-extinguishing test was performed by putting 1 g sample of the electrolyte solution into a glass dish, igniting the sample, and record time needed for the flame to extinguish. The results are summarized in Table 20 below. The phosphonium additive in concentrations between 10 and 20 w % decreased the fire self-extinguishing time (seconds per gram) was reduced by 33 to 53%. This is an indication that the safety and reliability of lithium ion batteries can be substantially improved by using the phosphonium salt as an additive in the conventional lithium ion electrolytes.

TABLE 20

| | | Conventional | Phosphonium | SET |
|---|---|---|---|---|
| Example | Solvent | Salt | Additive (w %) | (s/g) |
| 43 | EC:DEC 1:1 | 1.0M LiPF₆ | 0 | 67 |
| 44 | EC:DEC 1:1 | 1.0M LiPF₆ | 20 | 31 |
| 45 | EC:DEC:EMC 1:1:1 | 1.0M LiPF₆ | 0 | 75 |
| 46 | EC:DEC:EMC 1:1:1 | 1.0M LiPF₆ | 10 | 51 |

### Example 47

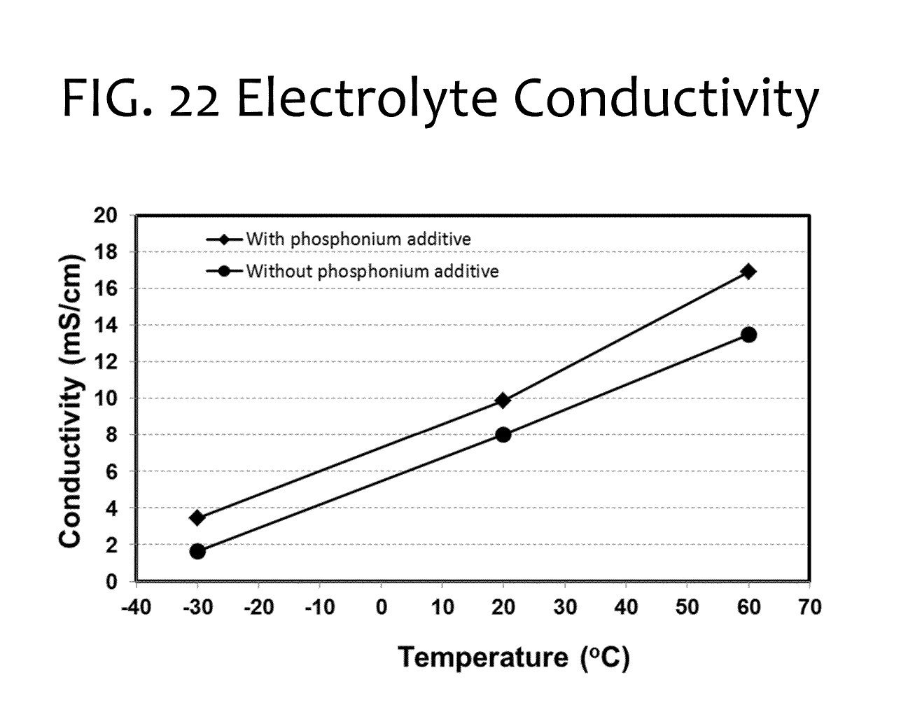

In another experiment, phosphonium salt was used as an additive in a lithium battery standard electrolyte solution. In one embodiment of the present invention, a standard electrolyte solution of 1.0 M LiPF₆ in a mixed solvent of EC (ethylene carbonate) and DEC (diethyl carbonate) at 1:1 weight ratio, noted as EC:DEC 1:1, was provided by Novolyte Technologies (part of BASF Group). The phosphonium salt (CH₃CH₂CH₂)(CH₃CH₂)(CH₃)₂PC(CN)₃ was added to the standard electrolyte solution at 10 w %. The ionic conductivities of both the standard electrolyte solution and the solution with phosphonium additive were measured at different temperatures from −30 to +60° C. As illustrated in FIG. 22, the phosphonium additive improves the ionic conductivity of the electrolyte solution in a broad temperature range. At −30° C., the ionic conductivity is increased by 109% as a result of the phosphonium additive. At +20° C., the ionic conductivity is increased by 23% as a result of the phosphonium additive. At +60° C., the ionic conductivity is increased by about 25% as a result of the phosphonium additive. In general, ionic conductivity of the standard electrolyte solution increased by at least 25% as a result of the phosphonium additive

### Example 48

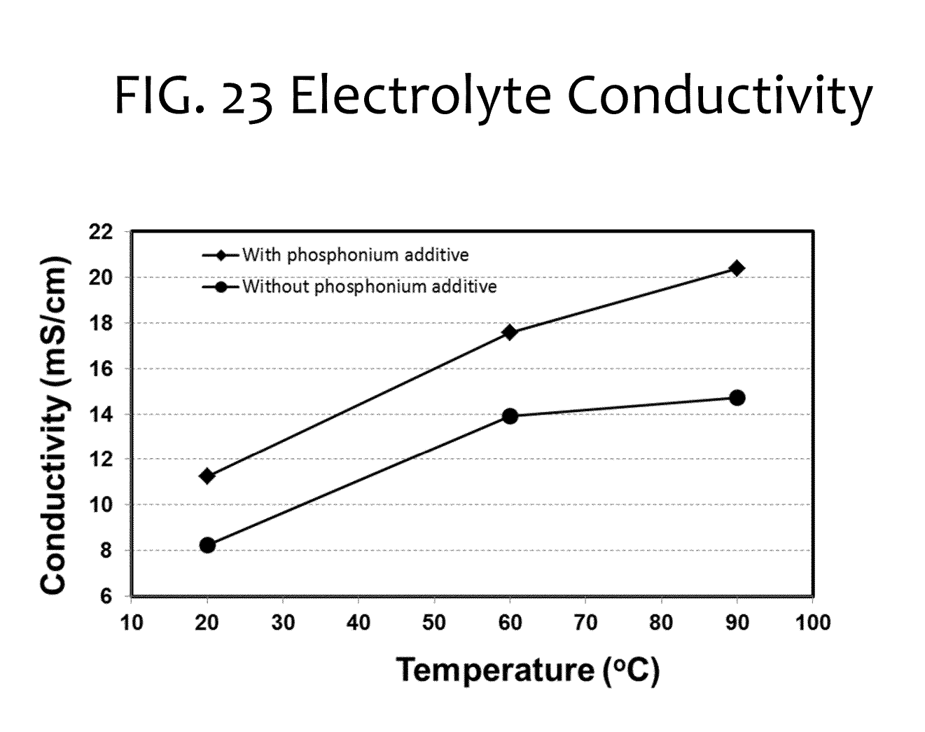

In another experiment, phosphonium salt was used as an additive in a lithium battery standard electrolyte solution. In one embodiment of the present invention, a standard electrolyte solution of 1.0 M LiPF₆ in a mixed solvent of EC (ethylene carbonate), DEC (diethyl carbonate) and EMC (ethylmethyl carbonate) at 1:1:1 weight ratio, noted as EC:DEC:EMC 1:1:1, was provided by Novolyte Technologies (part of BASF Group). The phosphonium salt (CH₃CH₂CH₂)(CH₃CH₂)(CH₃)₂PCF₃BF₃ was added to the standard electrolyte solution at 10 w %. The ionic conductivities of both the standard electrolyte solution and the solution with phosphonium additive were measured at different temperatures from 20 to 90° C. As illustrated in FIG. 23, the phosphonium additive improves the ionic conductivity of the electrolyte solution in a broad temperature range, especially at high temperatures. At 20° C., the ionic conductivity is increased by about 36% as a result of the phosphonium additive. At 60° C., the ionic conductivity is increased by about 26% as a result of the phosphonium additive. At 90° C., the ionic conductivity is increased by about 38% as a result of the phosphonium additive. In general, ionic conductivity of the standard electrolyte solution increased by at least 25% as a result of the phosphonium additive.

The present invention is not to be limited in scope by the specific embodiments disclosed in the examples which are intended as illustrations of a few aspects of the invention and any embodiments which are functionally equivalent are within the scope of this invention. Indeed, various modifications of the invention in addition to those shown and described herein will become apparent to those skilled in the art and are intended to fall within the appended claims.

A number of references have been cited, the entire disclosures of which are incorporated herein by reference.

What is claimed is:

1. A method of synthesizing a mixture of molecules or salts having low symmetry by using mixed Grignard reagents.

2. The method of claim 1 wherein one or more components of the mixture of molecules or salts having low symmetry exhibit symmetry lower than C₃ᵥ.

3. The method of claim 1 wherein a ratio of different components in the mixture of molecules or salts having low average symmetry is varied by varying mole fraction or ratio of Grignard reagents in the mixture of Grignard reagents.

4. A method of synthesizing a mixture of molecules, comprising the steps of:
reacting a reactant (R) with a mixture of at least two Grignard reagents having mole fractions of fₐ and f_{b}, respectively, and where fₐ+f_{b}=1, to produce a mixture of molecules having selective mole fractions.

5. The method of claim 4 wherein the Grignard reagents are comprised of RₐMgX and R_{b}MgX, where Rₐ and R_{b} are independently comprised of any of: alkyl, alkenyl, alkynyl, aryl or other compound capable of producing an organomagnesium compound, and X is comprised of any one of: Cl, Br or I.

6. The method of claim 4 wherein R is comprised of a phosphine precursor PR′₃ where R′ is comprised of any one or more of: chloro, bromo, iodo, alkyloxy, aryloxy, or other leaving group having electronegativity greater than carbon.

7. The method of claim 4 further comprising the steps of:
reacting the mixture of molecules with one or more alkyl halides to produce a corresponding mixture of phosphonium halides; and
ion exchanging the halides with an anion A⁻ to form a mixture of phosphonium ionic liquids or salts having selective mole fractions.

8. The method of claim 4 wherein R is comprised of a carbonyl containing molecule.

9. The method of claim 8 wherein the carbonyl containing molecule is selected from the group consisting of: aldehydes, ketones and esters.

10. The method of claim 4 wherein R is comprised of a metal complex.

11. The method of claim 10 wherein the metal complex is comprised of MY₂, where M is any metal, and Y is any one or more of Cl, Br, I, CH₃C₆H₄SO₃, CF₃SO₃, OR and the like.

12. A mixture of molecules having low average symmetry, wherein the mixture is prepared according to the method of claim 4.

13. A method of synthesizing a mixture of phosphonium ionic liquids or salts having controlled cation distribution, comprising the following reactions: 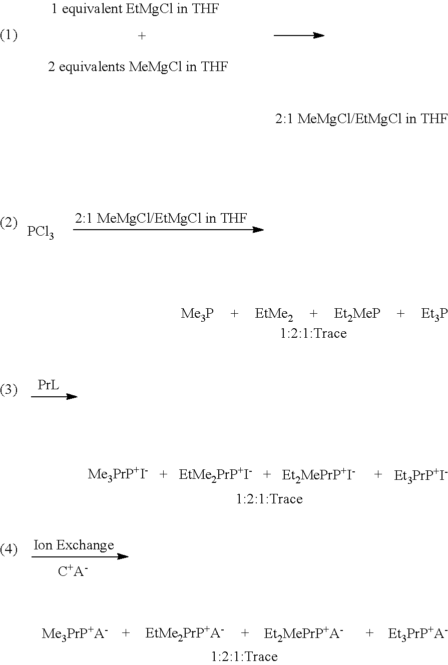
wherein Me is (CH₃), Et is (CH₃CH₂), Pr is (CH₃CH₂CH₂), C⁺ is a cation, and A⁺ is an anion.

14. A method of synthesizing a mixture of phosphonium ionic liquids or salts having controlled cation distribution, comprising the following reactions: 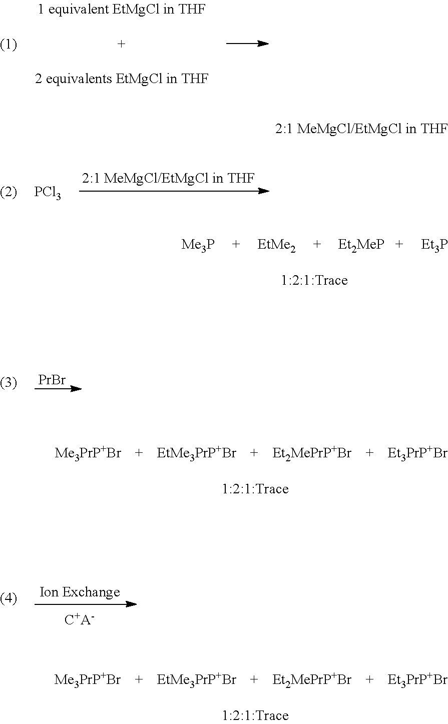
wherein Me is (CH₃), Et is (CH₃CH₂), Pr is (CH₃CH₂CH₂), C⁺ is a cation, and A⁺ is an anion.

15. The method of claim 13 or 14 wherein the anion A⁻ is comprised of any one or more of: —O₃SCF₃, —O₂CCF₃, —O₂CCF₂CF₂CF₃, CF₃BF₃⁻, C(CN)₃⁻, PF₆⁻, NO₃⁻, —O₃SCH₃, BF₄⁻, —O₃SCF₂CF₂CF₃, —O₂CCF₂CF₃, —O₂CH, —O₂CC₆H₅, —OCN, CO₃²⁻, (—OCOCOO—)BF₂⁻, (—OCOCOO⁻)(CF₃)₂B⁻, (—OCOCOO⁻)₂B⁻, (CF₃SO₂)₂N⁻, (CF₃)₂BF₂⁻, (CF₃)₃BF⁻, CF₃CF₂BF₃⁻, or —N(CN)₂.

16. A method of synthesizing a mixture of phosphonium salts or ionic liquids having controlled cation distribution, comprising the reaction: 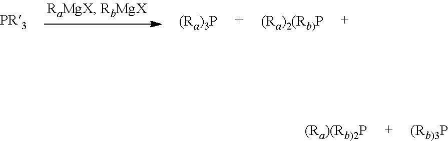
where Rₐ and R_{b} are independently comprised of any one or more of: alkyl, alkenyl, alkynyl, aryl or any other material capable of producing an organomagnesium compound, and R′ is comprised of any one or more of: chloro, bromo, iodo, alkyloxy, aryloxy or any other suitable leaving group, generally with a greater electronegativity than carbon, and where RₐMgX and R_{b}MgX are present at mole fractions fₐ and f_{b}, respectively, and fₐ+f_{b}=1.

17. The method of claim 16 wherein the reaction product is a mixture of phosphines having mole ratio: (Rₐ)₃P:(Rₐ)₂(R_{b})P:(Rₐ)(R_{b})₂P:(R_{b})₃P; and fₐ³:3*(fₐ²*f_{b}):3*(fₐ*f_{b}²):f_{b}³.

18. The method of claim 17 further comprising the steps of reacting the mixture of phosphines with one or more alkyl halides to produce a corresponding mixture of phosphonium halides; and
ion exchanging the halides with an anion A⁻ to form a mixture of phosphonium ionic liquids or salts having selective mole fractions.

19. A method of synthesizing a mixture of phosphonium salts or ionic liquids having controlled cation distribution, comprising the steps of:
(i) reacting a reactant of formula PR′₃ with a mixture of Grignard reagents to form a product mixture, wherein each R′ is independently a leaving group having electronegativity greater than carbon;
(ii) reacting the product mixture of step (i) with an halogen containing compound thereby producing a mixture of phosphonium halides; and
(iii) ion exchanging the halides with an anion to form a mixture of phosphonium salts or ionic liquids.

20. The method of claim 19 wherein each R′ is selected independently from the group consisting of chloro, bromo, iodo, alkyloxy, aryloxy, thioalkyl, perfluoroalkylsulfonates, tosylates, mesylates, and any combinations thereof.

21. The method of claim 19 wherein the reactant is PCl₃.

22. The method of claim 19 wherein at least two Grignard reagents in the mixture of Grignard reagents comprise a different organic group, wherein the organic group is capable of producing an organomagnesium compound.

23. The method of claim 22 wherein the organic group is selected independently from the group consisting of alkyl, alkenyl, alkynyl, aryl, heteroaryl, cyclyl, heterocyclyl, and any combinations thereof.

24. The method of claim 19 wherein the mixture of Grignard reagents comprises 2 to 10 different Grignard reagents.

25. The method of claim 19 wherein at least two Grignard reagents in the mixture of Grignard reagents have a mole ratio of about 100:1 to about 1:1.

26. The method of claim 25 wherein the mixture of Grignard reagents comprises two Grignard reagents having a mole ratio of about 10:1 to about 1:1.

27. The method of claim 25 wherein the mixture of Grignard reagents comprises two Grignard reagents having a mole ratio of about 2:1.

28. The method of claim 19 wherein the mixture of Grignard reagents comprises MeMgCl and EtMgCl.

29. The method of claim 28 wherein the mixture of Grignard reagents comprises MeMgCl and EtMgCl in about 2:1 mole ratio.

30. The method of claim 19 wherein the halogen containing compound is of formula RI or RBr, wherein R is selected from the group consisting of alkyl, alkenyl, alkynyl, aryl, heteroaryl, cyclyl, and heterocyclyl.

31. The method of claim 19 wherein the anion is selected from the group consisting of (CF₂SO₂)₂N⁻, (CF₃)₂BF₂⁻, (CF₃)₃BF⁻, (CF₃)₃PF₃⁻, (CF₃)₄B⁻, (CF₃)₄PF₂⁻, (CF₃CF₂)₃PF₃⁻, (CF₃CF₂)₄PF₂⁻, (CF₃CF₂CF₂)₃PF₃⁻, (CF₃CF₂CF₂)₄PF₂⁻, (CF₃SO₂)₂N⁻, (—OCO(CH₂)ₙCOO—)BF(CF₃)⁻, (—OCOCOCOO—)₂B⁻, (—OCOCOCOO—)B(CF₃)₂⁻, (—OCOCOCOO—)BF(CF₃)⁻, (—OCOCOO—)(CF₃)₂B⁻, (—OCOCOO—)(CF₃)₃PF₂⁻, (—OCOCOO—)₂B⁻, (—OCOCOO—)₂PF₂⁻, (—OCOCOO—)₃P⁻, (—OCOCOO—)BF(CF₃)⁻, (—OCOCOO—)BF₂⁻, (—OCOCOO—)PF₄⁻, (—OCOCR¹R²CR¹R²COO—)B(CF₃)₂⁻, (—OCOCR¹R²CR¹R²COO—)BF(CF₃)⁻, (—OCOCR₂COO—)₂B⁻, (—OCOCR₂COO—)B(CF₃)₂⁻, (—OCOCR₂COO—)BF(CF₃)⁻, (—OSOCF₂SOO—)B(CF₃)₂⁻, (—OSOCF₂SOO—)BF(CF₃)⁻, (—OSOCF₂SOO—)BF₂⁻, (—OSOCH₂SOO—)B(CF₃)₂⁻, (—OSOCH₂SOO—)BF(CF₃)⁻, (—OSOCH₂SOO—)BF₂⁻, BF₄⁻, C(CN)₃⁻, C₆H₅CO₂⁻, CF₃CF₂CO₂⁻, CF₃B(—OOR)₃⁻, CF₃B(—OOR)F₂⁻, CF₃BF(—OOR)₂⁻, CF₃BF₃⁻, CF₃CF₂BF₃⁻, CF₃CF₂CF₂CO₂⁻, CF₃CF₂CF₂SO₃⁻, CF₃CO₂⁻, CF₃SO₃⁻, CH₃SO₃⁻, CHO₂⁻, CO₃²⁻, N(CN)₂⁻, NO₃⁻, OCN⁻, PF₆⁻, and any combinations thereof, wherein R, R¹, and R² are independently for each occurrence H or fluoro.

32. The method of claim 19 wherein ratio of different phosphonium cations in the mixture of phosphonium salts or ionic liquids is varied by varying mole fraction or ratio of Grignard reagents in the mixture of Grignard reagents.

33. An electrochemical double layer capacitor (EDLC) comprising:
a positive electrode;
a negative electrode;
a separator between the first electrode and the second electrode; and
an electrolyte composition in contact with the positive electrode, the negative electrode, and the separator, wherein the electrolyte composition comprises:
a mixture of phosphonium ionic liquids, or phosphonium salts dissolved in a solvent and where the phosphonium ionic liquids or phosphonium salts have a controlled cation distribution.

34. The EDLC of claim 33 wherein the mixture of phosphonium ionic liquids or phosphonium salts having controlled cation distribution was made with the mixture of at least two Grignard reagents.

35. A battery comprising:
an anode;
a cathode;
a separator between the anode and the cathode; and
an electrolyte composition in contact with the anode, the cathode, and the separator, wherein the electrolyte composition comprises:
a mixture of phosphonium ionic liquids, or phosphonium salts dissolved in a solvent and where the phosphonium ionic liquids or phosphonium salts have a controlled cation distribution.

36. The battery of claim 35 wherein the mixture of phosphonium ionic liquids or phosphonium salts having controlled cation distribution was made with the mixture of at least two Grignard reagents.
